(19) United States
(12) Patent Application Publication
(10) Pub. No.: US 2014/0095293 A1
(43) Pub. Date: Apr. 3, 2014

(54) SOCIAL CONNECTIONS THROUGH TAGABLE APPAREL

(71) Applicant: Raj V. Abhyanker, Cupertino, CA (US)

(72) Inventor: Raj V. Abhyanker, Cupertino, CA (US)

(21) Appl. No.: 14/100,034

(22) Filed: Dec. 9, 2013

Related U.S. Application Data
(63) Continuation-in-part of application No. 11/603,442, filed on Nov. 22, 2006, now abandoned.
Application No. 11/603,442 is a continuation-in-part of application No. 11/653,194, filed on Jan. 12, 2007.
Application No. 11/653,194 is a continuation-in-part of application No. 13/236,964, filed on Sep. 20, 2011.
Application No. 13/236,964 is a continuation-in-part of application No. 13/242,303, filed on Sep. 23, 2011.
Application No. 13/242,303 is a continuation-in-part of application No. 13/272,245, filed on Oct. 13, 2011.

(51) Int. Cl. G06Q 50/00; G06Q 30/02

(52) U.S. Cl. CPC G06Q 50/01; G06Q 30/0242
USPC 705/14.41; 705/319

(57) ABSTRACT

Disclosed are a method, a device and a system of social connection broadcast data publication through a social-networkable apparel server using a radial algorithm to automatically distribute the social connection broadcast data on a set of user profiles having associated verified addresses in a threshold radial distance from a set of geospatial coordinates associated with a tagging of a taggable apparel generated through a computing device. In one embodiment, the social connection broadcast data is radially distributed as a broadcast data to (1) a set of recipients through an internet protocol (IP) based network (2) a set of merchants through the IP based network and/or (3) a set of user profiles in a circular geo-fenced area defined by the threshold radial distance from the set of geospatial coordinates associated with the tagging of the taggable apparel generated through the computing device through the radial algorithm of a neighborhood broadcasting system.

### CLAIMS OF PRIORITY

This patent application is a continuation in part and claims priority from:

(1) U.S. Provisional patent application No. 60/783,226, titled ‘Trade identity licensing in a professional services environment with conflict’ filed on Mar. 17, 2006.
(2) U.S. Provisional patent application No. 60/817,470 titled ‘Segmented services having a global structure of networked independent entities’, filed Jun. 28, 2006.
(3) U.S. Provisional patent application No. 60/853,499, titled ‘Method and apparatus of neighborhood expression and user contribution system’ filed on Oct. 19, 2006.
(4) U.S. Provisional patent application No. 60/854,230 titled ‘Method and apparatus of neighborhood expression and user contribution system’ filed on Oct. 25, 2006.
(5) U.S. Utility patent application Ser. No. 11/603,442 titled ‘Map based neighborhood search and community contribution’ filed on Nov. 22, 2006.
(6) U.S. Utility patent application Ser. No. 11/653,194 titled ‘Lodging and real property in a geo-spatial mapping environment’ filed on Jan. 12, 2007.
(7) U.S. Provisional patent application No. 61/526,693 titled ‘Geospatial constraint around biddability of a gastronomical item’ filed on Aug. 24, 2011.
(8) U.S. Utility patent application Ser. No. 13/236,964 titled ‘Near-field communication enabled wearable apparel garment and method to capture geospatially and socially relevant data of the wearer of the wearable apparel garment and/or a user of a reader device associated therewith’ filed on Sep. 20, 2011.
(9) U.S. Utility patent application Ser. No. 13/242,303 titled ‘Geospatially constrained gastronomic bidding’ filed on Sep. 23, 2011.
(10) U.S. Utility patent application Ser. No. 13/272,245 titled ‘Near-field communication enabled wearable apparel garment and method to capture geospatially and socially relevant data of the wearer of the wearable apparel garment and/or a user of a reader device associated therewith’ filed on Oct. 13, 2011.
(11) U.S. Provisional patent application No. 61/894,443 titled ‘Radio broadcast, commerce pushpins, and automated page updates to a geospatially constrained neighborhood region through an internet network and separately a trackable social community formed based on trackable tag based apparel that creates incentives and connections between users wearing promotional apparel and those other users reading the trackable tag on the apparel’ filed on Oct. 23, 2013.

### FIELD OF TECHNOLOGY

This disclosure relates generally to data processing devices and, more particularly, to a method, a device and/or a system of social connection broadcast data publication through a social-networkable apparel server using a radial broadcast algorithm to automatically distribute the social connection broadcast data on a set of user profiles having associated verified addresses in a threshold radial distance from a set of geospatial coordinates associated with the tagging of a taggable apparel generated through a mobile device, according to one or more embodiments.

### BACKGROUND

An entity (e.g., an individual, a family, a company, a team, an organization, a non-profit institution) may express its interests (e.g., beliefs, favorite bands, favorite sports teams, hobbies, values, passions, mutual connection amongst a group) through the apparel it wears (e.g., shirt, jacket, hat, pants, scarf, shoes). The entity may receive compliments and/or inquiries regarding aspects of the apparel it is wearing (e.g., messages, logos, images, brands, advertisements, writing, color, style). The entity may share much in common with another party that may admire and/or be interested in the apparel and/or the entity may not have the time and/or awareness in the moment to capitalize on this curiosity and/or shared interest(s).

In some cases, it may be unrealistic for the entity and the other party to form a traditional social connection in the moment. The entity may also be unaware of a potential friendship, business opportunity, and/or romantic relationship that could form around the apparel as a result of its lack of ability to form the traditional social connection in passing (e.g., while walking past one another on the street). Therefore, the entity may miss out on valuable opportunities for friendship, love, professional and/or financial gain.

Even if the entity is able to form a traditional social connection, it may be forced to do so with one individual at a time. There may be no way for the entity to network and/or form social connections, based on its apparel, at a larger scale without losing the intimacy of the initial connection. Furthermore, other social networks (e.g., Facebook.com) are impersonal as there may be no face to face contact and new ‘friends’ may never be able to shake hands. These social networks may also inundate users with information regarding people and/or places that they do not care deeply about. This may cause users to miss important and valuable updates and/or may cause messages to fall on deaf ears. A user (e.g., the entity, the other party, a different user) may never be aware of entities with shared interests that are around them if the entity and the user do not directly meet. The user may not have a way to benefit from the apparel based social connections formed by others in a geo-spatial location near them. This may lead to meaningless, transient connections and/or individuals missing out on chances for love, friendship, business, professional, and/or monetary gain.

### SUMMARY

Disclosed are a method, a device and a system of social connection broadcast data publication through a social-networkable apparel server using a radial algorithm to automatically distribute the social connection broadcast data on a set of user profiles having associated verified addresses in a threshold radial distance from a set of geospatial coordinates associated with the tagging of a taggable apparel generated through a mobile device.

In one aspect, a method of a social-networkable apparel server includes validating, through a processor and a memory, that a tagging of a taggable apparel through a mobile device is associated with a new user and/or an existing user of the social-networkable apparel server. The method verifies that a set of geospatial coordinates associated with the tagging of the taggable apparel through the mobile device are trusted based on a contact information transmitted from the mobile device to the social-networkable apparel server and/or a claimed geospatial location of the new user and/or the existing user of the social-networkable apparel server. In addition, the method determines that a time stamp associated with a creation date and/or a creation time of the tagging of the taggable apparel generated through the mobile device is trusted based on the set of geospatial coordinates where the taggable apparel was tagged. Furthermore, a social connection between the new user and the existing user and/or an individual wearing the taggable apparel is created by the social-networkable apparel server using a radial algorithm.

A design of the taggable apparel may be selected through an apparel creator module of the social-networkable apparel server based on a request of a merchant. An advertisement area on the taggable apparel may be customized through an advertisement creation module of the social-networkable apparel server based on the request of the merchant, wherein the advertisement area may be associated with a commercial item, a service, and/or a promotional item offered by the merchant to any of those individuals that read a short range communication technology on the taggable apparel. Additionally, a fulfillment request of an order may be submitted by the merchant for a quantity of the taggable apparel having customized ones of the advertisement area and/or each individually associated with the short range communication technology through the social-networkable apparel server, such the short term communication technology individually identifies each the taggable apparel and/or optionally a group of the taggable apparel and/or the wearer of the taggable apparel (through a unique identifier associated with the short term communication technology and/or a unique uniform resource locator destination to which each read tag may be transported in the social-networkable apparel server).

The merchant may be permitted to log-in to the social-networkable apparel server and/or set a criteria being a location sharing request, a social graph sharing request, a destination page design, a destination uniform resource locator location, and/or an updatable electronic promotion associated with each of the taggable apparel. The merchant may be permitted to log-in to the social-networkable apparel server and/or view statistics related to a most social wearer of the taggable apparel, a top tagger, a top sharer, a top promoter, a top influencer, a top geospatial area of tagging, and/or a set of statistics associated with an effectiveness and/or return on investment of a purchase associated with the fulfillment request.

The tagging of the taggable apparel generated through the mobile device may be automatically published on a set of user profiles having associated verified addresses in a threshold radial distance from the set of geospatial coordinates associated with the tagging of the taggable apparel generated through the mobile device of the new user and/or the existing user of the social-networkable apparel server using a radial algorithm. Additionally, a listing criteria associated with the tagging of the taggable apparel comprising a description, a photograph, a video, a salary, a fixed fee amount, an category, a functional status of a job offered through the tagging of the taggable apparel, wherein the job may be a household job, a repair job, a maintenance job, a professional job and/or a career opportunity may be automatically published. An availability chart may be populated when the job associated with the listing criteria may be posted, wherein the availability chart includes a target candidate living area radius, a start timing, an hours per day, an hours per month, a professional qualification criteria and/or a timing criteria.

The notification data may be determined to be generated by the new user and/or the existing user of a neighborhood broadcasting system when validating that the notification data may be associated with the mobile device. An application on the mobile device may be determined to be communicating the notification data to the neighborhood broadcasting system when the notification data may be processed. The new user and/or the existing user may be associated with the new user and/or the existing user profile in the neighborhood broadcasting system through the application on the mobile device. The tagging of the taggable apparel generated through the mobile device may be presented as a tag pushpin in a geospatial map surrounding pre-populated residential and/or business listings in a surrounding vicinity (such that the tag pushpin may be automatically presented on the geospatial map in addition to being presented on the set of user profiles having associated verified addresses within a threshold radial distance from the set of geospatial coordinates associated with the tagging of the taggable apparel generated through the mobile device of the new user and/or the existing user of the social-networkable apparel server).

The tagging of the taggable apparel generated through the mobile device may be radially distributed through an on-page posting, an electronic communication, and/or a push notification (delivered to desktop and/or mobile devices). Furthermore, the tagging of the taggable apparel may be associated with users and/or their user profiles around an epicenter defined at the set of geospatial coordinates associated with the tagging of the taggable apparel. The tagging of the taggable apparel may be generated through the mobile device to all subscribed user profiles in a circular geo-fenced area. The circular geo-fenced area may be defined by the threshold distance from the set of geospatial coordinates associated with the tagging of the taggable apparel generated through the mobile device through the radial algorithm of the neighborhood broadcasting system, which measures a distance away of each address associated with each user profile from the current geospatial location at the epicenter). The new user and/or the existing user may be permitted to drag and/or drop a tag pushpin on any location on the geospatial map, and/or automatically determine a latitude and/or a longitude associated with a placed location. A career center, a hardware store, a professional services provider, a landscaper, a gardener, a plumber, a handyman, and/or a homeless shelter in a surrounding geospatial area may be automatically notified to the set of geospatial coordinates associated with the tagging of the taggable apparel generated through the mobile device.

The geospatial coordinates may be extracted from a social connection broadcast data associated with the tagging of the taggable apparel generated through the mobile device when verifying that the set of geospatial coordinates associated with the tagging of the taggable apparel generated through the mobile device are trusted (based on the claimed geospatial location of the new user and/or the existing user of the social-networkable apparel server). Additionally, it may be determined that there is a relative match between a persistent clock associated with the social-networkable apparel serve rand/or a digital clock of the mobile device to determine that the time stamp associated with the creation date and/or time of the tagging of the taggable apparel generated through the mobile device may be accurate and/or therefore trusted.

The a publishing of the tagging of the taggable apparel generated through the mobile device may be automatically deleted on a set of user profiles (having associated verified addresses in the threshold radial distance from the set of geospatial coordinates associated with the tagging of the taggable apparel generated through the mobile device of the new user and/or the existing user of the social-networkable apparel server) based on a social connection expiration time. A set of residential addresses each associated with a resident name in a neighborhood surrounding the mobile device may be geo-coded. Furthermore, the set of residential addresses each associated with the resident name as the set of user profiles in the threshold radial distance from the claimed geospatial location of the new user and/or the existing user of the social-networkable apparel server may be prepopulated in a neighborhood curation system communicatively coupled with the social-networkable apparel server. The new user and/or the existing user may be permitted to modify content in each of the set of user profiles. The modified content may be tracked through the neighborhood curation system.

Additionally, a reversible history journal associated with each of the set of user profiles may be generated such that a modification of the new user and/or the existing user can be undone on a modified user profile page. An editing credibility of the new user and/or the existing user based may be determined on an edit history of the new user and/or the existing user and/or a community contribution validation of the new user and/or the existing user by other users of the neighborhood curation system. Furthermore, the tagging of the taggable apparel (generated through the mobile device) may be automatically published to the set of user profiles having an associated verified address within the threshold radial distance from the claimed geospatial location of the new user and/or the existing user of the social-networkable apparel server using the radial algorithm.

A claim request of the new user and/or the existing user generating the tagging of the taggable apparel (generated through the mobile device) may be processed to be associated with an address of the neighborhood curation system. It may be determined if the claimable neighborhood in the neighborhood curation system is associated with a private neighborhood community in the claimable neighborhood of the neighborhood curation system. The new user and/or the existing user may be associated with the private neighborhood community in the claimable neighborhood of the neighborhood curation system if the private neighborhood community has been activated by the new user and/or the existing user and/or a different new user and/or a different existing user.

The new user and/or the existing user may be permitted to draw a set of boundary lines in a form of a geospatial polygon such that the claimable neighborhood in a geospatial region surrounding the claim request creates the private neighborhood community in the neighborhood curation system if the private neighborhood community is inactive. The claim request of the new user and/or the existing user generating the tagging of the taggable apparel (generated through the mobile device) may be verified to be associated with a neighborhood address of the neighborhood curation system when the address is determined to be associated with a work address and/or a residential address of the new user and/or the existing user.

The tagging of the taggable apparel generated through the mobile device may be simultaneously published on the private neighborhood community (associated with the new user and/or the existing user generating the tagging of the taggable apparel generated through the mobile device) in the threshold radial distance from the address associated with the claim request of the new user and/or the existing user of the neighborhood curation system when the tagging of the taggable apparel generated through the mobile device is automatically published on the set of user profiles (having associated verified address in the threshold radial distance from the claimed geospatial location of the new user and/or the existing user of the social-networkable apparel server) based on a set of preferences of the new user and/or the existing user using the radial algorithm.

In addition, an interface may be provided to the merchant such that the merchant can use a haptic ‘flick’ gesture in a horizontal and/or a vertical fashion to switch a viewing pane associated with a monitoring of the effectiveness and/or return on investment of the purchase associated with the fulfillment request. A video communication and/or an audio communication may be automatically initiated between the mobile device of the merchant and/or another mobile device of the wearer of the taggable apparel and/or a tagger that reads the short term communication technology physically on the taggable apparel through the social-networkable apparel server (based on a set of preset criteria through the social-networkable apparel server).

The wearer of the taggable apparel (and/or the tagger that reads the short term communication technology physically on the taggable apparel) may be permitted to communicate with each other and/or form social connections with each other based on the participation criteria set by the merchant and/or the wearer of the taggable apparel and/or the tagger that reads the short term communication technology physically on the taggable apparel, (such that each of the wearer of a taggable apparel and/or the tagger that reads the short term communication technology physically on the taggable apparel may be able to form social connections with each participating person associated with the tagging of the taggable apparel). Merchants participating in the social-networkable apparel server may be permitted to see previous ratings, interview comments, reviews, prescreen questions, and/or background checks across a plurality of applicants applying for a plurality of jobs through the social-networkable apparel server (such that different merchants benefit from previous diligence (e.g., previous ratings, interview comments, reviews, prescreen questions, and/or background checks) by participating merchants with respect to each applicant applying for a job who has previously applied for different jobs through the social-networkable apparel server).

A summary data of how many user profile pages were updated with an alert of the tagging of the taggable apparel (generated through the mobile device) may be provided to the merchant generating the tagging of the taggable apparel (generated through the mobile device) when publishing the tagging of the taggable apparel (generated through the mobile device) in the private neighborhood community and/or the set of user profiles having associated verified address within the threshold radial distance from the claimed geospatial location of the new user and/or the existing user of the social-networkable apparel server based on the set of preferences of the new user and/or the existing user. Additionally, the tagging of the taggable apparel (generated through the mobile device) may be live broadcasted to the different new user and/or the different existing user and/or the new user and/or the existing users in the private neighborhood community and/or currently within the threshold radial distance from the current geospatial location through the social-networkable apparel server (such that a live broadcast multicasts to a plurality of data processing systems associated with each of the different user and/or the new user and/or the existing users simultaneously when the mobile device of the new user and/or the existing user generating the live-broadcast enables broadcasting of the tagging of the taggable apparel generated through the mobile device to any one of a geo spatial vicinity around the mobile device of the new user and/or the existing user generating the broadcast and/or in any private neighborhood community in which the new user and/or the existing user has a non-transitory connection).

The different new user and/or existing user and/or the new user and/or the existing users in the private neighborhood community may be permitted to bi-directionally communicate with the new user and/or the existing user generating the broadcast through the social-networkable apparel server. Any private neighborhood community in which the new user and/or the existing user has the non-transitory connection may be the residential address of the new user and/or the existing user and/or the work address of the new user and/or the existing user that has been confirmed by the social-networkable apparel server as being associated with the new user and/or the existing user. The threshold distance may be between 0.2 and 0.4 miles from the set of geospatial coordinates associated with the tagging of the taggable apparel generated through the mobile device to optimize a relevancy of the live-broadcast.

In another aspect, a method of a social-networkable apparel server includes determining, through a processor connected to a memory, that a time stamp associated with a creation date and/or a creation time of a tagging of a taggable apparel generated through a computing device is trusted based on a set of geospatial coordinates where the taggable apparel was tagged. The method includes automatically forming a social connection between a new user and/or an existing user and/or an individual wearing the taggable apparel through the social-networkable apparel server using a radial algorithm. In addition, the method includes radially distributing the tagging of the taggable apparel as a notification data through an on-page posting, an electronic communication, and/or a push notification delivered to either (1) a set of recipients through an internet protocol (IP) based network associated with users and/or their user profiles around an epicenter defined at the set of geo spatial coordinates associated with the tagging of the taggable apparel generated through the computing device, (2) a set of merchants through an internet protocol (IP) based network associated with the users and/or their user profiles around an epicenter defined at the set of geospatial coordinates associated with the tagging of the taggable apparel generated through the computing device or (3) a set of all subscribed user profiles in a circular geo-fenced area defined by the threshold distance from the set of geospatial coordinates associated with the tagging of the taggable apparel generated through the computing device through the radial algorithm of a neighborhood broadcasting system that measures a distance away of each address associated with each user profile from the current geospatial location at the epicenter.

In yet another aspect, a system includes a social-networkable apparel server to automatically form a social connection, through a processor connected to a memory, between a new user and/or an existing user and/or an individual wearing the taggable apparel using a radial algorithm. The system also includes a mobile device communicatively coupled with the social-networkable apparel server through the network to generate the social connection using a camera, a microphone, and/or a sensory capability of the mobile device to generate a captured data that is appended with a time stamp associated with a creation date and/or a creation time of captured data in generating the social connection.

A validation module may validate that a tagging of a taggable apparel through a mobile device is associated with a new user and/or an existing user of the social-networkable apparel server. The validation module may verify that a set of geospatial coordinates associated with the tagging of the taggable apparel through the mobile device are trusted based on a contact information transmitted from the mobile device to the social-networkable apparel server and/or a claimed geospatial location of the new user and/or the existing user of the social-networkable apparel server. A time stamp module may identify that a time stamp associated with a creation date and/or a creation time of the tagging of the taggable apparel generated through the mobile device may be trusted based on the set of geospatial coordinates where the taggable apparel was tagged.

An apparel creator module may select a design of the taggable apparel based on a request of a merchant, and an advertisement creation module may customize an advertisement area on the taggable apparel based on the request of the merchant, wherein the advertisement area may be associated with a commercial item, a service, and/or a promotional item offered by the merchant to any of those individuals that read a short term communication technology on the taggable apparel. Additionally, a submission module may submit a fulfillment request of an order by the merchant for a quantity of the taggable apparel having customized ones of the advertisement area and/or each individually associated with the short term communication technology through the social-networkable apparel server (such that each one of the short term communication technology individually identifies each the taggable apparel and/or optionally a group of the taggable apparel and/or the wearer of the taggable apparel through a unique identifier associated with either the short term communication technology and/or a unique uniform resource locator destination to which each read tag may be transported in the social-networkable apparel server).

Furthermore, a merchant criteria module may permit the merchant to log-in to the social-networkable apparel server and/or set a listing criteria being a location sharing request, a social graph sharing request, a destination page design, a destination uniform resource locator location, and/or an updatable electronic promotion associated with each of the taggable apparel. A statistic permission module may permit the merchant to log-in to the social-networkable apparel server and/or view statistics related to a most social wearer of the taggable apparel, a top tagger, a top sharer, a top promoter, a top influencer, a top geospatial area of tagging, and/or a set of statistics associated with an effectiveness and/or return on investment of a purchase associated with the fulfillment request. A publishing module may automatically publish the tagging of the taggable apparel generated through the mobile device on a set of user profiles having associated verified address in a threshold radial distance from the set of geospatial coordinates associated with the tagging of the taggable apparel generated through the mobile device of the new user and/or the existing user of the social-networkable apparel server using a radial algorithm. Moreover, a listing module may process a listing criteria associated with the tagging of the taggable apparel comprising a social connection, description, a photograph, a video, a salary, a fixed fee amount, an category, a functional status of a job offered through the tagging of the taggable apparel, wherein the job may be a household job, a repair job, a maintenance job, a professional job and/or a career opportunity.

A charting module may populate an availability chart when the job associated with the listing criteria is posted, wherein the availability chart may include a target candidate living area radius, a start timing, an hours per day, an hours per month, a professional qualification criteria and/or a timing criteria. A broadcast determination module may verify that the notification data is generated by the new user and/or the existing user of a neighborhood broadcasting system when validating that the notification data may be associated with the mobile device. Additionally, an application module may determine that an application on the mobile device is communicating the notification data to the neighborhood broadcasting system when the notification data may be processed.

An association module may associate the new user and/or the existing user with the new user and/or the existing user profile in the neighborhood broadcasting system through the application on the mobile device. In addition, a pushpin module may present the tagging of the taggable apparel generated through the mobile device as a tag pushpin in a geospatial map surrounding pre-populated residential and/or business listings in a surrounding vicinity, such that the tag pushpin may be automatically presented on the geospatial map in addition to being presented on the set of user profiles (having associated verified addresses in a threshold radial distance from the set of geospatial coordinates associated with the tagging of the taggable apparel generated through the mobile device of the new user and/or the existing user of the social-networkable apparel server).

A radial distribution module may allow the tagging of the taggable apparel, generated through the mobile device, to be radially distributed (through an on-page posting, an electronic communication, and/or a push notification delivered to desktop and/or mobile devices associated with users and/or their user profiles around an epicenter defined at the set of geo spatial coordinates associated with the tagging of the taggable apparel generated through the mobile device) to all subscribed user profiles in a circular geo-fenced area, defined by the threshold distance from the set of geospatial coordinates associated with the tagging of the taggable apparel generated through the mobile device, through the radial algorithm of the neighborhood broadcasting system that measures a distance away of each address associated with each user profile from the current geospatial location at the epicenter. Furthermore, a placement module may enable the new user and/or the existing user to drag and/or drop the tag pushpin on any location on the geospatial map, and/or automatically determine a latitude and/or a longitude associated with a placed location. A notification module may automatically notify a career center, a hardware store, a professional services provider, a landscaper, a gardener, a plumber, a handyman, and/or a homeless shelter in a surrounding geospatial area to the set of geospatial coordinates associated with the tagging of the taggable apparel generated through the mobile device.

An extraction module may extract the geospatial coordinates from a social connection broadcast data associated with the tagging of the taggable apparel generated through the mobile device when verifying that the set of geospatial coordinates associated with the tagging of the taggable apparel generated through the mobile device are trusted based on the claimed geospatial location of the new user and/or the existing user of the social-networkable apparel server. Additionally, a matching module may determine a relative match between a persistent clock associated with the social-networkable apparel server and/or a digital clock of the mobile device to determine that the time stamp associated with the creation date and/or time of the tagging of the taggable apparel generated through the mobile device is accurate and/or therefore trusted. A deletion module may automatically remove the a publishing of the tagging of the taggable apparel, generated through the mobile device, on a set of user profiles having associated verified addresses in the threshold radial distance from the set of geospatial coordinates associated with the tagging of the taggable apparel (generated through the mobile device of the new user and/or the existing user of the social-networkable apparel server) based on a social connection expiration time.

A plotting module may geocode a set of residential addresses each associated with a resident name in a neighborhood surrounding the mobile device. A data seeding module may prepopulate the set of residential addresses each associated with the resident name as the set of user profiles in the threshold radial distance (from the claimed geospatial location of the new user and/or the existing user of the social-networkable apparel server) in a neighborhood curation system communicatively coupled with the social-networkable apparel server. A curation permission module may permit the new user and/or the existing user to modify content in each of the set of user profiles. Furthermore, a discovery module may track the modified content through the neighborhood curation system. An undo module may generate a reversible history journal associated with each of the set of user profiles such that the modification of the new user and/or the existing user can be undone on a modified user profile page. A reputation module may determine an editing credibility of the new user and/or the existing user (based on an edit history of the new user and/or the existing user and/or a community contribution validation of the new user and/or the existing user by other users of the neighborhood curation system).

A publishing module may automatically publish the tagging of the taggable apparel generated through the mobile device to the set of user profiles having associated verified address in the threshold radial distance from the claimed geospatial location of the new user and/or the existing user of the social-networkable apparel server using the radial algorithm. A claiming module may process the claim request of the new user and/or the existing user generating the tagging of the taggable apparel generated through the mobile device to be associated with an address of the neighborhood curation system. Moreover, an association determination module may verify if the claimable neighborhood in the neighborhood curation system is associated with the private neighborhood community in the claimable neighborhood of the neighborhood curation system. A private neighborhood module may connect the new user and/or the existing user with the private neighborhood community in the claimable neighborhood of the neighborhood curation system if the private neighborhood community has been activated by the new user and/or the existing user and/or a different the new user and/or the existing user.

A boundary module may permit the new user and/or the existing user to draw a set of boundary lines in a form of a geospatial polygon (such that the claimable neighborhood in a geospatial region surrounding the claim request creates the private neighborhood community in the neighborhood curation system if the private neighborhood community may be inactive). An address type module may confirm the claim request of the new user and/or the existing user generating the tagging of the taggable apparel, generated through the mobile device, to be associated with a neighborhood address of the neighborhood curation system when the address may be determined to be associated with a work address and/or a residential address of the new user and/or the existing user. Additionally, a concurrency module may simultaneously publish the tagging of the taggable apparel (generated through the mobile device) on the private neighborhood community associated with the new user and/or the existing user generating the tagging of the taggable apparel generated through the mobile device (in the threshold radial distance from the address associated with the claim request of the new user and/or the existing user of the neighborhood curation system) when automatically publishing the tagging of the taggable apparel generated through the mobile device on the set of user profiles (having associated verified addresses in the threshold radial distance from the claimed geospatial location of the new user and/or the existing user of the social-networkable apparel server) based on a set of preferences of the new user and/or the existing user using the radial algorithm.

A gesture module may provide an interface to the merchant such that the merchant can use a haptic ‘flick’ gesture in a horizontal and/or a vertical fashion to switch a viewing pane associated with a monitoring of the effectiveness and/or return on investment of the purchase associated with the fulfillment request. A merchant module may automatically initiate a video communication and/or an audio communication between the mobile device of the merchant and/or another mobile device of the wearer of the taggable apparel and/or a tagger that reads the short term communication technology (physically associated with the taggable apparel) through the social-networkable apparel server based on a set of preset criteria through the social-networkable apparel server.

A communication module may permit each of the individual wearing the taggable apparel and/or the tagger (e.g., the new user or the existing user that reads the short term communication technology physically on the taggable apparel) to communicate with each other and/or form social connections with each other based on the participation criteria (set by the merchant and/or the wearer of a taggable apparel and/or the tagger that reads the short term communication technology physically on the taggable apparel), such that each of the wearer of a taggable apparel and/or the tagger that reads the short term communication technology physically on the taggable apparel may be able to form social connections with each participating person associated with the tagging of the taggable apparel. A historical applicant module may permit participating merchants in the social-networkable apparel server to see previous ratings, interview comments, reviews, prescreen questions, and/or background checks of across a plurality of applicants applying for a plurality of jobs through the social-networkable apparel server (such that different merchants benefit from previous diligence of at one of previous ratings, interview comments, reviews, prescreen questions, and/or background checks by participating merchants with each applicant to the job that has previously applied for different jobs through the social-networkable apparel server).

A summary module may provide a summary data to the merchant generating the tagging of the taggable apparel (generated through the mobile device) of how many user profile pages were updated with an alert of the tagging of the taggable apparel (generated through the mobile device) when publishing the tagging of the taggable apparel (generated through the mobile device) in the private neighborhood community and/or the set of user profiles (having associated verified addresses within the threshold radial distance from the claimed geospatial location of the new user and/or the existing user of the social-networkable apparel server) based on the set of preferences of the new user and/or the existing user. A curation permission module may permit the at least one of the new user and the existing user to modify content in each of the set of user profiles. A live broadcast module may live broadcast the tagging of the taggable apparel (generated through the mobile device) to the different the new user and/or the existing user and/or the new user and/or the existing users in the private neighborhood community and/or currently within the threshold radial distance from the current geospatial location through the social-networkable apparel server (such that a live broadcast multicasts to a plurality of data processing systems associated with each of the different user and/or the new user and/or the existing users simultaneously when the mobile device of the new user and/or the existing user generating the live-broadcast enables broadcasting of the tagging of the taggable apparel generated through the mobile device to any one of a geo spatial vicinity around the mobile device of the new user and/or the existing user generating the broadcast and/or in any private neighborhood community in which the new user and/or the existing user has a non-transitory connection).

A bi-directional communication module may permit the different the new user and/or the existing user and/or the new user and/or the existing user in the private neighborhood community to bi-directionally communicate with the new user and/or the existing user generating the broadcast through the social-networkable apparel server. Additionally, a non-transitory module may constrain any private neighborhood community in which the new user and/or the existing user has the non-transitory connection to the residential address (of the new user and/or the existing user and/or the work address of the new user and/or the existing user) that has been confirmed by the social-networkable apparel server as being associated with the new user and/or the existing user. A threshold module may automatically set the threshold distance to be between 0.2 and 0.4 miles from the set of geospatial coordinates associated with the tagging of the taggable apparel (generated through the mobile device) to optimize a relevancy of the live-broadcast.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a network view of a social-networkable apparel server 100 having a radial distribution module communicating with a device that generates a radial broadcast through an internet protocol network using a radial algorithm of the radial distribution module of the social-networkable apparel server 100, according to one or more embodiments.

FIG. 2 is an exploded view of the radial distribution module of FIG. 1 that applies the radial algorithm, according to one or more embodiments.

FIG. 3 is a broadcast view that demonstrates how the radial distribution module of FIG. 1 is used to communicate a social connection broadcast data to claimed user profiles, pre-seeded user profiles, and to telephone devices through a heterogeneous network formed through the internet protocol network of FIG. 1 and through a cellular network, according to one or more embodiments.

FIG. 4 is a radial operation view that illustrates an expansion of a threshold radial distance based on a claimed neighborhood at a radial boundary surrounding an epicenter formed by geospatial coordinates of the device of FIG. 1, according to one or more embodiments.

FIG. 5 illustrates a remote association view in which a mobile device of a merchant receives the social connection broadcast data (e.g., metadata) of FIG. 3 based on a non-transitory claimed address associated with a profile of the merchant even when the merchant's mobile device is outside a threshold radial distance of a broadcast, according to one or more embodiments.

FIG. 6 is a merchant view that depicts how the merchant of FIG. 5 manages and views orders and information about taggable apparel (e.g., statistics, tag pushpins, geospatial maps and summary data) based on the social connection broadcast data, according to one or more embodiments.

FIG. 7 is a user interface view that explains how a verified user views their profile, makes social connections, and manages notifications in neighborhoods that they have claimed, according to one or more embodiments.

FIG. 8 is an apparel creation user interface view that explains how a user creates, customizes (e.g., selects a design, an advertisement, and/or an incentive), socializes (e.g., selects preset criteria), and/or orders a quantity of taggable apparel, according to one or more embodiments.

FIG. 9 is a process flow of radially distributing the social connection broadcast data of FIG. 3 as a notification data around an epicenter defined at the set of geospatial coordinates associated with the social connection broadcast data, according to one or more embodiments.

FIG. 10 is a table view illustrating data relationships between users, locations, and with a set of notification types needed to generate a broadcast, according to one or more embodiments.

FIG. 11 is a critical path view illustrating a flow based on time in which critical operations in establishing a bi-directional session between a verified user and those individuals receiving the social connection broadcast data of FIG. 3 is established, according to one or more embodiments.

FIG. 12 is a tag data radial distribution and social connection view illustrating the radial distribution of a social connection broadcast data in the form of a notification data from a social-networkable apparel server 100 to the mobile devices of a new user, an individual wearing the taggable apparel, and a verified user with a non-transient connection to a claimed address within the threshold radial distance from the epicenter, forming a social connection between at least the new user and the individual wearing the taggable apparel.

Other features of the present embodiments will be apparent from the accompanying drawings and from the detailed description that follows.

### DETAILED DESCRIPTION

Example embodiments, as described below, may be used to provide a method, a system and/or a device of social connection broadcast data 102 publication through a social-networkable apparel server 100 using a radial algorithm 240 to automatically distribute the social connection broadcast data 102 in a threshold radial distance 119 from a set of geospatial coordinates 103 associated with a mobile device 504 (e.g., the device 104). Although the present embodiments have been described with reference to specific example embodiments, it will be evident that various modifications and changes may be made to these embodiments without departing from the broader spirit and scope of the various embodiments.

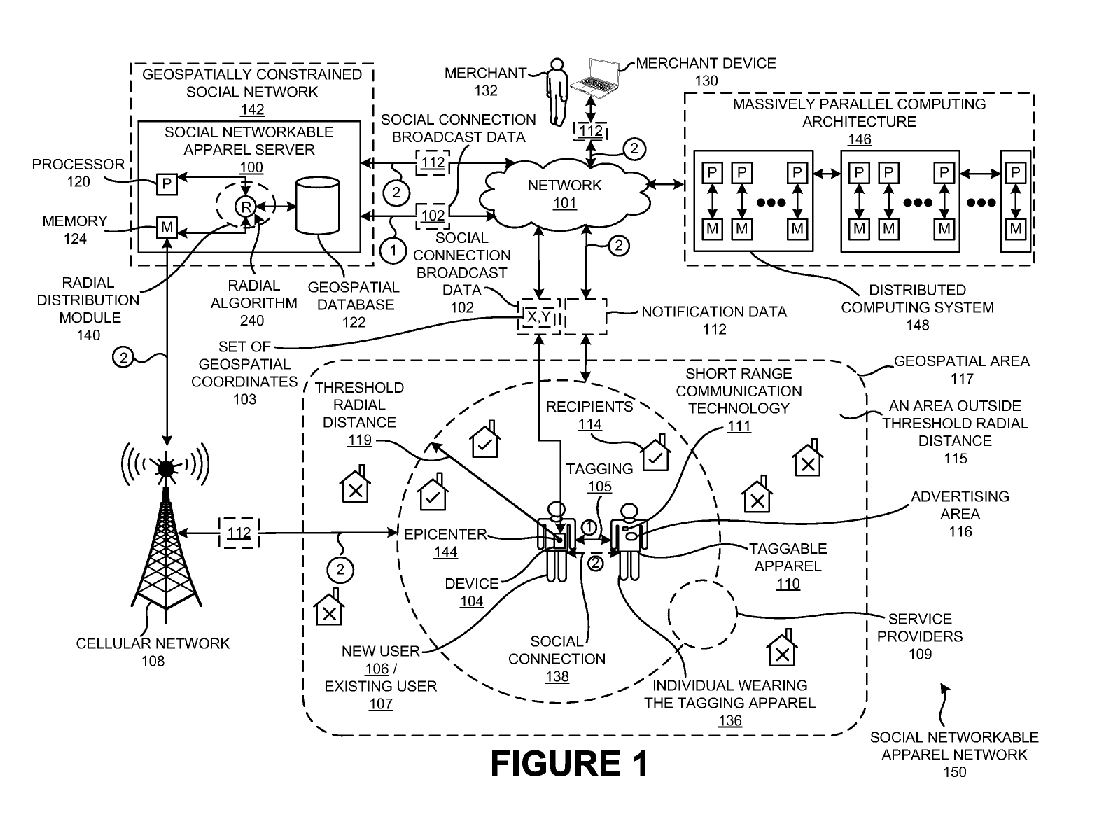

FIG. 1 is a network view of a social-networkable apparel server 100 having a radial distribution module 140 communicating with a device 104 that generates a radial broadcast through an internet protocol network 101 using a radial algorithm 240 of the radial distribution module 140 of the social-networkable apparel server 100, according to one or more embodiments.

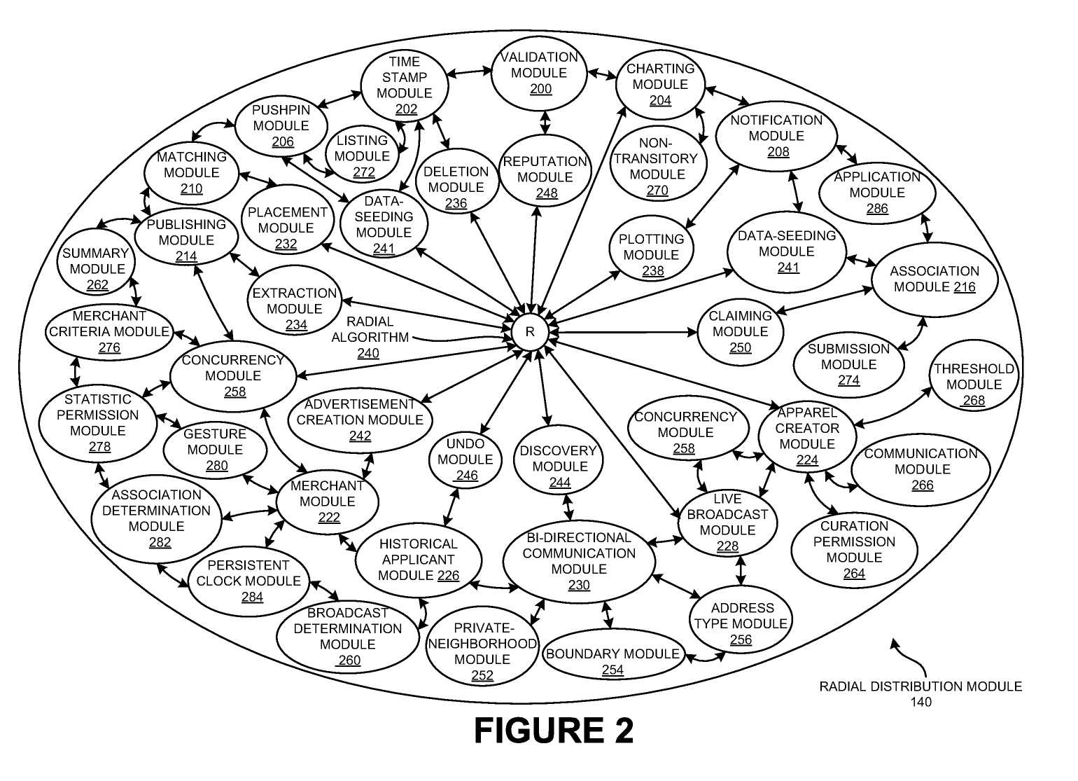

Particularly, FIG. 1 illustrates a social networkable apparel network 150, according to one or more embodiments. The embodiment of FIG. 1 describes a social-networkable apparel server 100, a network 101, a social connection broadcast data 102, a set of geospatial coordinates 103, a device 104 (e.g., a mobile device 504), a tagging 105, a new user 106, an existing user 107, a cellular network 108, service providers 109 (including a career center 309A, a hardware store 309B, a professional service provider 309C, a landscaper 309D, a gardener 309E, a plumber 309F, a handyman 309G, and a homeless shelter 309H), a taggable apparel 110, a short range communication technology 111, a notification data 112, a set of recipients 114, an area outside the threshold radial distance 115, an advertisement area 116, a geospatial area 117, a threshold radial distance 119, a processor 120, an application 121, a geospatial database 122, a memory 124, a radial distribution module 140 (e.g., that applies a radial algorithm 240 of FIG. 2 using a series of modules working in concert as described in FIG. 2), a merchant device 130, a merchant 132, an individual wearing the taggable apparel 136, a social connection 138, a geospatially constrained social network 142, an epicenter 144, a massively parallel computing architecture 146, and a distributed computing system 148.

The social-networkable apparel server 100 includes a processor 120, a memory 124, and a geospatial database 122, according to the embodiment of FIG. 1. The social-networkable apparel server 100 may be one or more server side data processing systems (e.g., web servers operating in concert with each other) that operate in a manner that provides a set of instructions to any number of client side devices (e.g., the device 104, (e.g., a mobile device 504, and/or the merchant device 130) communicatively coupled with the social-networkable apparel server 100 through the network 101. For example, the social-networkable apparel server 100 may be a computing system (e.g., or a group of computing systems) that operates in a larger client-server database framework (e.g., such as in a social networking software such as Nextdoor.com, Fatdoor.com, Facebook.com, etc.).

The device 104 (e.g., a mobile device 504) (e.g., a smartphone, a tablet, a laptop) may access the social-networkable apparel server 100 through the network 101 using a browser application of the mobile device (e.g., Google® Chrome) and/or through a client-side application downloaded to the device 104 (e.g., a mobile device 504) (e.g., a Nextdoor.com mobile application, a Fatdoor.com mobile application) operated by the new user 106/existing user 107. In an alternate embodiment, a non-mobile computing device, such as a desktop computer (not shown) may access the social-networkable apparel server 100 through the network 101.

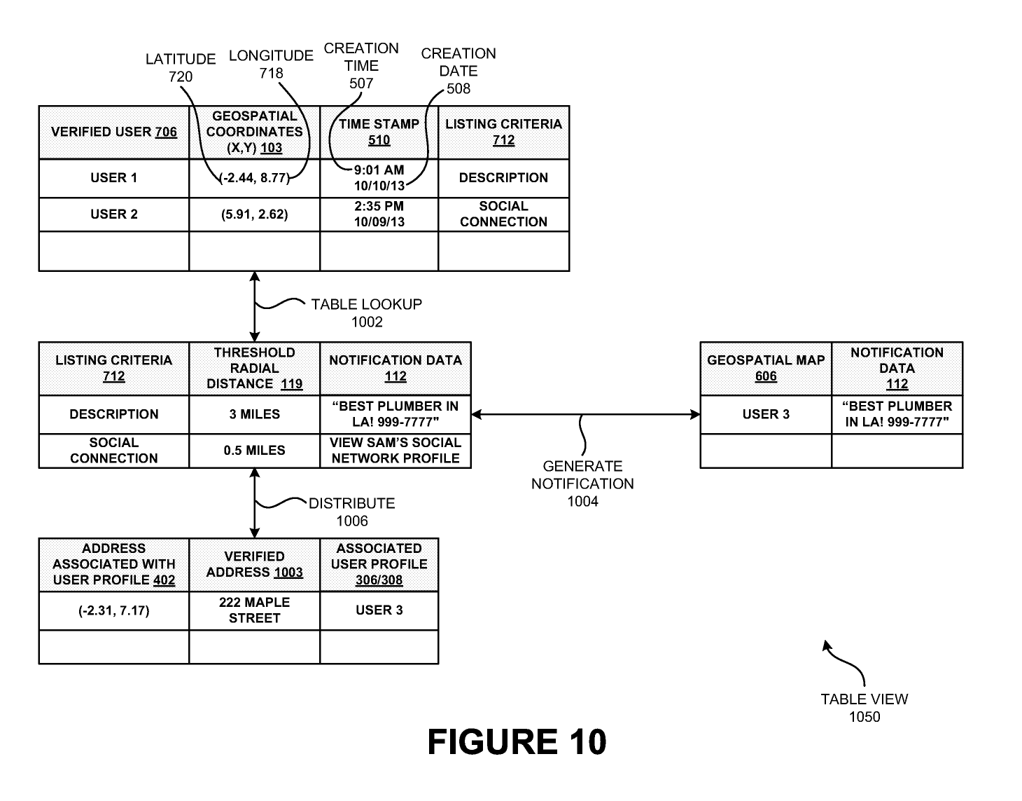

The social connection broadcast data 102 may be created from a tagging 105 by the device 104 of the new user 106/existing user 107 of a short range communication technology 111 (e.g., a near-field communication tag, an i-beacon) physically associated with the taggable apparel 110 worn by the individual wearing the taggable apparel 136. The social connection broadcast data 102 (a metadata) may be communicated from the device 104 (e.g., a mobile device 504) to the social-networkable apparel server 100 through the network 101. The social connection broadcast data 102 may include a set of geospatial coordinates 103 of the device 104, a time stamp 510, a unique uniform resource location destination (not shown), a unique identifier of the user of the device 104 (not shown), a unique identifier (of the taggable apparel 110) (not shown), and/or a listing criteria 620 (shown in FIG. 10).

The social connection broadcast data 102 may be generated and distributed through an application of the radial distribution module 140 (e.g., that applies the radial algorithm 240 of FIG. 2 using a series of modules working in concert as described in FIG. 2) of the social-networkable apparel server 100. The radial distribution module 140 (e.g., that applies the radial algorithm 240 of FIG. 2 using a series of modules working in concert as described in FIG. 2) may be a series of software functions/processes that simulates the experience of transmitting and receiving local broadcasts for the verified user, according to one or more embodiments.

Using an internet protocol based network (e.g., the network 101), the social-networkable apparel server 100 may be able to use the radial distribution module 140 (e.g., that applies the radial algorithm 240 of FIG. 2 using a series of modules working in concert as described in FIG. 2) to simulate a radio frequency (RF) based communication network using an IP network topology of the network 101. Therefore, the social connection broadcast data 102 can be distributed using the social-networkable apparel server 100 to a geo-constrained area (e.g., the recipients 114) in the geospatial area 117 and/or the service providers 109 in a geo-constrained area around an area in which the device 104 (e.g., a mobile device 504) operates without requiring expensive broadcast towers, transceivers, transmitters, amplifiers, antennas, tuners and/or wave generating and interpreting hardware (e.g., as may be required in local ham radio communication, frequency modulation (FM) audio systems, etc.). The radial distribution module 140 (e.g., that applies the radial algorithm 240 of FIG. 2 using a series of modules working in concert as described in FIG. 2) may recreate an experience of communication between parties in a geospatially restricted area (e.g., for example in the same city, in the surrounding neighborhood, in the same zip code, in the same building, in the same claimed neighborhood) through the use of an Internet protocol network. The social-networkable apparel server 100 may overcome technical challenges of determining a user's geospatial location, calculating distance to other verified users based on relative geospatial locations, and/or coordinating information with a database of geo-coded information of interest (e.g., using the geospatial database 122) using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2), as a function/module of the social-networkable apparel server 100, may determine the location of the new user 106/existing user 107, the distance between the new user 106/existing user 107 and other verified users, and the distance between the new user 106/existing user 107 and locations of interest. With that information, the radial distribution module 140 (e.g., that applies the radial algorithm 240 of FIG. 2 using a series of modules working in concert as described in FIG. 2) may further determine which verified users are within a predetermined vicinity of a new user 106/existing user 107. This set of verified users within the vicinity of another verified user may then be determined to be receptive to broadcasts transmitted by the new user 106/existing user 107 and to be available as transmitters of broadcasts to the new user 106/existing user 107.

The radial distribution module 140 (e.g., that applies the radial algorithm 240 of FIG. 2 using a series of modules working in concert as described in FIG. 2) in effect may create a social connection 138 between verified users of the network 101 that allows the users to communicate with each other, and this link may be based on the physical distance between the users as measured relative to a current geospatial location of the device 104 (e.g., a mobile device 504) with a claimed and verified (e.g., through a verification mechanism such as a postcard verification, a utility bill verification, and/or a vouching of the user with other users) non-transitory location (e.g., a home location, a work location) of the user and/or other users. In an alternate embodiment, the transitory location of the user (e.g., their current location, a current location of their vehicle and/or mobile phone) and/or the other users may also be used by the radial algorithm to determine an appropriate threshold distance for broadcasting a message.

Furthermore, the radial distribution module 140 (e.g., that applies the radial algorithm 240 of FIG. 2 using a series of modules working in concert as described in FIG. 2) may automatically update a set of pages associated with profiles of individuals and/or businesses that have not yet joined the network based on pre-seeded address information. In effect, the radial distribution module 140 (e.g., that applies the radial algorithm 240 of FIG. 2 using a series of modules working in concert as described in FIG. 2) may update pre-seeded pages in a geo-constrained radial distance from where a broadcast originates (e.g., using an epicenter 144 calculated from the current location of the device 104 (e.g., a mobile device 504)) with information about the social connection broadcast data 102. In effect, through this methodology, the radial distribution module 140 (e.g., that applies the radial algorithm 240 of FIG. 2 using a series of modules working in concert as described in FIG. 2) may leave ‘inboxes’ and/or post ‘alerts’ on pages created for users that have not yet signed up based on a confirmed address of the users through a public and/or a private data source (e.g., from Infogroup®, from a white page directory, etc.).

The radial distribution module 140 (e.g., that applies the radial algorithm 240 of FIG. 2 using a series of modules working in concert as described in FIG. 2) of the social-networkable apparel server 100 may be different from previous implementations because it is the first implementation to simulate the experience of local radio transmission between individuals using the internet and non-radio network technology by basing their network broadcast range on the proximity of verified users to one another, according to one or more embodiments.

FIG. 1 illustrates a number of operations between the device 104 and the recipients 114 and/or the service providers 109. Particularly, circle ‘1’ of FIG. 1 illustrates that the user of the device 104 communicates the social connection broadcast data 102 to the social-networkable apparel server 100 using the network 101. Then, after applying the radial algorithm 240 utilizing the radial distribution module 140, the social-networkable apparel server 100 generates and communicates an appropriate notification data (e.g., the notification data 112) associated with the social connection broadcast data 102 to a geospatially distributed set of recipients 114 in a radial area (radius represented as ‘r’ of FIG. 1) in a geospatial vicinity from an epicenter 144 associated a present geospatial location with the device 104 as illustrated as circle ‘2’ in FIG. 1.

The radial algorithm 240 may operate as follows, according to one or more embodiments. The radial algorithm may utilize a radial distribution function (e.g., a pair correlation function)

g(r)

in the opportunity network 150. The radial distribution function may describe how density varies as a function of distance from a new user 106/existing user 107, according to one or more embodiments.

If a given new user 106/existing user 107 is taken to be at the origin O (e.g., the epicenter 144), and if

p=N/V

is the average number density of recipients 114 in the opportunity network 150, then the local time-averaged density at a distance r from O is

pg(r)

according to one or more embodiments. This simplified definition may hold for a homogeneous and isotropic type of recipients 114, according to one or more embodiments of the radial algorithm 240.

A more anisotropic distribution (e.g., exhibiting properties with different values when measured in different directions) of the recipients 114 will be described below, according to one or more embodiments of the radial algorithm 240. In simplest terms it may be a measure of the probability of finding a recipient at a distance of r away from a given new user 106/existing user 107, relative to that for an ideal distribution scenario, according to one or more embodiments. The anisotropic algorithm involves determining how many recipients 114 are within a distance of r and r+dr away from the new user 106/existing user 107, according to one or more embodiments. The radial algorithm 240 may be determined by calculating the distance between all user pairs and binning them into a user histogram, according to one or more embodiments.

The histogram may then be normalized with respect to an ideal user at the origin o, where user histograms are completely uncorrelated, according to one or more embodiments. For three dimensions (e.g., such as a building representation in the geospatially constrained social network 142 in which there are multiple residents in each floor), this normalization may be the number density of the system multiplied by the volume of the spherical shell, which mathematically can be expressed as

g(r)_{X}=4πr²pdr,

where p may be the user density, according to one or more embodiments of the radial algorithm 240.

The radial distribution function of the radial algorithm 240 can be computed either via computer simulation methods like the Monte Carlo method, or via the Ornstein-Zernike equation, using approximative closure relations like the Percus-Yevick approximation or the Hypernetted Chain Theory, according to one or more embodiments

This may be important because by confining the broadcast reach of a verified user in the opportunity network 150 to a specified range, the radial distribution module 140 (e.g., that applies the radial algorithm 240 of FIG. 2 using a series of modules working in concert as described in FIG. 2) may replicate the experience of local radio broadcasting and enable verified users to communicate information to their immediate neighbors as well as receive information from their immediate neighbors in areas that they care about, according to one or more embodiments. Such methodologies can be complemented with hyperlocal advertising targeted to potential users of the social-networkable apparel server 100 on pre-seeded profile pages and/or active user pages of the social-networkable apparel server 100. Advertisement communications thus may become highly specialized and localized resulting in an increase in their value and interest to the local verified users of the network through the social-networkable apparel server 100.

The radial distribution module 140 (e.g., that applies the radial algorithm 240 of FIG. 2 using a series of modules working in concert as described in FIG. 2) may solve the problem of trying to locate a receptive audience to a verified user's broadcasts, whether that broadcast may be one's personal music, an advertisement for a car for sale, a solicitation for a new employee, and/or a recommendation for a good restaurant in the area. This radial distribution module 140 (e.g., that applies the radial algorithm 240 of FIG. 2 using a series of modules working in concert as described in FIG. 2) may eliminate unnecessarily broadcasting that information to those who are not receptive to it, both as a transmitter and as a recipient of the broadcast. The radial algorithm saves both time and effort of every user involved by transmitting information only to areas that a user cares about, according to one or more embodiments.

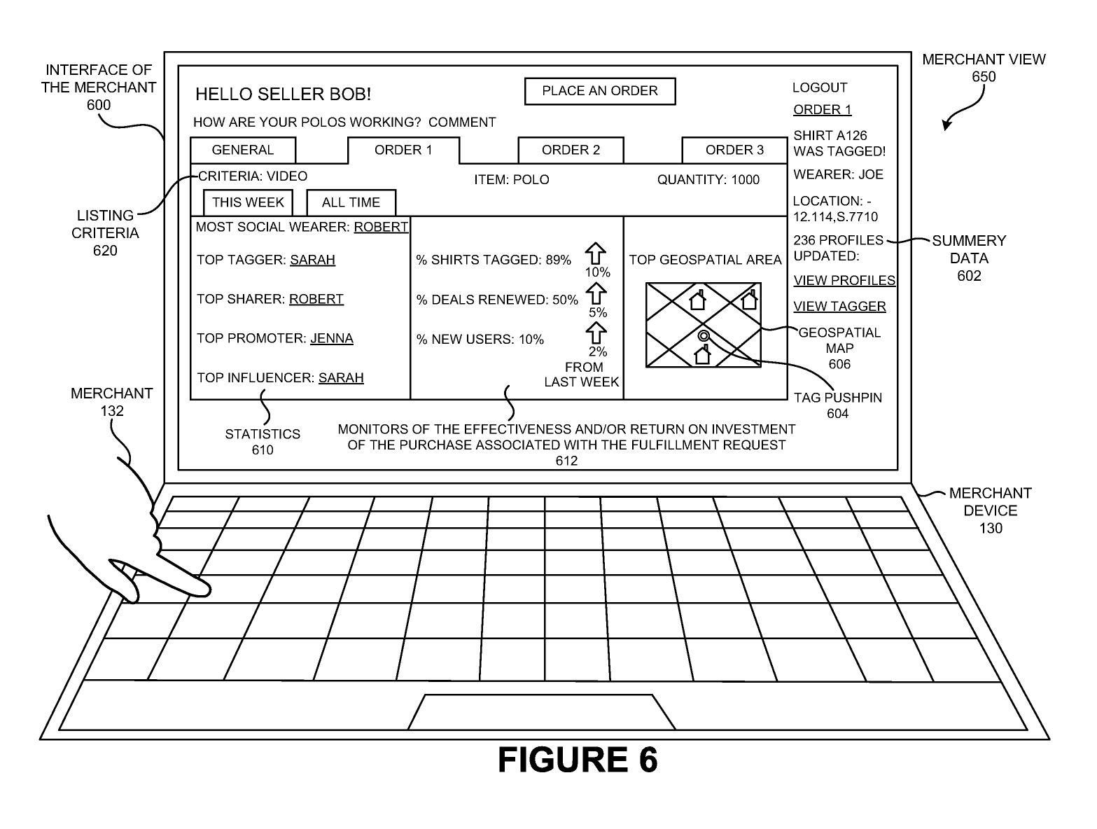

In effect, the radial algorithm of the social-networkable apparel server 100 enables users to notify people around locations that are cared about (e.g., around where they live, work, and/or where they are physically located). In one embodiment, the new user 106/existing user 107 can be provided ‘feedback’ after the social connection broadcast data 102 may be delivered to the recipients 114 and/or to the service providers 109 using the radial distribution module 140 (e.g., that applies the radial algorithm 240 of FIG. 2 using a series of modules working in concert as described in FIG. 2) of the social-networkable apparel server 100. For example, after the social connection broadcast data 102 may be delivered, the device 104 (e.g., a mobile device 504) may display a message saying: “3256 neighbors around a 1 mile radius from you have been notified on their profile pages of your gardening job notification in Menlo Park” and/or “8356 neighbors around a 1 mile radius from you have been notified of your full time job opportunity at your restaurant.” The merchant device 130 associated with the merchant 132 may be updated with a summary data 602 (shown in FIG. 6) (e.g., how many profiles were updated about the tagging 105, the ID of the tagger (e.g., the new user 106, the existing user 107), the individual wearing the taggable apparel 136, and/or the geospatial coordinates 103).

The various embodiments described herein of the social-networkable apparel server 100 using the radial distribution module 140 (e.g., that applies the radial algorithm 240 of FIG. 2 using a series of modules working in concert as described in FIG. 2) may solve a central problem of internet radio service providers (e.g., Pandora) by retaining cultural significance related to a person's locations of association. For example, the radial distribution module 140 (e.g., that applies the radial algorithm 240 of FIG. 2 using a series of modules working in concert as described in FIG. 2) may be used to ‘create’ new radio stations, television stations, and/or mini alert broadcasts to a geospatially constrained area on one end, and provide a means for those ‘tuning in’ to consume information posted in a geospatial area that the listener cares about and/or associates themselves with. The information provided can be actionable in that the new user 106/existing user 107 may be able to secure new opportunities through face to face human interaction and physical meeting not otherwise possible in internet radio scenarios.

The radial algorithm may be a set of instructions that may enable users (e.g., verified users, non-verified users) of the Nextdoor.com and Fatdoor.com websites and applications to broadcast their activities (e.g., garage sale, t-shirt sale, crime alert) to surrounding neighbors within a claimed neighborhood and to guests of a claimed neighborhood, according to one or more embodiments. The radial algorithm may be new because current technology does not allow for users of a network (e.g., Nextdoor.com, Fatdoor.com) to locally broadcast their activity to a locally defined geospatial area. With the radial algorithm, users of the network may communicate with one another in a locally defined manner, which may present more relevant information and activities, according to one or more embodiments. For example, if a verified user of the network broadcasts an item for sale, locally defined neighbors of the verified user may be much more interested in purchasing the product compared to if the item was for sale in a different town or city, according to one or more embodiments. The radial distribution module 140 may solve the problem of neighbors living in the locally defined geospatial area who don't typically interact, and allows them to connect within a virtual space that did not exist before, according to one or more embodiments. Prior to this invention of the radial algorithm 240 operating through the radial distribution module 140, community boards (e.g., job boards, for sale boards) were the only method of distributing content in a surrounding neighborhood effectively. However, there was no way to easily distribute content related to exigent circumstances and/or with urgency in a broadcast-like manner to those listening around a neighborhood through mobile devices 504 (e.g., a computing device) until the various embodiments applying the radial distribution module 140 as described herein.

A radial algorithm 240 may be a method of calculating a sequence of operations, and in this case a sequence of radio operations, according to one or more embodiments. Starting from an initial state and initial input, the radial algorithm 240 describes a computation that, when executed, proceeds through a finite number of well-defined successive states, eventually producing radial patterned distribution (e.g., simulating a local radio station), according to one or more embodiments.

The social-networkable apparel server 100 may solve technical challenges through the radial distribution module 140 (e.g., that applies the radial algorithm 240 of FIG. 2 using a series of modules working in concert as described in FIG. 2) by implementing a vigorous screening process to screen out any lewd or vulgar content in one embodiment. For example, what may be considered lewd content sometimes could be subjective, and the operator of the social-networkable apparel server 100 could argue that we are restricting their constitutional right to freedom of speech through a crowd-moderation capability enabled by the radial distribution module 140 (e.g., that applies the radial algorithm 240 of FIG. 2 using a series of modules working in concert as described in FIG. 2), according to one or more embodiments. In one embodiment, verified users may sign an electronic agreement to screen their content and agree that the opportunity network 150 may delete any content that it deems inappropriate for broadcasting, through the radial distribution module 140 (e.g., that applies the radial algorithm 240 of FIG. 2 using a series of modules working in concert as described in FIG. 2) according to one or more embodiments.

The radial distribution module 140 (e.g., that applies the radial algorithm 240 of FIG. 2 using a series of modules working in concert as described in FIG. 2) may allow verified users to create and broadcast their own radio show, e.g., music, talk show, commercial, instructional contents, etc., and to choose their neighborhood(s) for broadcasting based on a claimed location, according to one or more embodiments. The radial distribution module 140 (e.g., that applies the radial algorithm 240 of FIG. 2 using a series of modules working in concert as described in FIG. 2) may allow users to choose the neighborhoods that they would want to receive the broadcasts, live and recorded broadcasts, and/or the types and topics of broadcasts that interest them.

The radial distribution module 140 (e.g., that applies the radial algorithm 240 of FIG. 2 using a series of modules working in concert as described in FIG. 2) based approach of the social-networkable apparel server 100 may be a completely different concept from the currently existing neighborhood (e.g. geospatial) social networking options. The radial distribution module 140 (e.g., that applies the radial algorithm 240 of FIG. 2 using a series of modules working in concert as described in FIG. 2) may also allow the user to create his/her own radio station, television station and/or other content such as the social connection broadcast data 102 and distribute this content around locations to users and pre-seeded profiles around them. The radial distribution module 140 (e.g., that applies the radial algorithm 240 of FIG. 2 using a series of modules working in concert as described in FIG. 2) can allow verified users to create their content and broadcast in the selected geospatial area. It also allows verified listeners to listen to only the relevant local broadcasts of their choice.

The radial distribution module 140 (e.g., that applies the radial algorithm 240 of FIG. 2 using a series of modules working in concert as described in FIG. 2) may be important because it may provide any verified user the opportunity to create his/her own radial broadcast message (e.g., can be audio, video, pictoral and/or textual content) and distribute this content to a broad group. Radial distribution module 140 (e.g., that applies the radial algorithm 240 of FIG. 2 using a series of modules working in concert as described in FIG. 2) may also allow verified listeners listen to any missed live broadcasts through the prerecorded features, according to one or more embodiments. Through this, the radial distribution module 140 (e.g., that applies the radial algorithm 240 of FIG. 2 using a series of modules working in concert as described in FIG. 2) changes the way social networks (e.g., Nextdoor, Fatdoor, Facebook, Path, etc.) operate by enabling location centric broadcasting to regions that a user cares about, according to one or more embodiments. Radial distribution module 140 (e.g., that applies the radial algorithm 240 of FIG. 2 using a series of modules working in concert as described in FIG. 2) may solve a technical challenge by defining ranges based on a type of job posting, a type of neighborhood, and/or boundary condition of a neighborhood by analyzing whether the social connection broadcast data 102 may be associated with a particular kind of job, a particular neighborhood, a temporal limitation, and/or through another criteria.

By using the radial distribution module 140 (e.g., that applies the radial algorithm 240 of FIG. 2 using a series of modules working in concert as described in FIG. 2) of the social-networkable apparel server 100 the verified user 16 may be able to filter irrelevant offers and information provided by broadcasts. In one embodiment, only the broadcasting user (e.g., the new user 106/existing user 107) may be a verified user to create accountability for a particular broadcast and/or credibility of the broadcaster. In this embodiment, recipients 114 of the broadcast may not need to be verified users of the opportunity network. By directing traffic and organizing the onslaught of broadcasts, the radial distribution module 140 (e.g., that applies the radial algorithm 240 of FIG. 2 using a series of modules working in concert as described in FIG. 2) of the social-networkable apparel server 100 may able to identify the origins and nature of each group of incoming information and locate recipients 114 that are relevant/interested in the social connection broadcast data 102, maximizing the effective use of each broadcast.

The radial distribution module 140 (e.g., that applies the radial algorithm 240 of FIG. 2 using a series of modules working in concert as described in FIG. 2) of the social-networkable apparel server 100 may process the input data from the device 104 (e.g., a mobile device 504) in order to identify which notification(s) to broadcast to which individual(s). This may be separate from a traditional radio broadcast as it not only geographically constrains broadcasters and recipients 114 but also makes use of user preferences in order to allow broadcasters to target an optimal audience and allow recipients 114 to alter and customize what they consume. The new user 106/existing user 107 may associate his/herself with a non-transitory address in order to remain constantly connected to their neighborhood and/or neighbors even when they themselves or their neighbors are away. The radial algorithm 240 may be also unique from a neighborhood social network (e.g., the geospatially constrained social network 142) as it permits users to broadcast offers, information, audio, video etc. to other users, allowing users to create their own stations.

In order to implement the radial distribution module 140 (e.g., that applies the radial algorithm 240 of FIG. 2 using a series of modules working in concert as described in FIG. 2), geospatial data may need to be collected and amassed in order to create a foundation on which users may sign up and verify themselves by claiming a specific address, associating themselves with that geospatial location. The radial distribution module 140 (e.g., that applies the radial algorithm 240 of FIG. 2 using a series of modules working in concert as described in FIG. 2) may then be able to utilize the geospatial database 122 to filter out surrounding noise and deliver only relevant data to recipients 114. In order to accomplish this, the radial distribution module 140 (e.g., that applies the radial algorithm 240 of FIG. 2 using a series of modules working in concert as described in FIG. 2) may be able to verify the reliability of geospatial coordinates, time stamps, and user information associated with the device 104 (e.g., a mobile device 504). In addition, threshold geospatial radii, private neighborhood boundaries, and personal preferences may be established in the social-networkable apparel server 100 and accommodated using the radial distribution module 140 (e.g., that applies the radial algorithm 240 of FIG. 2 using a series of modules working in concert as described in FIG. 2). The geospatial database 122 may work in concert with the radial distribution module 140 (e.g., that applies the radial algorithm 240 of FIG. 2 using a series of modules working in concert as described in FIG. 2) to store, organize, and manage broadcasts, pushpins, user profiles, pre-seeded user profiles, social connection broadcast data, and epicenter 144 locations associated with the geospatially constrained social network 142 (e.g., a neighborhood social network such as Fatdoor.com, Nextdoor.com).

The radial algorithm 240 may be used to calculate relative distances between each one of millions of records as associated with each placed geo-spatial coordinate in the geospatially constrained social network 142 (e.g., a neighborhood social network such as Fatdoor.com, Nextdoor.com). Calculations of relative distance between each geospatial coordinate can be a large computational challenge because of the high number of reads, writes, modify, and creates associated with each geospatial coordinate added to the geospatially constrained social network 142 and subsequent recalculations of surrounding geospatial coordinates associated with other users and/or other profile pages based a relative distance away from a newly added set of geospatial coordinates (e.g., associated with the social connection broadcast data 102 and/or with other pushpin types). To overcome this computational challenge, the radial algorithm may leverage a massively parallel computing architecture 146 through which processing functions are distributed across a large set of processors accessed in a distributed computing system 148 through the network 101.

In order to achieve the utilization of the massively parallel computing architecture 146 in a context of a radial distribution function of a geospatially constrained social network 142, a number of technical challenges have been overcome in at least one embodiment. Particularly, the radial distribution module 140 constructs a series of tables based on an ordered geospatial ranking based on frequency of interaction through a set of ‘n’ number of users simultaneously interacting with the geospatially constrained social network 142, in one preferred embodiment. In this manner, sessions of access between the social-networkable apparel server 100 and users of the social-networkable apparel server 100 (e.g., the new user 106/existing user 107) may be monitored based on geospatial claimed areas of the user (e.g., a claimed work and/or home location of the user), and/or a present geospatial location of the user. In this manner, tables associated with data related to claimed geospatial areas of the user and/or the present geospatial location of the user may be anticipatorily cached in the memory 124 to ensure that a response time of the geospatially constrained social network 142 may be not constrained by delays caused by extraction, retrieval, and transformation of tables that are not likely to be required for a current and/or anticipated set of sessions between users and the social-networkable apparel server 100.

In a preferred embodiment, an elastic computing environment may be used by the radial distribution module 140 to provide for increase/decreases of capacity within minutes of a database function requirement. In this manner, the radial distribution module 140 can adapt to workload changes based on number of requests of processing simultaneous and/or concurrent requests associated with social connection broadcast data 102 by provisioning and deprovisioning resources in an autonomic manner, such that at each point in time the available resources match the current demand as closely as possible.

The radial distribution module 140 (e.g., that applies the radial algorithm 240 of FIG. 2 using a series of modules working in concert as described in FIG. 2) may be a concept whereby a server communicating data to a dispersed group of recipients 114 (e.g., the new user 106, the existing user 107, the wearer of the taggable apparel, the merchant 132 and/or other users) over a network 101, which may be an internet protocol based wide area network (as opposed to a network communicating by radio frequency communications) communicates that data only to a geospatially-constrained group of recipients 114 (e.g., the new user 106, the existing user 107, the wearer of the taggable apparel, the merchant 132 and/or other users). The radial distribution module 140 (e.g., that applies the radial algorithm 240 of FIG. 2 using a series of modules working in concert as described in FIG. 2) may apply a geospatial constraint related to a radial distance away from an origin point, or a constraint related to regional, state, territory, county, municipal, neighborhood, building, community, district, locality, and/or other geospatial boundaries.

The radial distribution module 140 (e.g., that applies the radial algorithm 240 of FIG. 2 using a series of modules working in concert as described in FIG. 2) may be new as applied to data traveling over wide area networks using internet protocol topology in a geospatial social networking and commerce context, according to one or more embodiments. While radio broadcasts, by their nature, are transmitted in a radial pattern surrounding the origin point, there may be no known mechanism for restricting access to the data only to verified users of a service subscribing to the broadcast. As applied to wired computer networks, while techniques for applying geospatial constraints have been applied to search results, and to other limited uses, there has as yet been no application of geospatial constraint as applied to the various embodiments described herein using the radial distribution module 140 (e.g., that applies the radial algorithm 240 of FIG. 2 using a series of modules working in concert as described in FIG. 2).

The radial distribution module 140 (e.g., that applies the radial algorithm 240 of FIG. 2 using a series of modules working in concert as described in FIG. 2) may be roughly analogous to broadcast radio communications such as a) in broadcast radio, b) in wireless computer networking, and c) in mobile telephony. However, all of these systems broadcast their information promiscuously, making the data transmitted available to anyone within range of the transmitter who may be equipped with the appropriate receiving device. In contrast, the radial distribution module 140 (e.g., that applies the radial algorithm 240 of FIG. 2 using a series of modules working in concert as described in FIG. 2) herein describes a system in which networks are used to transmit data in a selective manner in that information may be distributed around a physical location of homes or businesses in areas of interest/relevancy.

The radial distribution module 140 (e.g., that applies the radial algorithm 240 of FIG. 2 using a series of modules working in concert as described in FIG. 2) may solve a problem of restricting data transmitted over networks to specific users who are within a specified distance from the individual who originates the data. In a broad sense, by enabling commerce and communications that are strictly limited within defined neighborhood boundaries, the radial distribution module 140 (e.g., that applies the radial algorithm 240 of FIG. 2 using a series of modules working in concert as described in FIG. 2) may enable the geospatially constrained social network 142 (e.g., a neighborhood social network such as Fatdoor.com, Nextdoor.com) communications, attacking the serious social conditions of anonymity and disengagement in community that afflict the nation and, increasingly, the world.

The radial distribution module 140 (e.g., that applies the radial algorithm 240 of FIG. 2 using a series of modules working in concert as described in FIG. 2) may comprise one or more modules that instruct the social-networkable apparel server 100 to restrict the broadcasting of the social connection broadcast data 102 to one or more parts of the geospatial area 117. For example, in the embodiment of FIG. 1, the radial distribution module 140 (e.g., that applies the radial algorithm 240 of FIG. 2 using a series of modules working in concert as described in FIG. 2) may instruct the social-networkable apparel server 100 to broadcast the social connection broadcast data 102 to the recipients 114 but not to the area outside the threshold radial distance 115.

In one or more embodiments, the radial distribution module 140 (e.g., that applies the radial algorithm 240 of FIG. 2 using a series of modules working in concert as described in FIG. 2) may allow the social-networkable apparel server 100 to function in manner that simulates a traditional radio broadcast (e.g., using a radio tower to transmit a radio frequency signal) in that both the social-networkable apparel server 100 and the radio broadcast are restricted in the geospatial scope of the broadcast transmission. In one or more embodiments, the radial distribution module 140 (e.g., that applies the radial algorithm 240 of FIG. 2 using a series of modules working in concert as described in FIG. 2) may prevent the broadcast of the social connection broadcast data 102 to any geospatial area to which the new user 106/existing user 107 does not wish to transmit the social connection broadcast data 102, and/or to users that have either muted and/or selectively subscribed to a set of broadcast feeds.

The radial distribution module 140 (e.g., that applies the radial algorithm 240 of FIG. 2 using a series of modules working in concert as described in FIG. 2) may analyze the social connection broadcast data 102 to determine which recipients 114 may receive notification data 112 within a threshold radial distance 119 (e.g., set by the new user 106/existing user 107 and/or auto calculated based on a type of job posting). The radial distribution module 140 (e.g., that applies the radial algorithm 240 of FIG. 2 using a series of modules working in concert as described in FIG. 2) may use a variety of parameters, including information associated with the social connection broadcast data (e.g. location of job, type of job, etc.) to determine the threshold radial distance 119.

The radial distribution module 140 (e.g., that applies the radial algorithm 240 of FIG. 2 using a series of modules working in concert as described in FIG. 2) may also determine which verified addresses associated with recipients 114 having verified user profiles are located within the threshold radial distance 119. The radial distribution module 140 (e.g., that applies the radial algorithm 240 of FIG. 2 using a series of modules working in concert as described in FIG. 2) may then broadcast the notification data 112 to the profiles and/or mobile devices of the verified users having verified addresses within the threshold radial distance 119.

The radial distribution module 140 (e.g., that applies the radial algorithm 240 of FIG. 2 using a series of modules working in concert as described in FIG. 2) may therefore simulate traditional radio broadcasting (e.g. from a radio station transmission tower) over the IP network. Thus, the radial distribution module 140 (e.g., that applies the radial algorithm 240 of FIG. 2 using a series of modules working in concert as described in FIG. 2) may allow the broadcast to include information and data that traditional radio broadcasts may not be able to convey, for example geospatial coordinates and/or real-time bi-directional communications. Additionally, the radial distribution module 140 (e.g., that applies the radial algorithm 240 of FIG. 2 using a series of modules working in concert as described in FIG. 2) may allow individual users low-entry broadcast capability without resort to expensive equipment and/or licensing by the Federal Communications Commission (FCC).

Another advantage of this broadcast via the radial distribution module 140 (e.g., that applies the radial algorithm 240 of FIG. 2 using a series of modules working in concert as described in FIG. 2) may be that it may bypass obstructions that traditionally disrupt radio waves such as mountains and/or atmospheric disturbances. Yet another advantage of the radial distribution module 140 (e.g., that applies the radial algorithm 240 of FIG. 2 using a series of modules working in concert as described in FIG. 2) may be that it may expand the physical distance of broadcast capability without resort to the expense ordinarily associated with generating powerful carrier signals. In yet another advantage, the radial distribution module 140 (e.g., that applies the radial algorithm 240 of FIG. 2 using a series of modules working in concert as described in FIG. 2) may allow for almost unlimited channels and/or stations as compared to traditional radio where only a narrow band of electromagnetic radiation has been appropriated for use among a small number of entities by government regulators (e.g. the FCC).

The new user 106/existing user 107 may be an individual who operates the device 104 (e.g., a mobile device 504) to generate the social connection broadcast data 102. It will be understood by those skilled in the art that the verified nature of the user may be an optional characteristic in an alternate embodiment. This means that in an alternate embodiment, any user (whether verified or not) may generate the social connection broadcast data 102 through the device 104 (e.g., a mobile device 504). In another alternative embodiment, the new user 106/existing user 107 may be an electronic sensor, such as a detection sensor device (e.g., a sensory detection sensor device such as a motion detector, a chemical detection device, etc.), and/or an appliance (e.g., such as a refrigerator, a home security network, and/or a motion detector). It should also be noted that the ‘mobile’ nature of the device 104 may be optional in yet another alternative embodiment. In such an alternate embodiment, any computing device, whether mobile/portable or fixed in location may generate the social connection broadcast data 102.

The cellular network 108 may be associated with a telephone carrier (e.g., such as AT&T, Sprint, etc.) that provides an infrastructure through which communications are generated between the social-networkable apparel server 100 and the service providers 109 using the radial algorithm 240. For example, the cellular network 108 may provide a communication infrastructure through which the social connection broadcast data 102 may be communicated as voice and/or text messages through telephones (e.g., standard telephones and/or smart phones) operated by at least some of the service providers 109 of FIG. 1. It should be understood that in one embodiment, the service providers 109 are paid subscribers/customers of the geospatially constrained social network 142 in a manner such that each of the service providers 109 may pay a fee per received social connection broadcast data 102, and/or each hired engagement to the geospatially constrained social network 142. The service providers 109 may pay extra to be permitted access to receive the social connection broadcast data 102 even when they do not have a transitory and/or non-transitory connection to a neighborhood if they service that neighborhood area though operating their business outside of it. For this reason, FIG. 1 visually illustrates that the service providers 109 may be located (e.g., principal business address) outside the threshold radial distance 119.

The cellular network 108 (e.g., a mobile network) may be a wireless network distributed over land areas called cells, each served by at least one fixed-location transceiver, known as a cell site or base station through which the social connection broadcast data 102 is distributed from the social-networkable apparel server 100 to telephones of the service providers 109 using the radial distribution module 140 (e.g., that applies the radial algorithm 240 of FIG. 2 using a series of modules working in concert as described in FIG. 2), according to one or more embodiments. The cellular network 108 may use a set of frequencies from neighboring cells, to avoid interference and provide guaranteed bandwidth within each cell, in one embodiment.

When joined together these cells of the cellular network 108 may provide radio coverage over a wide geographic area through the cellular network 108 in a manner that ensures that the social connection broadcast data 102 may be simultaneously communicated via both IP networks (e.g., to the recipients 114) and/or to the service providers 109 through the cellular network 108. It will be appreciated that the radial distribution module 140 (e.g., that applies the radial algorithm 240 of FIG. 2 using a series of modules working in concert as described in FIG. 2) in effect permits simultaneous updates to claimed user pages, unclaimed (pre-seeded) user pages in a geospatially constrained social network 142 (e.g., neighborhood social network) based on a geospatial location of the device 104 (e.g., a mobile device 504) in a manner that simulates a radio (RF) based network separately from the concepts described in conjunction with the cellular network 108. However, it will be understood that the radial distribution module 140 (e.g., that applies the radial algorithm 240 of FIG. 2 using a series of modules working in concert as described in FIG. 2) may be not restricted to such topology and can multimodally communicate through different networks, such as through the cellular network 108 described in FIG. 1.

The service providers 109 may be locations, devices, and/or mobile phones associated with individuals and/or agencies for hire. The service providers 109 may be notified when a work opportunity in an area that they care about including a non-transitory location (e.g., around where they live and/or work, regardless of where they currently are) and a transitory location (e.g., where they currently are) is posted using the device 104 (e.g., a mobile device 504) as the social connection broadcast data 102.

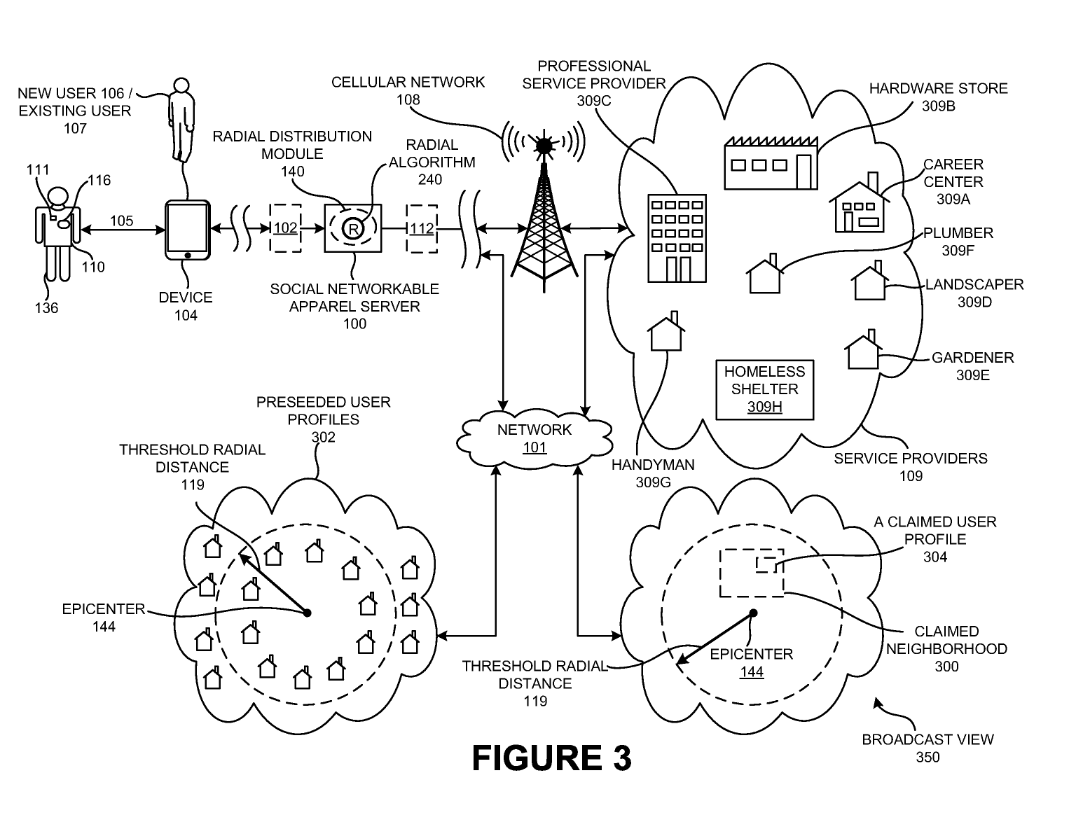

The service providers 109 are illustrated in FIG. 3 as including a hardware store 110A, a homeless shelter 110B, a career center 110C, and a set of professional(s) 110. In this manner, mobile devices and/or desktop computers operated by the service providers 109 may be alerted whenever the social connection broadcast data 102 is posted in and/or around their neighborhood through a push notification (e.g., an alert popping up on their phone), through an email, a telephone call, and/or a voice message delivered to the particular mobile device 504 (e.g., computing device) operated by each of the service providers 109 using the radial distribution module 140 (e.g., that applies the radial algorithm 240 of FIG. 2 using a series of modules working in concert as described in FIG. 2).

The social connection broadcast data 102 may be delivered as notification data 112 (which may include a number of attributes as later will be described with reference to FIG. 2) from the social-networkable apparel server 100 to the recipients 114 (e.g., the new user 106, the existing user 107, the individual wearing the taggable apparel 136, the merchant 132 and/or an another user) and/or to the service providers 109 using the radial distribution module 140 (e.g., that applies the radial algorithm 240 of FIG. 2 using a series of modules working in concert as described in FIG. 2) of the social-networkable apparel server 100.

The recipients 114 may be individuals that have claimed a profile (e.g., verified their profile through a postcard, a telephone lookup, a utility bill) associated with a particular non-transitory address (e.g., a home address, a work address) through a geospatial social network (e.g., a geospatially constrained social network 142 (e.g., a neighborhood social network such as Fatdoor.com, Nextdoor.com)) through which the social-networkable apparel server 100 operates. The recipients 114 may be in a geo-fenced area, in that an epicenter 144 of a broadcast message from the device 104 (e.g., a mobile device 504) may be a center through which a radial distance is calculated based on a characteristic of the social connection broadcast data 102. For example, a push notification (not shown) may be delivered in a 0.1 mile radius, and an on page-posting may be automatically delivered to a broader 0.6 mile radius either automatically and/or through a user defined preference (e.g., set by the new user 106/existing user 107).

It should be appreciated that individuals in an area outside the threshold radial distance 115 may not receive the social connection broadcast data 102 because their geospatial address may be outside a radial boundary surrounding an epicenter 144 in which the social connection broadcast data 102 originates. Additionally, the threshold radial distance 119 may be confined on its edges by a geospatial polygon at a juncture between area defined by recipients 114 and the area outside the threshold radial distance 115, according to one or more embodiments.

FIG. 2 is an exploded view of the radial distribution module 140 of FIG. 1 that applies the radial algorithm 240, according to one or more embodiments.

Particularly, FIG. 2 illustrates an exploded view of the radial distribution module 140, according to one or more embodiments. A variety of software instruction sets and/or hardware components form the radial distribution module 140, according to one or more embodiments. Select ones of these software instruction sets and/or hardware components utilize the radial algorithm 240 to perform functions related to radially distributing information to pre-seeded user profiles, user profiles, and telephone devices (e.g., land based phones, circuit switched phones).

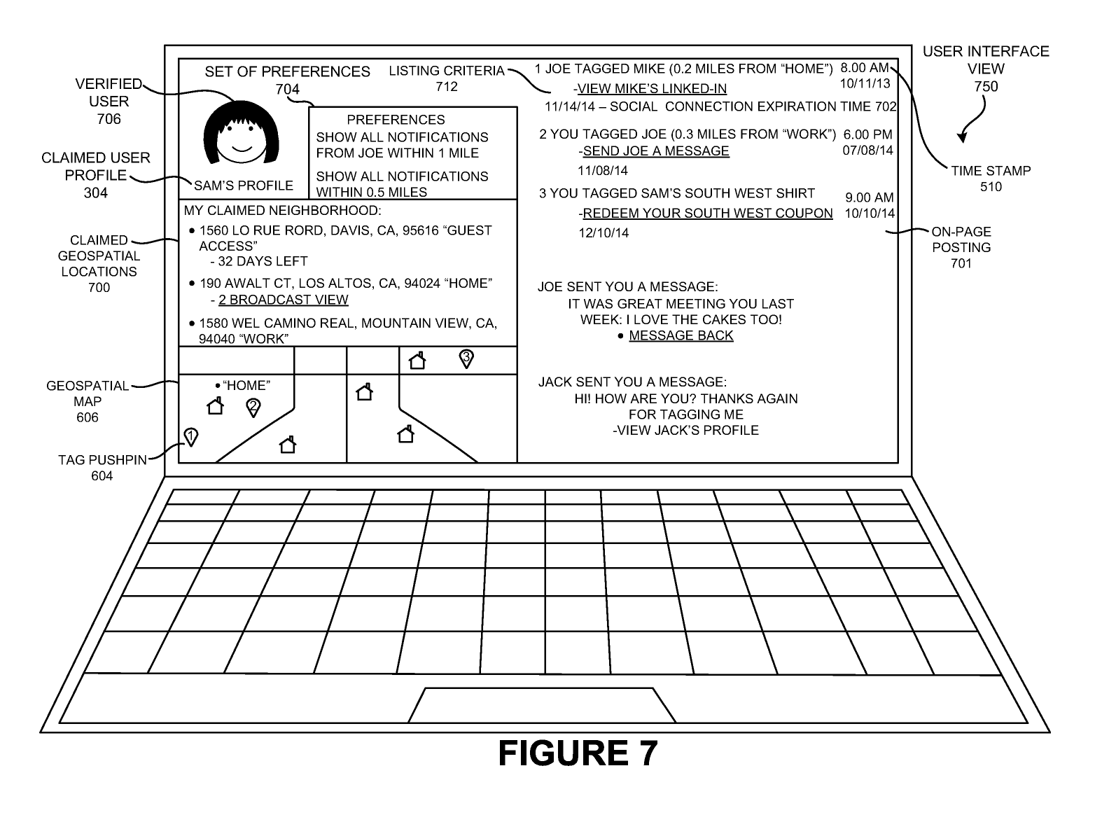

A validation module 200 may determine that a social connection broadcast data 102 generated through a mobile device 504 may be associated with a verified user (e.g., the new user 106/existing user 107 of FIG. 1 as described as the verified user 706 in FIG. 7) of the social-networkable apparel server 100) using a processor 120 and/or a memory 124. In addition, the validation module 200 may determine that the broadcast data (e.g., the social connection broadcast data 102) is generated by the validated user (e.g., the new user 106/existing user 107 of FIG. 1 as described as the verified user 706 in FIG. 7) of the neighborhood broadcasting system (e.g., of the geospatially constrained social network 142) when analyzing that the broadcast data (e.g., the social connection broadcast data 102) is associated with the mobile device 504. The validation module 200 may apply the radial algorithm 240 to determine if the verified user 706 may be in a validated geospatial location based on previous history of the verified user 706, according to one or more embodiments.

In addition, the validation module 200 may ensure that a set of geospatial coordinates 103 associated with the social connection broadcast data 102 generated through the mobile device 504 are trusted based on a claimed geospatial location (e.g., any of the claimed geospatial locations 700 as described in FIG. 7) of the verified user (e.g., the new user 106/existing user 107 of FIG. 1 as described as the verified user 706 in FIG. 7) of the social-networkable apparel server 100.

A time stamp module 202 may determine that a time stamp 510 associated with a creation date 508 and/or a of the social connection broadcast data 102 generated through the mobile device 504 may be trusted based on the claimed geospatial location (e.g., any of the claimed geospatial locations 700 as described in FIG. 7) of the verified user (e.g., the new user 106/existing user 107 of FIG. 1 as described as the verified user 706 in FIG. 7) of the social-networkable apparel server 100. A listing module 272 may determine a listing criteria 620 associated with the social connection broadcast data 102 including a description, a photograph, a video, a salary, a fixed fee amount, a category, a functional status of a job offered through the social connection broadcast data 102, wherein the job may be a household job, a repair job, a maintenance job, a professional job and/or a career opportunity.

A charting module 204 may populate an availability chart 714 when the job associated with the listing criteria 620 may be posted, wherein the availability chart 714 includes a target candidate living area radius, a start timing, an hours per day, an hours per month, a professional qualification criteria and/or a timing criteria. A submission module 274 may communicate the broadcast data (e.g., the social connection broadcast data 102) to the neighborhood broadcasting system when the broadcast data (e.g., the social connection broadcast data 102) may be processed, and/or to associate the verified user (e.g., the new user 106/existing user 107 of FIG. 1 as described as the verified user 706 in FIG. 7) with a verified user (e.g., the new user 106/existing user 107 of FIG. 1 as described as the verified user 706 in FIG. 7) profile in the neighborhood broadcasting system through the application on the mobile device 504.

A pushpin module 206 may present the social connection broadcast data 102 generated through the mobile device 504 as a tag pushpin 604 of the tag broadcast in a geospatial map 606 surrounding pre-populated residential and/or business listings in a surrounding vicinity, such that the tag alert pushpin of the tag broadcast may be automatically presented on the geospatial map 606 in addition to being presented on the set of user profiles (e.g., pre-seeded user profiles 302 and/or claimed user profiles 304 as described in FIG. 3 having associated verified addresses in the threshold radial distance 119 from the set of geospatial coordinates 103 associated with the social connection broadcast data 102 generated through the mobile device 504 of the verified user (e.g., the new user 106/existing user 107 of FIG. 1 as described as the verified user 706 in FIG. 7) of the social-networkable apparel server 100).

The radial distribution module 140 may radially distribute the social connection broadcast data 102 generated through the mobile device 504 through an on-page posting 701, an electronic communication, and/or a push notification (not shown) delivered to desktop and/or mobile devices 504 associated with users and/or their user profiles (e.g., pre-seeded user profiles 302 and/or claimed user profiles 304 as described in FIG. 3) around the epicenter 144 defined at the set of geospatial coordinates 103 associated with the social connection broadcast data 102 generated through the mobile device 504 to all subscribed user profiles (e.g., pre-seeded user profiles 302 and/or claimed user profiles 304 as described in FIG. 3) in a circular geo-fenced area defined by the threshold distance from the set of geospatial coordinates 103 associated with the social connection broadcast data 102 generated through the mobile device 504 through the radial algorithm 240 of a neighborhood broadcasting system that measures a distance away of each address associated with each user profile from the current geospatial location at the epicenter 144. A placement module 232 may enable the verified user (e.g., the new user 106/existing user 107 of FIG. 1 as described as the verified user 706 in FIG. 7) to drag and/or drop the tag alert pushpin on any location on the geospatial map 606, and/or automatically determining a latitude 720 and/or a longitude 718 associated a placed location.

A notification module 208 may automatically notify a career center 309A, a hardware store 309B, a professional service provider 309C, a landscaper 309D, a gardener 309E, a plumber 309F, a handyman 309G, and/or a homeless shelter 309H in a surrounding geospatial area to the set of geospatial coordinates 103 associated with the social connection broadcast data 102 generated through the mobile device 504. An extraction module 234 may separate the geospatial coordinates 103 from a social connection broadcast data associated with the social connection broadcast data 102 generated through the mobile device 504 when verifying that the set of geospatial coordinates 103 associated with the social connection broadcast data 102 generated through the mobile device 504 are trusted based on the claimed geospatial location (e.g., any of the claimed geospatial locations 700 as described in FIG. 7) of the verified user (e.g., the new user 106/existing user 107 of FIG. 1 as described as the verified user 706 in FIG. 7) of the social-networkable apparel server 100.

A matching module 210 may determine a relative match between a persistent clock 284 associated with the social-networkable apparel server 100 and/or a digital clock of the mobile device 504 to determine that the time stamp 510 associated with the creation date 508 and/or time of the social connection broadcast data 102 generated through the mobile device 504 may be accurate and/or therefore trusted. A deletion module 236 may automatically remove a publishing of the social connection broadcast data 102 generated through the mobile device 504 on a set of user profiles (e.g., pre-seeded user profiles 302 and/or claimed user profiles 304 as described in FIG. 3 having associated verified addresses in the threshold radial distance 119 from the set of geospatial coordinates 103 associated with the social connection broadcast data 102 generated through the mobile device 504 of the verified user (e.g., the new user 106/existing user 107 of FIG. 1 as described as the verified user 706 in FIG. 7) of the social-networkable apparel server 100) based on a social connection expiration time 702. A plotting module 238 may geocode a set of residential addresses each associated with a resident name in a neighborhood surrounding the mobile device 504.

A data-seeding module 241 may prepopulate the set of residential addresses each associated with the resident name as the set of user profiles (e.g., pre-seeded user profiles 302 and/or claimed user profiles 304 as described in FIG. 3 in the threshold radial distance 119 from the claimed geospatial location (e.g., any of the claimed geospatial locations 700 as described in FIG. 7) of the verified user (e.g., the new user 106/existing user 107 of FIG. 1 as described as the verified user 706 in FIG. 7) of the social-networkable apparel server 100 in a neighborhood curation system (e.g., part of the geospatially constrained social network 142) communicatively coupled with the social-networkable apparel server 100.

An advertisement creation module 242 may allow the user (e.g., the merchant 132) to customize an advertisement area 116 on the taggable apparel 136 based on the request of the merchant 132, wherein the advertisement area 116 may be associated with a commercial item, a service, and/or a promotional item offered by the merchant to any of those individuals that read a short range communication technology 111 (e.g., a near-field communication tag, an i-beacon) on the taggable apparel 136. Additionally, a submission module 274 may allow the user (e.g., the merchant 132) to submit a fulfillment request 810 of an order 812 by the user (e.g., the merchant 132) for a quantity 814 of the taggable apparel 110 having customized ones of the advertisement area 116 and/or each individually associated with the short range communication technology 111 through the social-networkable apparel server 100 (such that each one of the short range communication technology 111 individually identifies each the taggable apparel 110 and/or optionally a group of the taggable apparel and/or the wearer of 806 through a unique identifier 804 associated with either each of the one of the short range communication technology 111 and/or a unique uniform resource locator destination to which each read tag may be transported in the social-networkable apparel server 100). A curation permission module 264 may permit the at least one of the new user 106 and the existing user 107 to modify content in each of the set of user profiles.

Furthermore, a merchant criteria module 276 may permit the merchant 132 to log-in to the social-networkable apparel server 100 and/or set a criteria being a location sharing request, a social graph sharing request, a destination page design, a destination uniform resource locator location, and/or an updatable electronic promotion associated with each of the taggable apparel. A statistic permission module 278 may permit the merchant 132 to log-in to the social-networkable apparel server 100 132 and/or view statistics 610 related to a most social wearer of the taggable apparel, a top tagger, a top sharer, a top promoter, a top influencer, a top geospatial area of tagging, and/or a set of statistics 610 associated with an effectiveness and/or return on investment of a purchase associated with the fulfillment request.

A curation permission module 264 may allow a user (e.g., the new user 106, the existing user 107, the wearer of the taggable apparel 136) to alter content in each of the set of user profiles (e.g., pre-seeded user profiles 302 and/or claimed user profiles 304 as described in FIG. 3). A discovery module 244 may track the modified content through the neighborhood curation system (e.g., part of the geospatially constrained social network 142). An undo module 246 may generate a reversible history journal associated with each of the set of user profiles (e.g., pre-seeded user profiles 302 and/or claimed user profiles 304 as described in FIG. 3 such that a modification of the verified user (e.g., the new user 106/existing user 107 of FIG. 1 as described as the verified user 706 in FIG. 7) can be undone on a modified user profile page. A reputation module 248 may determine an editing credibility of the verified user (e.g., the new user 106/existing user 107 of FIG. 1 as described as the verified user 706 in FIG. 7) based on an edit history of the verified user (e.g., the new user 106/existing user 107 of FIG. 1 as described as the verified user 706 in FIG. 7) and/or a community contribution validation of the verified user (e.g., the new user 106/existing user 107 of FIG. 1 as described as the verified user 706 in FIG. 7) by other users of the neighborhood curation system (e.g., part of the geospatially constrained social network 142).

A publishing module 214 may automatically communicate the social connection broadcast data 102 generated through the mobile device 504 to a set of user profiles (e.g., pre-seeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7) of the verified user (e.g., the new user 106/existing user 107 of FIG. 1 as described as the verified user 706 in FIG. 7) of the social-networkable apparel server 100 using the radial algorithm 240. A claiming module 250 may process a claim request of the verified user (e.g., the new user 106/existing user 107 of FIG. 1 as described as the verified user 706 in FIG. 7) generating the social connection broadcast data 102 generated through the mobile device 504 to be associated with an address of the neighborhood curation system (e.g., part of the geospatially constrained social network 142). A private-neighborhood module 252 may determine if the claimable neighborhood in the neighborhood curation system (e.g., part of the geospatially constrained social network 142) may be associated with a private neighborhood community in the claimable neighborhood of the neighborhood curation system (e.g., part of the geospatially constrained social network 142).

An association module 216 may associate the verified user (e.g., the new user 106/existing user 107 of FIG. 1 as described as the verified user 706 in FIG. 7) with the private neighborhood community in the claimable neighborhood of the neighborhood curation system (e.g., part of the geospatially constrained social network 142) if the private neighborhood community has been activated by the verified user (e.g., the new user 106/existing user 107 of FIG. 1 as described as the verified user 706 in FIG. 7) and/or a different verified user (e.g., the new user 106/existing user 107 of FIG. 1 as described as the verified user 706 in FIG. 7). A boundary module 254 may permit the verified user (e.g., the new user 106/existing user 107 of FIG. 1 as described as the verified user 706 in FIG. 7) to draw a set of boundary lines in a form of a geospatial polygon such that the claimable neighborhood in a geospatial region surrounding the claim request creates the private neighborhood community in the neighborhood curation system (e.g., part of the geospatially constrained social network 142) if the private neighborhood community may be inactive. An address type module 256 may verify the claim request of the verified user (e.g., the new user 106/existing user 107 of FIG. 1 as described as the verified user 706 in FIG. 7) generating the social connection broadcast data 102 generated through the mobile device 504 to be associated with a neighborhood address of the neighborhood curation system (e.g., part of the geospatially constrained social network 142) when the address may be determined to be associated with a work address and/or a residential address of the verified user (e.g., the new user 106/existing user 107 of FIG. 1 as described as the verified user 706 in FIG. 7).

A concurrency module 258 may simultaneously publish the social connection broadcast data 102 generated through the mobile device 504 on the private neighborhood community associated with the verified user (e.g., the new user 106/existing user 107 of FIG. 1 as described as the verified user 706 in FIG. 7) generating the social connection broadcast data 102 generated through the tagging 105 of the short range communication technology 111 by the mobile device 504 in the threshold radial distance 119 from the address associated with the claim request of the verified user (e.g., the new user 106/existing user 107 of FIG. 1 as described as the verified user 706 in FIG. 7) of the neighborhood curation system (e.g., part of the geospatially constrained social network 142) when automatically publishing the social connection broadcast data 102 generated through the mobile device 504 on a set of user profiles (e.g., pre-seeded user profiles 302 and/or claimed user profiles 304 as described in FIG. 3 having associated verified addresses in a threshold radial distance 119 from the claimed geospatial location (e.g., any of the claimed geospatial locations 700 as described in FIG. 7) of the verified user (e.g., the new user 106/existing user 107 of FIG. 1 as described as the verified user 706 in FIG. 7) of the social-networkable apparel server 100 based on a set of preferences of the verified user (e.g., the new user 106/existing user 107 of FIG. 1 as described as the verified user 706 in FIG. 7) using the radial algorithm 240.

A broadcast determination module 260 may verify that the social connection broadcast data 102 is generated by the new user and/or the existing user of a neighborhood broadcasting system when validating that the notification data may be associated with the mobile device. A merchant module 222 may automatically initiate a video communication and/or an audio communication between the merchant device 130 of the merchant 132 and another mobile device of the wearer of the taggable apparel 136 and/or a tagger (e.g., the new user 106, the existing user 107) that performs the tagging 105 of the short range communication technology 111 (physically on the taggable apparel) through the social-networkable apparel server 100 based on a set of preset criteria through the social-networkable apparel server 100.

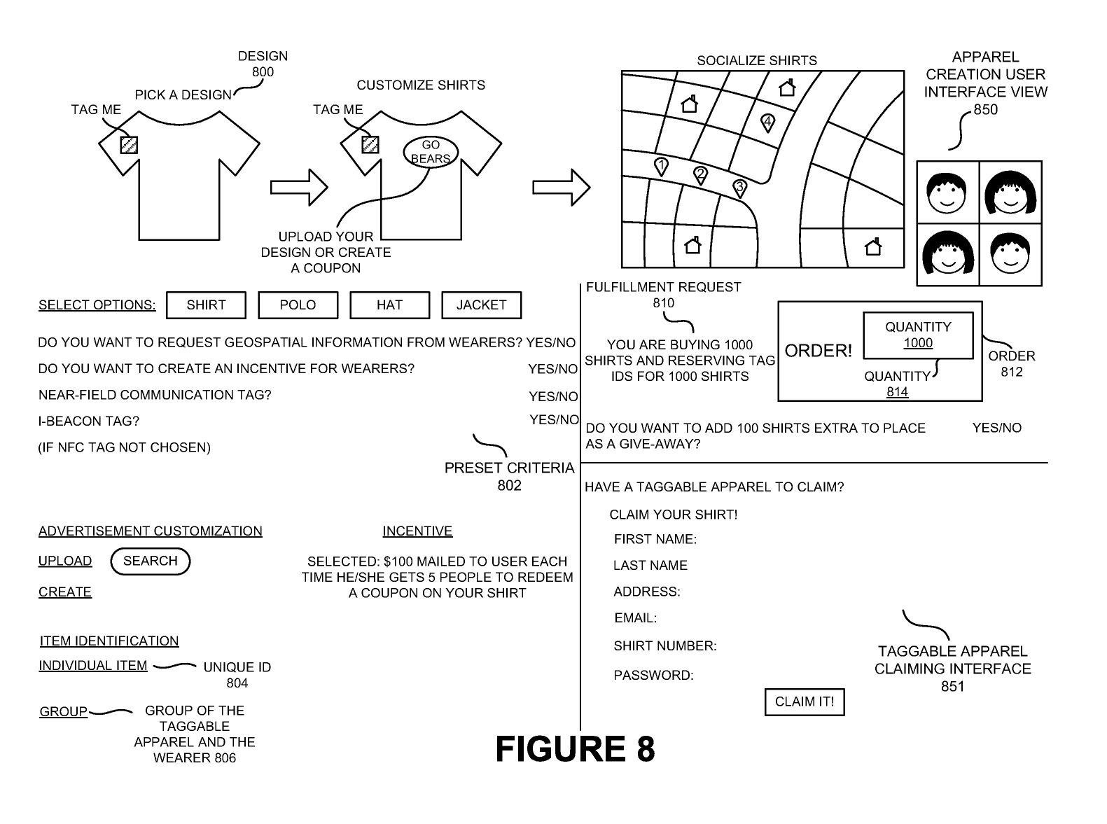

A design of the taggable apparel 110 may be selected through an apparel creator module 224 of the social-networkable apparel server 100 based on a request of a merchant 132 (as shown in FIG. 8). A communication module 266 may permit each of the individual wearing the taggable apparel and/or the tagger (e.g., the new user or the existing user that reads the short term communication technology physically on the taggable apparel) to communicate with each other and/or form social connections with each other based on the participation criteria (set by the merchant and/or the wearer of a taggable apparel and/or the tagger that reads the short term communication technology physically on the taggable apparel), such that each of the wearer of a taggable apparel and/or the tagger that reads the short term communication technology physically on the taggable apparel may be able to form social connections with each participating person associated with the tagging of the taggable apparel.

A historical applicant module 226 may permit participating merchants in the social-networkable apparel server 100 to see previous rating, interview function comments, review, prescreen questions, and/or background checks of across a plurality of applicants applying for a plurality jobs through the social-networkable apparel server 100 such that different employers benefit from previous diligence of at one of previous rating, interview function comments, review, prescreen questions, and/or background checks by participating employers with each applicant to the job that has previously applied for different jobs through the social-networkable apparel server 100. A summary module 262 may generate a summary data 602 to the merchant 132 generating the social connection broadcast data 102 generated through the mobile device 504 of how many user profile pages were updated with an alert of the social connection broadcast data 102 generated through the mobile device 504 when publishing the social connection broadcast data 102 generated through the mobile device 504 in the private neighborhood community and/or the set of user profiles (e.g., pre-seeded user profiles 302 and/or claimed user profiles 304 as described in FIG. 3 having associated verified addresses in the threshold radial distance 119 from the claimed geospatial location (e.g., any of the claimed geospatial locations 700 as described in FIG. 7) of the verified user (e.g., the new user 106/existing user 107 of FIG. 1 as described as the verified user 706 in FIG. 7) of the social-networkable apparel server 100 based on the set of preferences of the verified user (e.g., the new user 106/existing user 107 of FIG. 1 as described as the verified user 706 in FIG. 7).

A live broadcast module 228 may live broadcast the social connection broadcast data 102 generated through the mobile device 504 to the different verified user (e.g., the new user 106/existing user 107 of FIG. 1 as described as the verified user 706 in FIG. 7) and/or other verified user (e.g., another new user 106/existing user 107 of FIG. 1 as described as the verified user 706 in FIG. 7) in the private neighborhood community and/or currently within the threshold radial distance 119 from the current geospatial location through the social-networkable apparel server 100 through a multicast algorithm such that a live broadcast multicasts to a plurality of data processing systems associated with each of the different user and/or the other verified user (e.g., the new user 106/existing user 107 of FIG. 1 as described as the verified user 706 in FIG. 7) simultaneously when the mobile device 504 of the verified user (e.g., the new user 106/existing user 107 of FIG. 1 as described as the verified user 706 in FIG. 7) generating the live-broadcast enables broadcasting of the social connection broadcast data 102 generated through the mobile device 504 to any one of a geospatial vicinity around the mobile device 504 of the verified user (e.g., the new user 106/existing user 107 of FIG. 1 as described as the verified user 706 in FIG. 7) generating the broadcast and/or in any private neighborhood community in which the verified user (e.g., the new user 106/existing user 107 of FIG. 1 as described as the verified user 706 in FIG. 7) has a non-transitory connection.

A bi-directional communication module 230 may permit the different verified user (e.g., the new user 106/existing user 107 of FIG. 1 as described as the verified user 706 in FIG. 7) and/or other verified user (e.g., the new user 106/existing user 107 of FIG. 1 as described as the verified user 706 in FIG. 7) in the private neighborhood community to bi-directionally communicate with the verified user (e.g., the new user 106/existing user 107 of FIG. 1 as described as the verified user 706 in FIG. 7) generating the broadcast through the social-networkable apparel server 100. A curation permission module 264 may apply a crowdsourced moderation algorithm in which multiple neighbors to a geospatial area determine what content contributed to the social-networkable apparel server 100 persists and/or which may be deleted.

A threshold module 268 may automatically set the threshold distance between 0.2 and/or 0.4 miles from the set of geospatial coordinates 103 associated with the social connection broadcast data 102 generated through the mobile device 504 to optimize a relevancy of the live-broadcast. A non-transitory module 270 may determine any private neighborhood community in which the verified user (e.g., the new user 106/existing user 107 of FIG. 1 as described as the verified user 706 in FIG. 7) has a non-transitory connection which may be a residential address of the verified user (e.g., the new user 106/existing user 107 of FIG. 1 as described as the verified user 706 in FIG. 7) and/or a work address of the verified user (e.g., the new user 106/existing user 107 of FIG. 1 as described as the verified user 706 in FIG. 7) that has been confirmed by the social-networkable apparel server 100 as being associated with the verified user (e.g., the new user 106/existing user 107 of FIG. 1 as described as the verified user 706 in FIG. 7).

An association determination module 282 may enable the user to verify if the claimable neighborhood in the neighborhood curation system is associated with the private neighborhood community in the claimable neighborhood of the neighborhood curation system. A gesture module 280 may enable the user (e.g., the merchant 132) to use a haptic ‘flick’ gesture in a horizontal and/or a vertical fashion to switch a viewing pane associated with a monitoring of the effectiveness and/or return on investment of the purchase associated with the fulfillment request.

FIG. 3 is a broadcast view that demonstrates how the radial distribution module 140 of FIG. 1 is used to communicate a social connection broadcast data to claimed user profiles, pre-seeded user profiles, and to telephone devices through a heterogeneous network formed through the internet protocol network of FIG. 1 and through a cellular network, according to one or more embodiments.

Particularly, FIG. 3 illustrates a broadcast view 350, according to one or more embodiments. FIG. 3 introduces a claimed neighborhood 300, a set of pre-seeded user profiles 302, and a claimed user profile 304, and their relationships with elements previously described in FIG. 1. In addition, FIG. 3 explains the set of service providers 109 of FIG. 1 to include a career center 309A, a hardware store 309B, a professional service provider 309C, a landscaper 309D, a gardener 309E, a plumber 309F, a handyman 309G, and a homeless shelter 309H.

In FIG. 3, the claimed neighborhood 300 may refer to a region that may be claimed by the new user 106/existing user 107 as being associated with a non-transitory location (e.g., a work address, a home address) of the new user 106/existing user 107. The pre-seeded user profiles 302 may refer to address information from people and/or business directories that have been prepopulated in the geospatial social map and/or may be associated with manually placed pushpins on the geospatial map 606 in the geospatially constrained social network 142 of FIG. 1. The claimed user profile 304 may refer to the verified user 706 associated with a verified address in the geospatial social map and/or may be associated with claimed pushpin (e.g., a previously pre-seeded residential and/or business profile) on the geospatial map 606 in the geospatially constrained social network 142 of FIG. 1.

The career center 309A, the hardware store 309B, the professional service provider 309C, the landscaper 309D, the gardener 309E, the plumber 309F, the handyman 309G, and the homeless shelter 309H may receive the social connection broadcast data 102 (contained in the notification data 112) through their mobile devices, desktop devices, and/or through their cellular telephones. The career center 309A, the hardware store 309B, the professional service provider 309C, the landscaper 309D, the gardener 309E, the plumber 309F, the handyman 309G, and the homeless shelter 309H may receive the social connection broadcast data 102 and may bi-directionally interact with the service providers 109 through either cellular and/or through the network 101 (e.g., an internet protocol network). When a job opportunity is filled by the new user 106/existing user 107 interacting with any one of the recipients based on the bi-directional communication, the new user 106/existing user 107 may be able to hire, manage, and pay any one or more of the career center 309A, the hardware store 309B, the professional service provider 309C, the landscaper 309D, the gardener 309E, the plumber 309F, the handyman 309G, and the homeless shelter 309H, that may receive the social connection broadcast data 102 through the social-networkable apparel server 100.

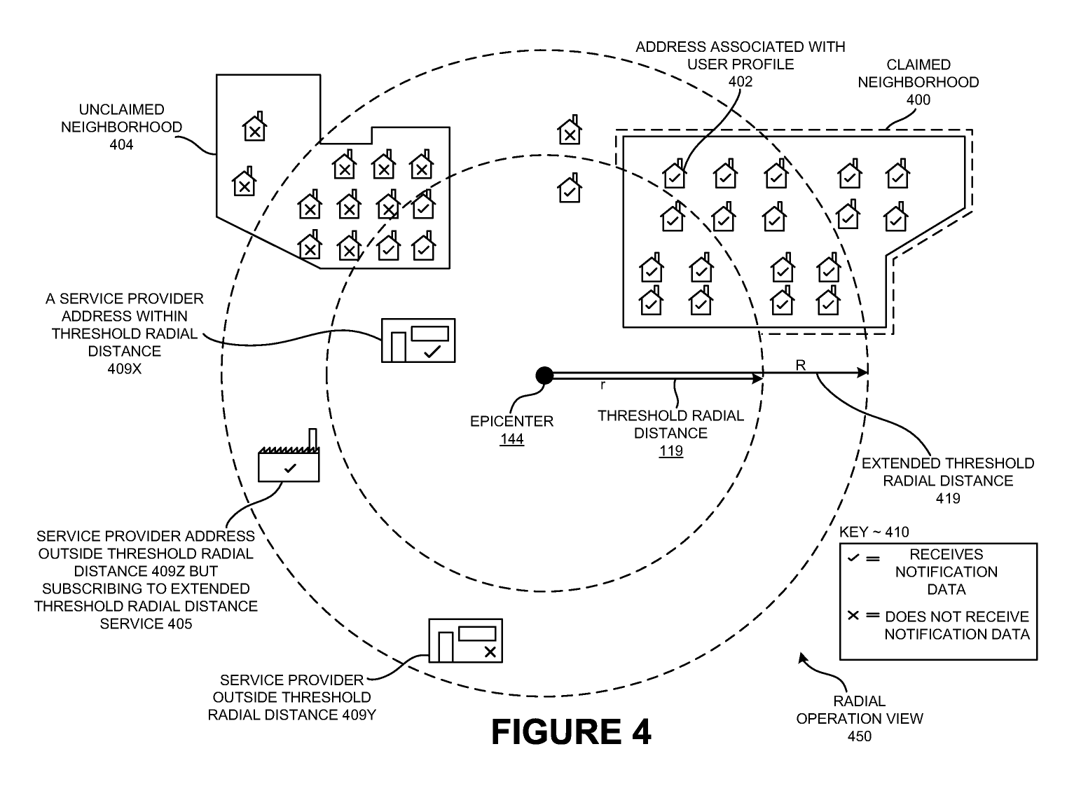

The notification data 112 may be communicated through the network 101 to the pre-seeded user profiles 302 within a threshold radial distance 119 of the epicenter 144. Alternately, the notification data 112 may be communicated through the network 101 to different ones of the claimed user profile 304 within the claimed neighborhood 300 that are located within the threshold radial distance 119 from the epicenter 144. Additionally, as described in FIG. 4, it will be understood that the claimed neighborhood 300 may be situated partially within the threshold radial distance 119 and partially outside the threshold radial distance 119, yet the notification data 112 received by of the recipients 114 (e.g., having a claimed user profile) may be propagated to other claimed user profiles within the claimed neighborhood 300 even though they are outside the threshold radial distance 119.

The notification data 112 may also be communicated through the cellular network 108 or through the network 101 to the set of service providers 309. For example, the career center 309A may use the opportunity network 150 to monitor jobs in a neighborhood and publish these jobs to residents around a geospatial area of the neighborhood. In addition, the hardware store 309B may attract day laborers from different parts of a city who desire work in a region around the hardware store. The professional service provider 309C, the landscaper 309D, the gardener 309E, and the handyman 309G may service a particular neighborhood and may be alerted of a new opportunity based on a subscription they pay to access broadcasts from areas that they service. Additionally, it should be understood that other types of businesses may receive the notification data 112. For example, additional service providers such as retail shops, wholesale stores, construction jobsites, and other parties or entities that require new employees, independent contractors, temporary workers or day labor may receive the notification data 112. Service providers may also be individual users who are in need of work around their home or office.

FIG. 4 is a radial operation view 450 that illustrates an expansion of a threshold radial distance based on a claimed neighborhood 400 at a radial boundary surrounding the epicenter 144 formed by geospatial coordinates of the device of FIG. 1, according to one or more embodiments. FIG. 4 illustrates a claimed neighborhood 400, an address associated with a user profile 402, an unclaimed neighborhood 404, a service provider address outside the threshold radial distance as described in operation 409Z but subscribing to extend the threshold radial distance as described in operation 405, a service provider within the threshold radial distance as described in operation 409X, a service provider outside the threshold radial distance in operation 409Y, and a key 410. The key 410 describes that a ‘checkmark’ inside a home in either the claimed neighborhood 400 and/or the unclaimed neighborhood 404 indicates that the social connection broadcast data 102 reaches a user associated with that address at a radial geospatial distance away. In contrast, the key 410 describes that an ‘X mark’ inside a home in either the claimed neighborhood 400 and/or the unclaimed neighborhood 404 indicates that the social connection broadcast data 102 does not reach a user associated with that address at a radial geospatial distance away.

Particularly, in FIG. 4, an address associated with each user profile 402 is illustrated, according to one or more embodiments. In FIG. 4, because the claimed neighborhood 400 is partially within the threshold radial distance ‘r’, every verified user in the claimed neighborhood 400 receives the social connection broadcast data 102, according to one or more embodiments. Thereby, the radial broadcast distance ‘r’ is extended to a′ as illustrated in FIG. 4 (e.g., the extended threshold radial distance 419 of FIG. 4). It should be understood that in an alternate embodiment, the radial broadcast of the social connection broadcast data 102 may not extend to the entire group of users of the claimed neighborhood 400. However, to promote neighborhood communication and cooperation, the social connection broadcast data 102 is illustrated as being extended to the claimed neighborhood 400 in the embodiment of FIG. 4.

It should be also noted that in some embodiments, the “pre-seeded user profiles” may be users that have previously signed up for the geospatially constrained social network 142, as opposed to users that have been pre-seeded there in a social network. For example, in one alternate embodiment, each of the claimed neighborhood 400 may serve as an approximate to actual radial distribution, in that broadcast messages are solely sent to claimed neighborhoods (e.g., private claimed neighborhoods) of actual users in a vicinity of a broadcast (rather than to public profiles).

FIG. 4 also illustrates an unclaimed neighborhood 404. The unclaimed neighborhood 404 may be pre-seeded based on public data, according to one or more embodiments. The unclaimed neighborhood has within it a series of addresses (e.g., associated with non-transitory homes and/or business locations), according to one or more embodiments as illustrated in FIG. 4. Those addresses in the unclaimed neighborhood 404 to whom the social connection broadcast data 102 is delivered have a ‘checkmark’, according to one or more embodiments. In contrast, those addresses in the unclaimed neighborhood 404 to whom the social connection broadcast data 102 is not delivered have an ‘X mark’, as illustrated in FIG. 4. Particularly, addresses in the radial boundary ‘r’ have a check mark, whereas addresses that extend from the radial boundary ‘r’ (e.g., and therefore outside the threshold radial distance 119) are marked with the ‘X mark’. In this example embodiment of FIG. 4 showing the unclaimed neighborhood 404, the addresses within the threshold radial distance 119 are the addresses that receive the social connection broadcast data 102.

Also illustrated in FIG. 4 is the concept of the service provider address within the threshold radial distance as shown in operation 409X, the service provider address outside the threshold radial distance but subscribing to extend threshold radial distance service as shown in operation 405, and the service provider outside the threshold radial distance as illustrated in operation 409Y. Each of these different operations will be compared and contrasted. The service provider address in operation 409X may receive the social connection broadcast data 102 because the service provider in this example embodiment of FIG. 4 is within the threshold radial distance 119, according to one or more embodiments. The service provider address in operation 405 may receive the social connection broadcast data 102 because they provide a consideration (e.g., pay a monthly subscription, annual fee, and/or pay per access/use fee) to the geospatially constrained social network 142, even though the service provider in operation 405 does not have a physical address within the threshold radial distance 119. The geospatially constrained social network 142 (e.g., or social-networkable apparel server 100) may verify, confirm, and/or ask for an assurance that the service provider actually provides services to homes/businesses in the threshold radial distance 119. The geospatially constrained social network 142 (and other the social-networkable apparel server 100) may request feedback, reviews, and comments from homes/businesses in the geospatially constrained social network 142 for the service providers in operation 405 and operation 409X to ensure that they continue to be recommended and/or are permitted to participate in the threshold radial distance 119 around the epicenter 144 (e.g., where the broadcast originates) in the geospatially constrained social network 142. Operation 409Y indicates that a service provider outside the threshold radial distance 119 does not receive the social connection broadcast data 102, and therefore cannot participate bi-directionally in the geospatially constrained social network 142.

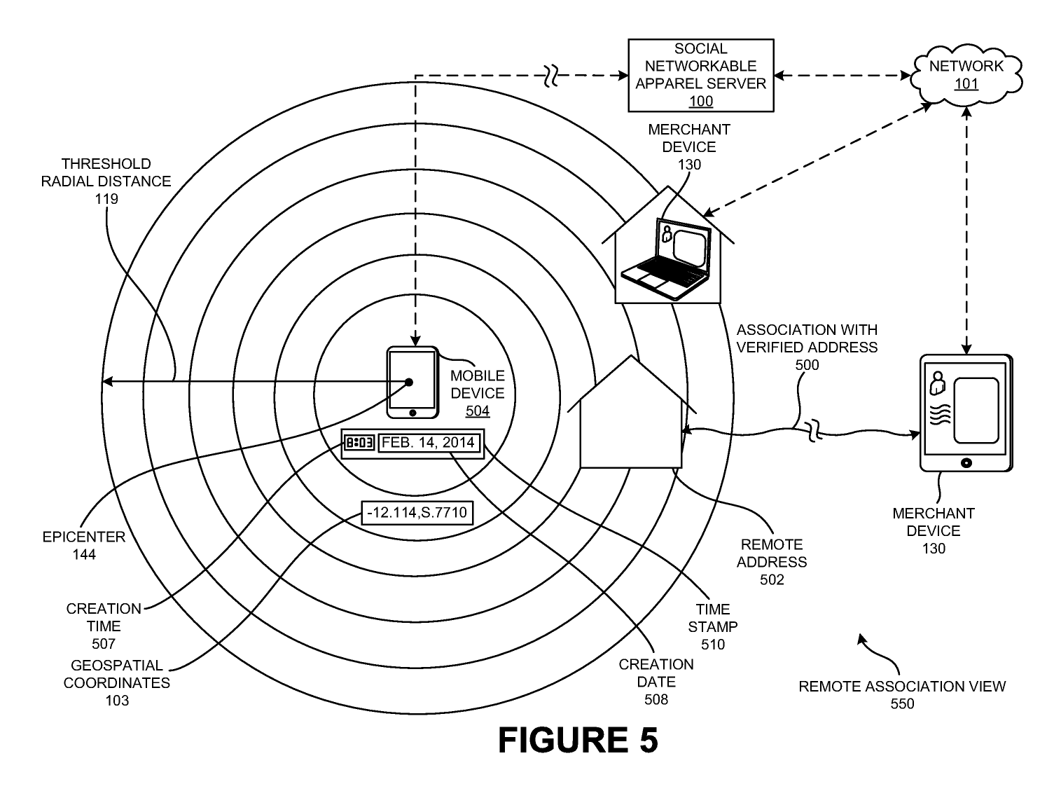

FIG. 5 illustrates a remote association view 550 in which a merchant device 130 of a merchant 132 receives the social connection broadcast data 102 of FIG. 3 based on a non-transitory claimed address associated with a profile of the merchant 132 even when the merchant's mobile device is outside a threshold radial distance 119 of a broadcast, according to one or more embodiments.

Particularly, FIG. 5 illustrates an operation 500 which illustrates the merchant device can be associated to a remote address 502, and a time stamp 510 associated with a creation time 507, a creation date 508, and a set of geospatial coordinates 103. The remote address 502 may be a non-transitory location such as a home and/or a work address of the employer (e.g., the new user 106/existing user 107 generating the social connection broadcast data 102), according to one or more embodiments. The non-transitory location may be a place of domicile (e.g., a home) and/or a place of sites (e.g., a physical location and/or a principle place of business) of a property (e.g., a work address) and/or business associated with the new user 106/existing user 107), according to one or more embodiments. The concept illustrates that the merchant device 130 may be located at a physical location outside the threshold radial distance 119 and/or still get the social connection broadcast data 102 if the merchant device 130 has verified an address at a location that they care about and/or are associated with (e.g., a location in which they live, work, and/or have guest access) that is within the threshold radial distance 119. In other words, the new user 106/existing user 107 may receive broadcast (e.g., the social connection broadcast data 102 which may be live streamed and/or through after the event notifications) related to a radial distance from their home and/or work even when physically at a location outside their claimed non-transitory location.

FIG. 6 is a merchant view 650 that explains how the merchant of FIG. 5 manages and communicates with a set of users based on the social connection broadcast data 102, according to one or more embodiments. Particularly, FIG. 6 illustrates a set of the summary data 602, the tag pushpin 604, the geospatial map 606, the commercial item 608 and the statistics 610 according to one or more embodiments.

In FIG. 6, the merchant 132 may log into their profile and be at least allowed to view, via an interface of the merchant 600, their past orders, view statistics relating to their past orders and/or place orders. The summary data 602 may be presented to the merchant 132 to show the merchant 132 how many profiles were updated when one of their commercial items 608 was tagged, the ID of the tagger (e.g., the new user 106, the existing user 107), the individual wearing the taggable apparel 136, and/or the geospatial coordinates 103. The geospatial map 606 may allow the merchant 132 to view a tag pushpin 604 and identify a top geospatial area. The merchant 132 may also be able to view a set of statistics 610 (e.g., a most social wearer of the taggable apparel, a top tagger, a top sharer, a top promoter, a top influencer, a top geospatial area of tagging, and/or a set of statistics associated with an effectiveness and/or return on investment of a purchase associated with the fulfillment request) for each order and/or a general set of statistics encompassing all past orders of the merchant 132. A listing criteria 620 selected by the merchant 132 (e.g., a description, a photograph, a video, a salary, a fixed fee amount, an category, a functional status of a job offered through the tagging of the taggable apparel, wherein the job may be a household job, a repair job, a maintenance job, a professional job and/or a career opportunity) which may determine what may be published as a result of the tagging 105 may also be viewed for each order.

An interface may be provided to the merchant 132 such that the merchant 132 can use a haptic ‘slide/flick’ gesture, through a gesture module 280, in a horizontal and/or a vertical fashion to switch a viewing pane associated with a monitoring of the effectiveness and/or return on investment of the purchase associated with the fulfillment request 612. The summary data may be provided to the merchant generating the tagging of the taggable apparel (generated through the mobile device) of how many user profile pages were updated with an alert of the tagging of the taggable apparel (generated through the mobile device) when publishing the tagging of the taggable apparel (generated through the mobile device) in the private neighborhood community and/or the set of user profiles (having associated verified addresses in the threshold radial distance from the claimed geospatial location of the new user and/or the existing user of the social-networkable apparel server 100) based on the set of preferences of the new user and/or the existing user.

FIG. 7 is a user interface view that explains how a verified user views their profile, makes social connections, and manages notifications in neighborhoods that they have claimed, according to one or more embodiments. In FIG. 7, notification data 112 may be delivered to the user (e.g., the new user 106, the existing user 107, the individual wearing the taggable apparel 136) and how the user manages notifications (e.g., on-page posting 701, an electronic communication, a push notification) in neighborhoods that they have claimed, according to one or more embodiments. Particularly, FIG. 7 describes claimed geospatial locations 700 of a verified user 706 (‘Sam’), and associated information with a tag broadcast generated by Sam and/or generated within a threshold radial distance 119 from one of the verified user 706's claimed geospatial locations 700. A set of preferences 704 may be modified by the user and may allow the user to determine a distance away from the epicenter 144 of the tagging 105 in which a notification may be presented to the user. The social connection expiration time 702 may represent a date and/or time at which a notification will be removed from the user device (e.g., the device 104, the mobile device 504). The claimed user profile 304 may also possess a taggable apparel claiming interface 851 (shown in FIG. 8).

FIG. 8 is an apparel creation user interface view that explains how a user (e.g., the merchant) creates, customizes (e.g., selects a design, an advertisement, and/or an incentive), socializes (e.g., selects preset criteria), and/or orders a quantity of taggable apparel, according to one or more embodiments. The merchant 132 may select a design 800 of the taggable apparel and/or make the advertisement area 116 by uploading their own and/or creating one. A preset criteria 802 may be selected (e.g., by the answering of questions shown in FIG. 8) by the merchant 132 that may determine the information gathered and/or broadcasted by the tagging 105. A unique identifier 804 may also be selected so that each taggable apparel has its own ID, according to one or more embodiments. A group of the taggable apparel and the wearer 806 may also be selected so that an individual wearing multiple taggable apparel items may be identified, according to one or more embodiments. The user may also select an incentive type to present to individuals wearing the taggable apparel 136 and may be presented with an option of ordering additional taggable apparel to place as a giveaway. Once the user (e.g., the merchant 132) has created their taggable apparel and selected all desired preset criteria 802, may then be able to check a fulfillment request 810 and place an order 812 of a quantity 814 of the taggable apparel 136. The apparel creation user interface may also include the taggable apparel claiming interface 851, which may allow the user to enter information such as a first name, a last name, an address, an email, a shirt number, and/or a password in order to claim their taggable apparel.

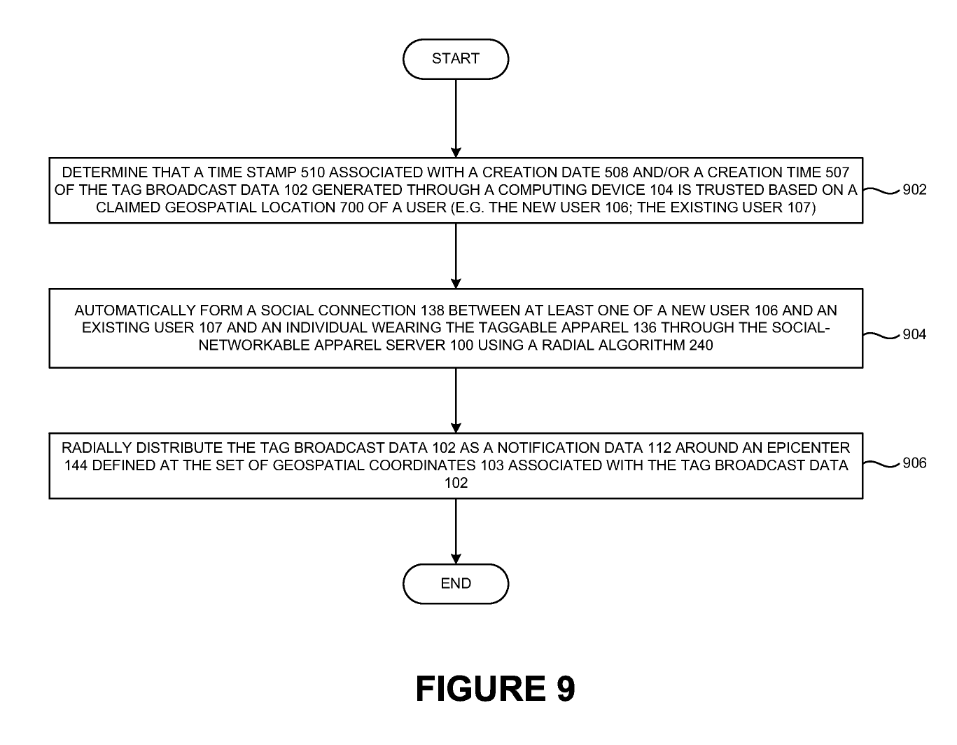

FIG. 9 is a process flow of radially distributing the social connection broadcast data of FIG. 3 as a notification data 112 around an epicenter 144 defined at the set of geospatial coordinates 103 of FIG. 3 associated with the social connection broadcast data 102, according to one or more embodiments. Particularly, in FIG. 9, operation 902 may determine that a time stamp 510 associated with a creation date 508 and/or a creation time 507 of the social connection broadcast data 102 generated through a computing device (e.g., the device 104) is trusted based on a claimed geospatial location of a user (e.g., the new user 106/existing user 107), according to one or more embodiments. Then, in operation 904, a social connection 138 may be automatically formed between the at least one of the new user 106/the existing user 107 and an individual wearing the taggable apparel 136 through the social-networkable apparel server 100 using a radial algorithm 240. Next, in operation 906, the social connection broadcast data 102 may be radially distributed as the notification data 112 around an epicenter 144 defined at the set of geospatial coordinates 103 associated with the social connection broadcast data 102.

FIG. 10 is a table view 1050 illustrating data relationships between users, locations, and with a set of notification types needed to generate a broadcast, according to one or more embodiments. In FIG. 10, a table lookup 1002 may be performed in which a listing criteria 620 is matched with a threshold radial distance 119 and a notification data 112. Then, a notification may be generated using the generate notification operation 1004 from the merchant 132, and distributed to the verified address (e.g., the verified address 1003) in the threshold radial distance 119 using the distribute operation 1006, according to one or more embodiments.

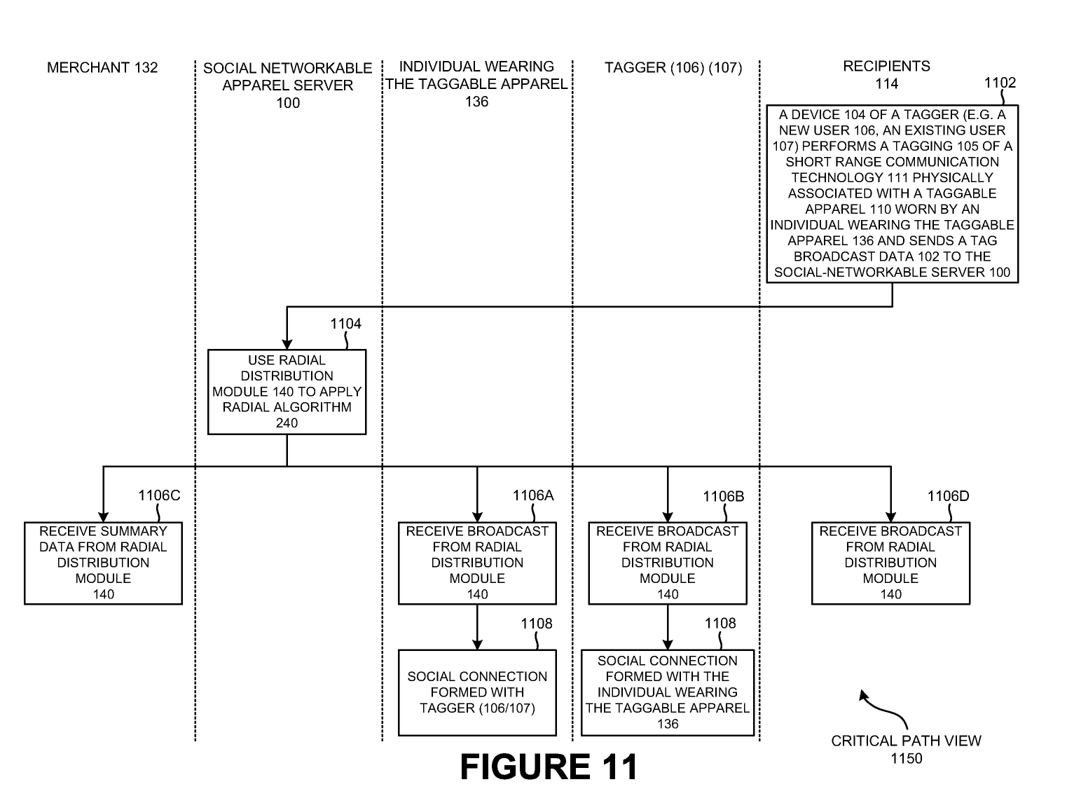

FIG. 11 is a critical path view 1150 illustrating a flow based on time in which critical operations in establishing a bi-directional session between a verified user and those individuals receiving the social connection broadcast data of FIG. 3 is established, according to one or more embodiments. In FIG. 11, a device 104 of a tagger (e.g., the new user 106, the existing user 107) performs a tagging 105 of a short range communication technology 111 physically associated with a taggable apparel 110 worn by an individual wearing the taggable apparel 136 and sends a social connection broadcast data 102 to the social-networkable apparel server 100 in operation 1102. Then, the social-networkable apparel server 100 uses radial distribution module 140 to apply a radial algorithm 240 in operation 1104, according to one or more embodiments. In operation 1106A, the individual wearing the taggable apparel 136 receives the broadcast from the radial distribution module 140, according to one or more embodiments. Similarly, the tagger (e.g., the new user 106, the existing user 107) receives the social connection broadcast data 102 (e.g., metadata) from the radial distribution module 140 of the social-networkable apparel server 100 in operation 1106B, according to one or more embodiments. Based on operation 1106A and 1106B, the merchant 132 may automatically receive a summary of how many recipients received the social connection broadcast data 102 in operation 1106C, according to one or more embodiments. In operation 1106D, a recipients 114 (e.g., verified users with non-transient connections within a threshold radial distance 119 from the epicenter 144) receive the broadcast from the radial distribution module 140, according to one or more embodiments. Next, a social connection is established between the tagger (e.g., the new user 106, the existing user 107) and the individual wearing the taggable apparel 136 in operation 1108.

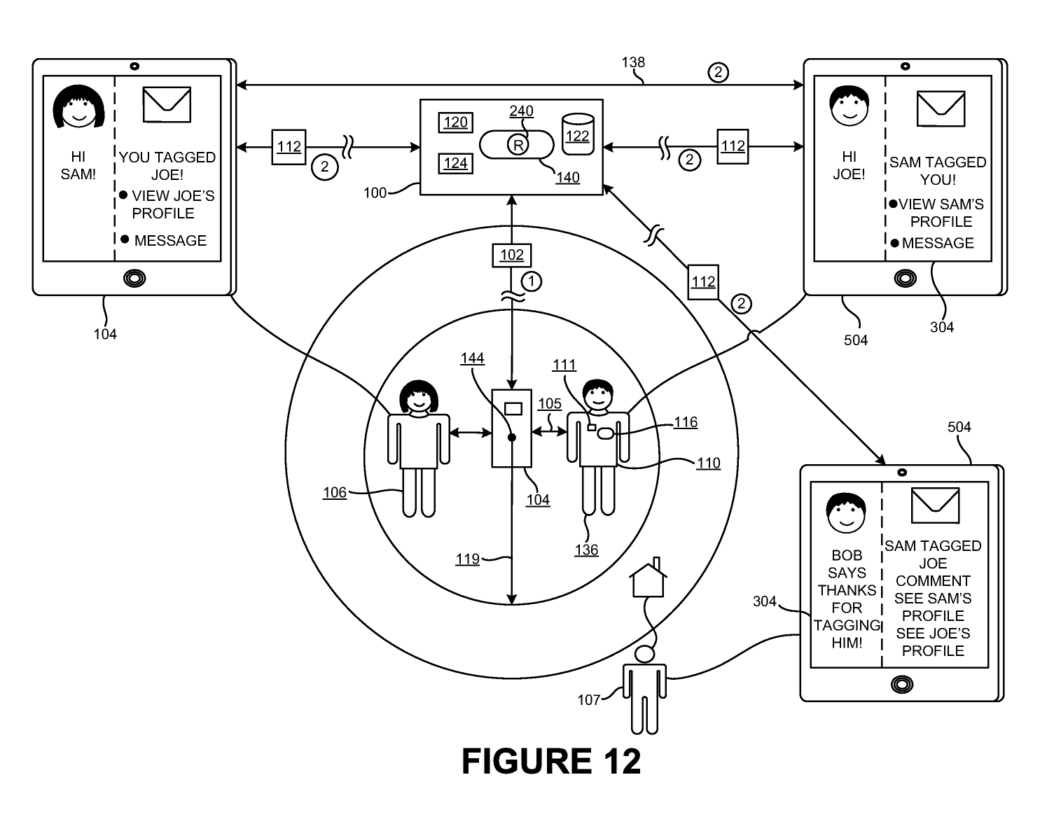

FIG. 12 is a tag data radial distribution and social connection view illustrating the radial distribution of a social connection broadcast data in the form of a notification data from a social-networkable apparel server 100 to the mobile devices of a new user, an individual wearing the taggable apparel, and a verified user with a non-transient connection to a claimed address within the threshold radial distance from the epicenter, forming a social connection between at least the new user and the individual wearing the taggable apparel. In FIG. 12, a new user 106 performs a tagging 105 of a short range communication technology 111 physically associated with a taggable apparel 110 worn by an individual wearing the taggable apparel 136 with a device 104. 1) The device 104 sends a social connection broadcast data 102 to the social-networkable apparel server 100 which applies the radial algorithm 240 and 2) simultaneously broadcasts a notification data to a) the mobile devices 504 of the new user 106 and the individual wearing the taggable apparel 136, forming a social connection between the new user 106 and the individual wearing the taggable apparel 136 and b) the mobile device 504 of a user (e.g., a verified user 706) with a non-transient connection to a claimed address within a threshold radial distance 119 from the epicenter 144. The new user 106, the individual wearing the taggable apparel 136, and/or the verified user 706 may view the notification as an on-page posting 701 on claimed user profiles 304 displayed on mobile devices 504.

It should be noted that there are a number of different ‘user’ roles described in the various embodiments described herein. The user roles include a ‘user’, a ‘claimed user’, and a ‘verified user’. The user is someone that has signed up for and/or accessed the social-networkable apparel server 100 through the geospatially constrained social network 142. The user can ‘claim’ an existing profile (e.g., prepopulated and/or created by another user through a wiki like creation process), and/or ‘claim’ an address with a new location, thereby transforming the user to the ‘claimed user’. The claimed user can verify that they actually live at a particular home address and/or work at a particular business address (e.g., thereby showing their affiliation with a non-transitory location) by submitting a response to a verification code on a postcard, submitting a utility bill, and/or being invited by and/or getting vouched for by an existing verified user. This can transform the claimed user to a ‘verified user’, in one embodiment. It will be understood by those with skill in the art that the new user 106/existing user 107 may refer to either a user that has not yet claimed, the claimed user, and/or the verified user.

In one aspect, a method of a social-networkable apparel server 100 includes validating, through a processor 120 and a memory 124, that a tagging 105 of a taggable apparel 110 through a mobile device 504 is associated with a new user 106 and/or an existing user 107 of the social-networkable apparel server 100. The method verifies that a set of geospatial coordinates 103 associated with the tagging 105 of the taggable apparel 110 through the mobile device 504 are trusted based on a contact information transmitted from the mobile device 504 to the social-networkable apparel server 100 and/or a claimed geospatial location of the new user 106 and/or the existing user 107 of the social-networkable apparel server 100. In addition, the method determines that a time stamp 510 associated with a creation date 508 and/or a creation time 507 of the tagging 105 of the taggable apparel 110 generated through the mobile device 504 (e.g., computing device) is trusted based on the set of geospatial coordinates 103 where the taggable apparel 110 was tagged. Furthermore, a social connection 138 between the new user 106 and the existing user 107 and an individual wearing the taggable apparel 136 is created by the social-networkable apparel server 100 using a radial algorithm 240.

A design 800 of the taggable apparel 110 may be selected through an apparel creator module 224 of the social-networkable apparel server 100 based on a request of a merchant 132. An advertisement area on the taggable apparel 110 may be customizing through an advertisement creation module 242 of the social-networkable apparel server 100 based on the request of the merchant 132, wherein the advertisement area may be associated with a commercial item 608, a service, and/or a promotional item offered by the merchant 132 to any of those individuals that read a short range communication technology 111 (e.g., a near-field communication tag, an i-beacon) on the taggable apparel 110. Additionally, a fulfillment request 810 of an order 812 may be submitted by the merchant 132 for a quantity 814 of the taggable apparel 110 having customized ones of the advertisement area and/or each individually associated with the short range communication technology 111 through the social-networkable apparel server 100, such that the short range communication technology 111 individually identifies each the taggable apparel 110 and/or optionally a group of the taggable apparel and/or the wearer of the taggable apparel 806 (through a unique identifier 804 associated with either each of the one of the short range communication technology 111 and/or a unique uniform resource locator destination to which each read tag may be transported in the social-networkable apparel server 100).

The merchant 132 may be permitted to log-in to the social-networkable apparel server 100 and/or set a criteria being a location sharing request, a social graph sharing request, a destination page design 800, a destination uniform resource locator location, and/or an updatable electronic promotion associated with each of the taggable apparel. The merchant 132 may be permitted to log-in to the social-networkable apparel server 100 and/or view statistics 610 related to a most social wearer of the taggable apparel, a top tagger, a top sharer, a top promoter, a top influencer, a top geospatial area 117 of tagging, and/or a set of statistics 610 associated with an effectiveness and/or return on investment of a purchase associated with the fulfillment request 612.

The tagging 105 of the taggable apparel 110 generated through the mobile device 504 may be automatically published on a set of user profiles having associated verified address 1003es in a threshold radial distance 119 from the set of geospatial coordinates 103 associated with the tagging 105 of the taggable apparel 110 generated through the mobile device 504 of the new user 106 and/or the existing user 107 of the social-networkable apparel server 100 using a radial algorithm 240. Additionally, a listing criteria 620 associated with the tagging 105 of the taggable apparel 110 comprising a description, a photograph, a video, a salary, a fixed fee amount, an category, a functional status of a job offered through the tagging 105 of the taggable apparel 110, wherein the job may be a household job, a repair job, a maintenance job, a professional job and/or a career opportunity may be automatically published. An availability chart may be populated when the job associated with the listing criteria 620 may be posted, wherein the availability chart includes a target candidate living area radius, a start timing, an hours per day, an hours per month, a professional qualification criteria and/or a timing criteria.

The notification data 112 may be determined to be generated by the new user 106 and/or the existing user 107 of a neighborhood broadcasting system when validating that the notification data 112 may be associated with the mobile device. An application on the mobile device 504 may be determined to be communicating the notification data 112 to the neighborhood broadcasting system when the notification data 112 may be processed. The new user 106 and/or the existing user 107 may be associated with the new user 106 and/or the existing user 107 profile in the neighborhood broadcasting system through the application on the mobile device. The tagging 105 of the taggable apparel 110 generated through the mobile device 504 may be presented as a tag pushpin 604 in a geospatial map 606 surrounding pre-populated residential and/or business listings in a surrounding vicinity (such that the tag pushpin 604 may be automatically presented on the geospatial map 606 in addition to being presented on the set of user profiles having associated verified addresses 1003 in a threshold radial distance 119 from the set of geospatial coordinates 103 associated with the tagging 105 of the taggable apparel 110 generated through the mobile device 504 of the new user 106 and/or the existing user 107 of the social-networkable apparel server 100).

The tagging 105 of the taggable apparel 110 generated through the mobile device 504 may be radially distributed through an on-page posting 701, an electronic communication, and/or a push notification (delivered to desktop and/or mobile devices). Furthermore, the tagging 105 of the taggable apparel 110 may be associated with users and/or their user profiles around an epicenter 144 defined at the set of geospatial coordinates 103 associated with the tagging 105 of the taggable apparel 110. The tagging 105 of the taggable apparel 110 may be generated through the mobile device 504 to all subscribed user profiles in a circular geo-fenced area. The circular geo-fenced area may be defined by the threshold distance from the set of geospatial coordinates 103 associated with the tagging 105 of the taggable apparel 110 generated through the mobile device 504 through the radial algorithm 240 of the neighborhood broadcasting system (that measures a distance away of each address associated with each user profile 402 from the current geospatial location at the epicenter 144). The new user 106 and/or the existing user 107 may be permitted to drag and/or drop a tag pushpin 604 on any location on the geospatial map 606, and/or automatically determine a latitude 720 and/or a longitude 718 associated with a placed location. A career center 309A, a hardware store 309B, a professional services provider 309C, a landscaper 309D, a gardener 309E, a plumber 309F, a handyman 309G, and/or a homeless shelter 309H in a surrounding geospatial area 117 may be automatically notified to the set of geospatial coordinates 103 associated with the tagging 105 of the taggable apparel 110 generated through the mobile device.

The geospatial coordinates 103 may be extracted from a social connection broadcast data 102 associated with the tagging 105 of the taggable apparel 110 generated through the mobile device 504 when verifying that the set of geospatial coordinates 103 associated with the tagging 105 of the taggable apparel 110 generated through the mobile device 504 are trusted (based on the claimed geospatial location of the new user 106 and/or the existing user 107 of the social-networkable apparel server 100). Additionally, it may be determined that there is a relative match between a persistent clock 284 associated with the social-networkable apparel server 100 and/or a digital clock of the mobile device 504 to determine that the time stamp 510 associated with the creation date 508 and/or time of the tagging 105 of the taggable apparel 110 generated through the mobile device 504 may be accurate and/or therefore trusted.

The a publishing of the tagging 105 of the taggable apparel 110 generated through the mobile device 504 may be automatically deleted on a set of user profiles (having associated verified address 1003es in the threshold radial distance 119 from the set of geospatial coordinates 103 associated with the tagging 105 of the taggable apparel 110 generated through the mobile device 504 of the new user 106 and/or the existing user 107 of the social-networkable apparel server 100) based on a social connection expiration time 702. A set of residential addresses each associated with a resident name in a neighborhood surrounding the mobile device 504 may be geo-coded. Furthermore, the set of residential addresses each associated with the resident name as the set of user profiles in the threshold radial distance 119 from the claimed geospatial location of the new user 106 and/or the existing user 107 of the social-networkable apparel server 100 may be prepopulated in a neighborhood curation system communicatively coupled with the social-networkable apparel server 100. The new user 106 and/or the existing user 107 may be permitted to modify content in each of the set of user profiles. The modified content may be tracked through the neighborhood curation system.

Additionally, a reversible history journal associated with each of the set of user profiles may be generated such that a modification of the new user 106 and/or the existing user 107 can be undone on a modified user profile page. An editing credibility of the new user 106 and/or the existing user 107 based may be determined on an edit history of the new user 106 and/or the existing user 107 and/or a community contribution validation of the new user 106 and/or the existing user 107 by other users of the neighborhood curation system. Furthermore, the tagging 105 of the taggable apparel 110 (generated through the mobile device) may be automatically published to the set of user profiles having associated verified addresses 1003 in the threshold radial distance 119 from the claimed geospatial location of the new user 106 and/or the existing user 107 of the social-networkable apparel server 100 using the radial algorithm 240.

A claim request of the new user 106 and/or the existing user 107 generating the tagging 105 of the taggable apparel 110 (generated through the mobile device) may be processes to be associated with an address of the neighborhood curation system. It may be determined if the claimable neighborhood in the neighborhood curation system is associated with a private neighborhood community in the claimable neighborhood of the neighborhood curation system. The new user 106 and/or the existing user 107 may be associated with the private neighborhood community in the claimable neighborhood of the neighborhood curation system if the private neighborhood community has been activated by the new user 106 and/or the existing user 107 and/or a different the new user 106 and/or the existing user 107.

The new user 106 and/or the existing user 107 may be permitted to draw a set of boundary lines in a form of a geospatial polygon such that the claimable neighborhood in a geospatial region surrounding the claim request creates the private neighborhood community in the neighborhood curation system if the private neighborhood community is inactive. The claim request of the new user 106 and/or the existing user 107 generating the tagging 105 of the taggable apparel 110 (generated through the mobile device) may be verified to be associated with a neighborhood address of the neighborhood curation system when the address is determined to be associated with a work address and/or a residential address of the new user 106 and/or the existing user 107.

The tagging 105 of the taggable apparel 110 generated through the mobile device 504 may be simultaneously published on the private neighborhood community (associated with the new user 106 and/or the existing user 107 generating the tagging 105 of the taggable apparel 110 generated through the mobile device) in the threshold radial distance 119 from the address associated with the claim request of the new user 106 and/or the existing user 107 of the neighborhood curation system when the tagging 105 of the taggable apparel 110 generated through the mobile device 504 is automatically published on the set of user profiles (having associated verified addresses 1003 in the threshold radial distance 119 from the claimed geospatial location of the new user 106 and/or the existing user 107 of the social-networkable apparel server 100) based on a set of preferences 704 of the new user 106 and/or the existing user 107 using the radial algorithm 240.

In addition, an interface may be provided to the merchant 132 such that the merchant 132 can use a haptic ‘flick’ gesture in a horizontal and/or a vertical fashion to switch a viewing pane associated with a monitoring of the effectiveness and/or return on investment of the purchase associated with the fulfillment request 612. A video communication and/or an audio communication may be automatically initiated between the mobile device 504 of the merchant 132 and/or another mobile device 504 of the wearer of the taggable apparel 110 and/or a tagger that reads the short range communication technology 111 (e.g., a near-field communication tag, an i-beacon) physically on the taggable apparel 110 through the social-networkable apparel server 100 (based on a set of preset criteria 802 through the social-networkable apparel server 100).

The wearer of the taggable apparel 110 (and/or the tagger that reads the short range communication technology 111 physically on the taggable apparel 110) may be permitted to communicate with each other and/or form social connections 138 with each other based on the participation criteria set by the merchant 132 and/or the wearer of the taggable apparel 110 and/or the tagger that reads the short range communication technology 111 physically on the taggable apparel 110, (such that each of the wearer of a taggable apparel 110 and/or the tagger that reads the short range communication technology 111 (e.g., a near-field communication tag, an i-beacon) physically on the taggable apparel 110 may be able to form social connections 138 with each participating person associated with the tagging 105 of the taggable apparel 110). Merchants 132 participating in the social-networkable apparel server 100 may be permitted to see previous ratings, interview comments, reviews, prescreen questions, and/or background checks across a plurality of applicants applying for a plurality of jobs through the social-networkable apparel server 100 (such that different merchants benefit from previous diligence (e.g., previous ratings, interview comments, reviews, prescreen questions, and/or background checks) by participating merchants 132 with each applicant to the job that has previously applied for different jobs through the social-networkable apparel server 100).

A summary data 602 of how many user profile pages were updated with an alert of the tagging 105 of the taggable apparel 110 (generated through the mobile device) may be provided to the merchant 132 generating the tagging 105 of the taggable apparel 110 (generated through the mobile device) when publishing the tagging 105 of the taggable apparel 110 (generated through the mobile device) in the private neighborhood community and/or the set of user profiles having associated verified addresses 1003 in the threshold radial distance 119 from the claimed geospatial location of the new user 106 and/or the existing user 107 of the social-networkable apparel server 100 based on the set of preferences 704 of the new user 106 and/or the existing user 107. Additionally, the tagging 105 of the taggable apparel 110 (generated through the mobile device) may be live broadcasted to the different new user 106 and/or the existing user 107 and/or the new user 106 and/or the existing users 107 in the private neighborhood community and/or currently within the threshold radial distance 119 from the current geospatial location through the social-networkable apparel server 100 (such that a live broadcast multicasts to a plurality of data processing systems associated with each of the different user and/or the new user 106 and/or the existing users 107 simultaneously when the mobile device 504 of the new user 106 and/or the existing user 107 generating the live-broadcast enables broadcasting of the tagging 105 of the taggable apparel 110 generated through the mobile device 504 to any one of a geospatial vicinity around the mobile device 504 of the new user 106 and/or the existing user 107 generating the broadcast and/or in any private neighborhood community in which the new user 106 and/or the existing user 107 has a non-transitory connection).

The different new user 106 and/or existing user 107 and/or the new user 106 and/or the existing users 107 in the private neighborhood community may be permitted to bi-directionally communicate with the new user 106 and/or the existing user 107 generating the broadcast through the social-networkable apparel server 100. Any private neighborhood community in which the new user 106 and/or the existing user 107 has the non-transitory connection may be the residential address of the new user 106 and/or the existing user 107 and/or the work address of the new user 106 and/or the existing user 107 that has been confirmed by the social-networkable apparel server 100 as being associated with the new user 106 and/or the existing user 107. The threshold distance may be between 0.2 and 0.4 miles from the set of geospatial coordinates 103 associated with the tagging 105 of the taggable apparel 110 generated through the mobile device 504 to optimize a relevancy of the live-broadcast.

In another aspect, a method of a social-networkable apparel server 100 includes determining, through a processor 120 connected to a memory 124, that a time stamp 510 associated with a creation date 508 and/or a creation time 507 of a tagging 105 of a taggable apparel 110 generated through a computing device 104 is trusted based on a set of geospatial coordinates 103 where the taggable apparel 110 was tagged. The method includes automatically forming a social connection 138 between a new user 106 and/or an existing user 107 and/or an individual wearing the taggable apparel 136 through the social-networkable apparel server 100 using a radial algorithm 240. In addition, the method includes radially distributing the tagging 105 of the taggable apparel 110 as a notification data 112 through an on-page posting 701, an electronic communication, and/or a push notification delivered to either (1) a set of recipients 114 through an internet protocol (IP) based network 101 associated with users and/or their user profiles around an epicenter 144 defined at the set of geospatial coordinates 103 associated with the tagging 105 of the taggable apparel 110 generated through the computing device, (2) a set of merchants through an internet protocol (IP) based network 101 associated with the users and/or their user profiles around an epicenter 144 defined at the set of geospatial coordinates 103 associated with the tagging 105 of the taggable apparel 110 generated through the computing device 104 or (3) a set of all subscribed user profiles in a circular geo-fenced area defined by the threshold distance from the set of geospatial coordinates 103 associated with the tagging 105 of the taggable apparel 110 generated through the computing device 104 through the radial algorithm 240 of a neighborhood broadcasting system that measures a distance away of each address associated with each user profile 402 from the current geospatial location at the epicenter 144.

In yet another aspect, a system includes a social-networkable apparel server 100 to automatically form a social connection 138, through a processor 120 connected to a memory 124, between a new user 106 and/or an existing user 107 and/or an individual wearing the taggable apparel 136 using a radial algorithm 240. The system also includes a mobile device 504 communicatively coupled with the social-networkable apparel server 100 through the network 101 to generate the social connection 138 using a camera, a microphone, and/or a sensory capability of the mobile device 504 to generate a captured data that is appended with a time stamp 510 associated with a creation date 508 and/or a creation time 507 of captured data in generating the social connection 138.

A validation module 200 may validate that a tagging 105 of a taggable apparel 110 through a mobile device 504 is associated with a new user 106 and/or an existing user 107 of the social-networkable apparel server 100. The validation module 200 may verify that a set of geospatial coordinates 103 associated with the tagging 105 of the taggable apparel 110 through the mobile device 504 are trusted based on a contact information transmitted from the mobile device 504 to the social-networkable apparel server 100 and/or a claimed geospatial location of the new user 106 and/or the existing user 107 of the social-networkable apparel server 100. A time stamp module 202 may identify that a time stamp 510 associated with a creation date 508 and/or a creation time 507 of the tagging 105 of the taggable apparel 110 generated through the mobile device 504 may be trusted based on the set of geospatial coordinates 103 where the taggable apparel 110 was tagged.

An apparel creator module 224 may select a design 800 of the taggable apparel 110 based on a request of a merchant 132, and an advertisement creation module 242 may customize an advertisement area 116 on the taggable apparel 110 based on the request of the merchant 132, wherein the advertisement area 116 may be associated with a commercial item 608, a service, and/or a promotional item offered by the merchant 132 to any of those individuals that read a short range communication technology 111 on the taggable apparel 110. Additionally, a submission module 274 may submit a fulfillment request 810 of an order 812 by the merchant 132 for a quantity 814 of the taggable apparel 110 having customized ones of the advertisement area 116 and/or each individually associated with the short range communication technology 111 through the social-networkable apparel server 100 (such that the short range communication technology 111 individually identifies each the taggable apparel 110 and/or optionally a group of the taggable apparel and/or the wearer of the taggable apparel 806 through a unique identifier 804 associated with either each of the one of the short range communication technology 111 and/or a unique uniform resource locator destination to which each read tag may be transported in the social-networkable apparel server 100).

Furthermore, a merchant criteria module 276 may permit the merchant 132 to log-in to the social-networkable apparel server 100 and/or set a listing criteria 620 being a location sharing request, a social graph sharing request, a destination page design, a destination uniform resource locator location, and/or an updatable electronic promotion associated with each of the taggable apparel. A statistic permission module 278 may permit the merchant 132 to log-in to the social-networkable apparel server 100 and/or view statistics 610 related to a most social wearer of the taggable apparel, a top tagger, a top sharer, a top promoter, a top influencer, a top geospatial area 117 of tagging, and/or a set of statistics 610 associated with an effectiveness and/or return on investment of a purchase associated with the fulfillment request 612. A publishing module 214 may automatically publish the tagging 105 of the taggable apparel 110 generated through the mobile device 504 on a set of user profiles having associated verified addresses 1003 in a threshold radial distance 119 from the set of geo spatial coordinates 103 associated with the tagging 105 of the taggable apparel 110 generated through the mobile device 504 of the new user 106 and/or the existing user 107 of the social-networkable apparel server 100 using a radial algorithm 240. Moreover, a listing module 272 may process a listing criteria 620 associated with the tagging 105 of the taggable apparel 110 comprising a social connection 138, description, a photograph, a video, a salary, a fixed fee amount, an category, a functional status of a job offered through the tagging 105 of the taggable apparel 110, wherein the job may be a household job, a repair job, a maintenance job, a professional job and/or a career opportunity.

A charting module 204 may populate an availability chart when the job associated with the listing criteria 620 is posted, wherein the availability chart may include a target candidate living area radius, a start timing, an hours per day, an hours per month, a professional qualification criteria and/or a timing criteria. A broadcast determination module 260 may verify that the notification data 112 is generated by the new user 106 and/or the existing user 107 of a neighborhood broadcasting system when validating that the notification data 112 may be associated with the mobile device. Additionally, an application module 286 may determine that an application on the mobile device 504 is communicating the notification data 112 to the neighborhood broadcasting system when the notification data 112 may be processed.

An association module 216 may associate the new user 106 and/or the existing user 107 with the new user 106 and/or the existing user 107 profile in the neighborhood broadcasting system through the application on the mobile device 504. In addition, a pushpin module 206 may present the tagging 105 of the taggable apparel 110 generated through the mobile device 504 as a tag pushpin 604 in a geospatial map 606 surrounding pre-populated residential and/or business listings in a surrounding vicinity, such that the tag pushpin 604 may be automatically presented on the geospatial map 606 in addition to being presented on the set of user profiles (having associated verified address 1003es in a threshold radial distance 119 from the set of geospatial coordinates 103 associated with the tagging 105 of the taggable apparel 110 generated through the mobile device 504 of the new user 106 and/or the existing user 107 of the social-networkable apparel server 100).

A radial distribution module 140 may allow the tagging 105 of the taggable apparel 110, generated through the mobile device 504, to be radially distributed (through an on-page posting 701, an electronic communication, and/or a push notification delivered to desktop and/or mobile devices associated with users and/or their user profiles around an epicenter 144 defined at the set of geospatial coordinates 103 associated with the tagging 105 of the taggable apparel 110 generated through the mobile device) to all subscribed user profiles in a circular geo-fenced area, defined by the threshold distance from the set of geospatial coordinates 103 associated with the tagging 105 of the taggable apparel 110 generated through the mobile device 504, through the radial algorithm 240 of the neighborhood broadcasting system that measures a distance away of each address associated with each user profile 402 from the current geospatial location at the epicenter 144. Furthermore, a placement module 232 may enable the new user 106 and/or the existing user 107 to drag and/or drop the tag pushpin 604 on any location on the geospatial map 606, and/or automatically determine a latitude 720 and/or a longitude 718 associated with a placed location. A notification module 208 may automatically notify a career center 309A, a hardware store 309B, a professional services provider 309C, a landscaper 309D, a gardener 309E, a plumber 309F, a handyman 309G, and/or a homeless shelter 309H in a surrounding geospatial area 117 to the set of geospatial coordinates 103 associated with the tagging 105 of the taggable apparel 110 generated through the mobile device 504.

An extraction module 234 may extract the geospatial coordinates 103 from a social connection broadcast data 102 102 associated with the tagging 105 of the taggable apparel 110 generated through the mobile device 504 when verifying that the set of geospatial coordinates 103 associated with the tagging 105 of the taggable apparel 110 generated through the mobile device 504 are trusted based on the claimed geospatial location of the new user 106 and/or the existing user 107 of the social-networkable apparel server 100. Additionally, a matching module 210 may determine a relative match between a persistent clock 284 associated with the social-networkable apparel server 100 and/or a digital clock of the mobile device 504 to determine that the time stamp 510 associated with the creation date 508 and/or time of the tagging 105 of the taggable apparel 110 generated through the mobile device 504 is accurate and/or therefore trusted. A deletion module 236 may automatically remove the a publishing of the tagging 105 of the taggable apparel 110, generated through the mobile device, on a set of user profiles having associated verified address 1003es in the threshold radial distance 119 from the set of geospatial coordinates 103 associated with the tagging 105 of the taggable apparel 110 (generated through the mobile device 504 of the new user 106 and/or the existing user 107 of the social-networkable apparel server 100) based on a social connection expiration time 702.

A plotting module 238 may geocode a set of residential addresses each associated with a resident name in a neighborhood surrounding the mobile device. A data-seeding module 241 may prepopulate the set of residential addresses each associated with the resident name as the set of user profiles in the threshold radial distance 119 (from the claimed geospatial location of the new user 106 and/or the existing user 107 of the social-networkable apparel server 100) in a neighborhood curation system communicatively coupled with the social-networkable apparel server 100. A curation permission module 264 may permit the new user 106 and/or the existing user 107 to modify content in each of the set of user profiles. Furthermore, a discovery module 244 may track the modified content through the neighborhood curation system. An undo module 246 may generate a reversible history journal associated with each of the set of user profiles such that the modification of the new user 106 and/or the existing user 107 can be undone on a modified user profile page. A reputation module 248 may determine an editing credibility of the new user 106 and/or the existing user 107 (based on an edit history of the new user 106 and/or the existing user 107 and/or a community contribution validation of the new user 106 and/or the existing user 107 by other users of the neighborhood curation system).

A publishing module 214 may automatically publish the tagging 105 of the taggable apparel 110 generated through the mobile device 504 to the set of user profiles having associated verified addresses 1003 in the threshold radial distance 119 from the claimed geospatial location of the new user 106 and/or the existing user 107 of the social-networkable apparel server 100 using the radial algorithm 240. A claiming module 250 may process the claim request of the new user 106 and/or the existing user 107 generating the tagging 105 of the taggable apparel 110 generated through the mobile device 504 to be associated with an address of the neighborhood curation system. Moreover, an association determination module 282 may verify if the claimable neighborhood in the neighborhood curation system is associated with the private neighborhood community in the claimable neighborhood of the neighborhood curation system. A private-neighborhood module 252 may connect the new user 106 and/or the existing user 107 with the private neighborhood community in the claimable neighborhood of the neighborhood curation system if the private neighborhood community has been activated by the new user 106 and/or the existing user 107 and/or a different the new user 106 and/or the existing user 107.

A boundary module 254 may permit the new user 106 and/or the existing user 107 to draw a set of boundary lines in a form of a geospatial polygon (such that the claimable neighborhood in a geospatial region surrounding the claim request creates the private neighborhood community in the neighborhood curation system if the private neighborhood community may be inactive). An address type module 256 may confirm the claim request of the new user 106 and/or the existing user 107 generating the tagging 105 of the taggable apparel 110, generated through the mobile device, to be associated with a neighborhood address of the neighborhood curation system when the address may be determined to be associated with a work address and/or a residential address of the new user 106 and/or the existing user 107. Additionally, a concurrency module 258 may simultaneously publish the tagging 105 of the taggable apparel 110 (generated through the mobile device) on the private neighborhood community associated with the new user 106 and/or the existing user 107 generating the tagging 105 of the taggable apparel 110 generated through the mobile device 504 (in the threshold radial distance 119 from the address associated with the claim request of the new user 106 and/or the existing user 107 of the neighborhood curation system) when automatically publishing the tagging 105 of the taggable apparel 110 generated through the mobile device 504 on the set of user profiles (having associated verified address 1003es in the threshold radial distance 119 from the claimed geospatial location of the new user 106 and/or the existing user 107 of the social-networkable apparel server 100) based on a set of preferences 704 of the new user 106 and/or the existing user 107 using the radial algorithm 240.

A gesture module 280 may provide an interface to the merchant 132 such that the merchant 132 can use a haptic ‘flick’ gesture in a horizontal and/or a vertical fashion to switch a viewing pane associated with a monitoring of the effectiveness and/or return on investment of the purchase associated with the fulfillment request 612. A merchant module 222 may automatically initiate a video communication and/or an audio communication between the mobile device 504 of the merchant 132 and/or another mobile device 504 of the wearer of the taggable apparel 110 and/or a tagger that reads the short range communication technology 111 (physically associated with the taggable apparel 110) through the social-networkable apparel server 100 based on a set of preset criteria 802 through the social-networkable apparel server 100.

A communication module 266 may permit each of the individual wearing the taggable apparel 136 and/or the tagger (e.g., the new user 106 or the existing user 107 that reads the short range communication technology 111 physically on the taggable apparel 110) to communicate with each other and/or form social connections 138 with each other based on the participation criteria (set by the merchant 132 and/or the wearer of a taggable apparel 110 and/or the tagger that reads the short range communication technology 111 physically on the taggable apparel 110), such that each of the wearer of a taggable apparel 110 and/or the tagger that reads the short range communication technology 111 physically on the taggable apparel 110 may be able to form social connections 138 with each participating person associated with the tagging 105 of the taggable apparel 110. A historical applicant module 226 may permit participating merchants in the social-networkable apparel server 100 to see previous ratings, interview comments, reviews, prescreen questions, and/or background checks of across a plurality of applicants applying for a plurality of jobs through the social-networkable apparel server 100 (such that different merchants benefit from previous diligence of at one of previous ratings, interview comments, reviews, prescreen questions, and/or background checks by participating merchants with each applicant to the job that has previously applied for different jobs through the social-networkable apparel server 100).

A summary module 262 may provide a summary data 602 to the merchant 132 generating the tagging 105 of the taggable apparel 110 (generated through the mobile device) of how many user profile pages were updated with an alert of the tagging 105 of the taggable apparel 110 (generated through the mobile device) when publishing the tagging 105 of the taggable apparel 110 (generated through the mobile device) in the private neighborhood community and/or the set of user profiles (having associated verified addresses 1003 in the threshold radial distance 119 from the claimed geospatial location of the new user 106 and/or the existing user 107 of the social-networkable apparel server 100) based on the set of preferences 704 of the new user 106 and/or the existing user 107. A curation permission module 264 may permit the at least one of the new user 106 and the existing user 107 to modify content in each of the set of user profiles. A live broadcast module 228 may live broadcast the tagging 105 of the taggable apparel 110 (generated through the mobile device) to the different the new user 106 and/or the existing user 107 and/or the new user 106 and/or the existing users 107 in the private neighborhood community and/or currently within the threshold radial distance 119 from the current geospatial location through the social-networkable apparel server 100 (such that a live broadcast multicasts to a plurality of data processing systems associated with each of the different user and/or the new user 106 and/or the existing users 107 simultaneously when the mobile device 504 of the new user 106 and/or the existing user 107 generating the live-broadcast enables broadcasting of the tagging 105 of the taggable apparel 110 generated through the mobile device 504 to any one of a geospatial vicinity around the mobile device 504 of the new user 106 and/or the existing user 107 generating the broadcast and/or in any private neighborhood community in which the new user 106 and/or the existing user 107 has a non-transitory connection).

A bi-directional communication module 230 may permit the different the new user 106 and/or the existing user 107 and/or the new user 106 and/or the existing user 107 in the private neighborhood community to bi-directionally communicate with the new user 106 and/or the existing user 107 generating the broadcast through the social-networkable apparel server 100. Additionally, a non-transitory module 270 may constrain any private neighborhood community in which the new user 106 and/or the existing user 107 has the non-transitory connection to the residential address (of the new user 106 and/or the existing user 107 and/or the work address of the new user 106 and/or the existing user 107) that has been confirmed by the social-networkable apparel server 100 as being associated with the new user 106 and/or the existing user 107. A threshold module 268 may automatically set the threshold distance to be between 0.2 and 0.4 miles from the set of geospatial coordinates 103 associated with the tagging 105 of the taggable apparel 110 (generated through the mobile device) to optimize a relevancy of the live-broadcast.

Embodiments described herein in FIGS. 1-11 govern a new kind of social network for neighborhoods, according to one or more embodiments (e.g., may be private and/or wild-editable search engine based). It should be noted that in some embodiments, the address of a user may be masked from the public search (but still may be used for privacy considerations), according to one or more embodiments. Some embodiments have no pre-seeded data, whereas others might. Embodiments described herein may present rich, location specific information on individual residents and businesses.

A user can “Claim” one or more Business Pages and/or a Residential Pages, according to one or more embodiments. In order to secure their Claim, the user may verify their location associated with the Business Page and/or Residential page within 30 days, or the page becomes released to the community, according to one or more embodiments. A user can only have a maximum of 3 unverified Claims out at any given time, according to one or more embodiments. When a user clicks on “Claim this Page” on Business Profile page and/or a Residential Profile page, they can indicate the manner in which they intend to verify their claim, according to one or more embodiments. Benefits of Claiming a Business Page and/or Residential page may enable the user to mark their page ‘Self-Editable only’ from the default ‘Fully Editable’ status, and see “Private” listings in a claimed neighborhood around the verified location, according to one or more embodiments. Each edit by a user on a Residential Profile page and/or a Business Profile page may be made visible on the profile page, along with a date stamp, according to one or more embodiments.

Browse Function:

Based on the user's current location, the browse function may display a local map populated with pushpins for location-specific information, and a news feed, made up of business page edits, public people page edits, any recent broadcasts, etc., according to one or more embodiments. The news feed may show up on each Business Page and each Residential Page, based on activity in the surrounding area, according to one or more embodiments. Secure a Neighborhood function: May allow the user to identify and “secure” a neighborhood, restricting certain types of access to verified residents, according to one or more embodiments. Add a Pushpin function: May allow any registered or verified user to add any type of Pushpin (as described in FIG. 8), according to one or more embodiments.

In addition to the map, the search results page may display a news feed, made up of business page edits, public people page edits, any recent broadcasts, and autogenerated alerts who has moved into the neighborhood, who has moved out of the neighborhood, any recent reviews in the neighborhood, any pushpins placed in the immediate area, etc., according to one or more embodiments. The news feed may prioritize entries relating to the search results, and will take into account privacy policies and preferences, according to one or more embodiments.

Example Newsfeeds may include:

Joe Smith moved into the neighborhood in September 2013. Welcome Joe! Like Share; 43 neighbors (hyperlink) moved in to the Cupertino library neighborhood in July 2013. Like Share; 12 neighbors (hyperlink) verified in to the Cupertino library neighborhood in July 2013. Like Share; Rai Abhyanker invited Paul Smith, a guest to the Cupertino neighborhood. Raj indicates Paul is a friend from college looking to move into the neighborhood. Welcome Paul!: Raj Abhyanker posted a Nissan Leaf for rent $35 a day, in mountain view Rent now. Like Share

This content may feed each Profile Page and helps to increase Search Engine value for content on the site, according to one or more embodiments. Alerts may be created and curated (prioritized, filtered) automatically and/or through crowdsourcing, to keep each page vibrant and actively updating on a regular basis (ideally once a day or more), according to one or more embodiments.

A Multi-Family Residence page will display a list of residents in the entire building, according to one or more embodiments. Clicking on any resident will display a Single Family Residence page corresponding to the individual living unit where that person resides, according to one or more embodiments.

For example, suppose that John Smith and Jane Smith live in apartment 12 of a large building. Their names are included in the list of residents. When a user clicks on either John Smith or Jane Smith, we will display a “Single Family Residence” page showing both John and Jane, just as if apartment 12 was a separate structure, according to one or more embodiments.

The broadcast feature (e.g., associated with the social connection broadcast data 102 and generated by the radial algorithm 240 of the radial distribution module 140) may be a “Radio” like function that uses the mobile device's current geospatial location to send out information to neighbors around the present geospatial location of the user, according to one or more embodiments. Broadcasts may be posted to neighbor pages in the geo spatial vicinity (e.g., in the same neighborhood) on public and private pages in the geospatial social network, according to one or more embodiments. These broadcasts may enable any user, whether they live in a neighborhood or not to communicate their thoughts to those that live or work (or have claimed) a profile in the neighborhood around where the broadcaster is physically at, regardless of where the broadcaster lives, according to one or more embodiments. Broadcasts can be audio, video, pictures, and or text, according to one or more embodiments. For accountability, the broadcaster may be a verified user and their identity made public to all users who receive the broadcast in one embodiment.

This means that the broadcast feature may be restricted to be used only by devices (E.g., mobile phones) that have a GPS chip (or other geolocation device) that an identify a present location of where the broadcast is originating from, according to one or more embodiments. The broadcast may be sent to all users who have claimed a profile in the geospatial vicinity where the broadcast originates, according to one or more embodiments. This can either be broadcast live to whoever is “tuned” in to a broadcast of video, audio, picture, and text in their neighborhood, or can be posted on each users profile if they do not hear the broadcast to the neighborhood in a live mode in one embodiment.

When a broadcast is made neighbors, around where the broadcast is made, they may receive a message that says something like:

Raj Abhyanker, a user in Menlo Park just broadcast “Japanese cultural program” video from the Cupertino Union church just now. Watch, Listen, View

This broadcast may be shared with neighbors around Menlo park, and or in Cupertino. This way, Raj's neighbors and those in Cupertino can know what is happening in their neighborhoods, according to one or more embodiments. In one embodiment, the broadcast only goes to one area (Cupertino or Menlo park in the example above).

Broadcasts could be constrained to devices that have geospatial accuracy of present location and a current only (mobile devices for example). Otherwise, broadcasts won't mean much, according to one or more embodiments (would otherwise be just like thoughts/video upload without this). Broadcasts shouldn't be confused with ‘upload videos’, according to one or more embodiments. Different concepts. Why? Broadcasts have an accuracy of time and location that cannot be altered by a user, according to one or more embodiments, hence, mobile is the most likely medium for this not desktop computer, according to one or more embodiments. We should not let the user set their own location for broadcasts (like other pushpin types), according to one or more embodiments. Also time is fixed, according to one or more embodiments. Fixing and not making these two variables editable give users confidence that the broadcast was associated with a particular time and place, and creates a very unique feature, according to one or more embodiments. For example, it would be not useful if the broadcast is untrusted as to location of origination, according to one or more embodiments. E.g., I broadcast when I am somewhere only about the location I am at, according to one or more embodiments.

Broadcasts are different that other pushpins because location of where a broadcast, and time of broadcast is

*current location* and *current time*, according to one or more embodiments. They are initiated wherever a broadcaster is presently at, and added to the news feed in the broadcasters neighborhood and in the area wherever a broadcaster is presently at, according to one or more embodiments.

Broadcast rules may include:

1. If I post a Broadcast in my secured neighborhood, only my neighbors can see it, according to one or more embodiments.

2. If I post a Broadcast in different secured neighborhood then my own, my neighbors can see it (e.g., unless I turn this off in my privacy setting) and neighbors in the secured neighborhood can see it (e.g., default not turn-offable, but I can delete my broadcast), according to one or more embodiments.

3. If I post a Broadcast in different unsecured neighborhood then my own, my neighbors can see it (unless I turn this off in my privacy setting) and the broadcast is publicly visible on user pages of public user profiles in the unsecured neighborhood until profiles are claimed and/or the neighborhood is secured, according to one or more embodiments.

4. If an outsider in a secure neighborhood posts a broadcast in my secure neighborhood, it's not public, according to one or more embodiments.

5. If an outsider in a unsecure neighborhood posts a broadcast in my secure neighborhood, the system does not post on profiles in his unsecure neighborhood (to prevent stalking, burglary), but does post in my secure neighborhood, according to one or more embodiments.

Privacy settings. For each verified residential or business location, the user may set Privacy to Default, Public, Private, or Inactive, according to one or more embodiments. The Default setting (which is the default) means that the profile will be public, until the neighborhood is secured; in a secured neighborhood, the profile will be Private, according to one or more embodiments. By changing this setting, the user may force the profile to be Public or Private, regardless of whether the neighborhood is secured, according to one or more embodiments.

For each verified residential location, the user may set edit access to Group Editable or Self Editable, according to one or more embodiments.

Residential Privacy example. The residential profiles can be: Public: anyone can search, browse, or view the user profile, according to one or more embodiments. This is the default setting for unsecured neighborhoods (initially, all the content on the site), according to one or more embodiments. Private: only people in my neighborhood can search, browse, or view the user's profile, according to one or more embodiments. This is the default for secured neighborhoods, according to one or more embodiments. Inactive: nobody can search, browse, or view the profile, even within a secured neighborhood, according to one or more embodiments. A user may have at least one active (public or private), verified profile in order to have edit capabilities, according to one or more embodiments; if the user makes all profiles inactive, that user is treated (for edit purposes) as an unverified user, according to one or more embodiments.

Verified users can edit the privacy setting for their profile and override the default, according to one or more embodiments. Group Editable: anyone with access to a profile based on the privacy roles above can edit the profile, according to one or more embodiments This is the default setting, according to one or more embodiments Self Editable, only the verified owner of a profile can edit that profile, according to one or more embodiments.

Exceptions Guest User. A verified user in another neighborhood is given “Guest” access to a neighborhood for a maximum of 60 days by a verified user in the neighborhood in which the guest access is given, according to one or more embodiments. In effect, the guest becomes a member of the neighborhood for a limited period, according to one or more embodiments. Friend. When a user has self-elected being friends with someone in a different neighborhood, they can view each other's profiles only (not their neighbors), according to one or more embodiments. One way for a user to verify a location is to submit a scanned utility bill, according to one or more embodiments.

When a moderator selects the Verify Utility Bills function, the screen will display a list of items for processing, according to one or more embodiments. Accept the utility bill as a means of verification, according to one or more embodiments. This will verify the user's location, and will also generate an e-mail to the user, according to one or more embodiments. Or Decline the utility bill as a means of verification, according to one or more embodiments. There will be a drop-down list to allow the moderator to select a reason, according to one or more embodiments; this reason will be included in an e-mail message to the user. Reasons may include: Name does not match, address does not match, name/address can't be read, not a valid utility bill, according to one or more embodiments.

An example embodiment will now be described. An entity (e.g., an individual, a family, a company, a team, an organization, a non-profit institution) may express its interests (e.g., beliefs, favorite bands, favorite sports teams, hobbies, values, passions, mutual connection amongst a group) through the apparel it wears (e.g., shirt, jacket, hat, pants, scarf, shoes). The entity may receive compliments and/or inquiries regarding aspects of the apparel it is wearing (e.g., messages, logos, images, brands, advertisements, writing, color, style). An another party that shares the interests indicated by the apparel may tag the apparel worn by the entity, forming a meaningful social connection based on the parties shared interest(s).

In some cases, the tagging may yield new friendship, business, and/or romantic opportunities formed initially around the apparel as the another party may be able to form a social connection with the entity in passing (e.g., while walking past one another on the street). Therefore, the entity may gain valuable opportunities for friendship, love, professional and/or financial gain that may not have been possible before.

The entity and/or the another party may be able to network and/or form social connections on a larger scale without losing the intimacy of the initial connection as their initial social connection (and details of the taggable apparel) is broadcasted to other user profiles within the threshold radial distance from the epicenter, according to one or more embodiments. Furthermore, the entity and the another party may form a personal connection as they meet face to face during the tagging. A user with a non-transient address within the threshold radial distance from the epicenter (e.g., the geospatial coordinates of the tagging) may receive relevant updates about individuals around places that they care deeply about (e.g., their home). This may allow the user to gain easy cognizance of important and valuable updates and may help ensure that messages are hears rather that falling on deaf ears. The user may be made aware of entities with shared interests that are around them as notifications are broadcasted to the user about the social connections being formed around their non-transient address(es). The users may be provided with a way to benefit from the social connections formed by others in a geo-spatial location near them as they may be able to contact the entity with which the user has shared interests upon receiving an update about the tagging. This may lead to the formation of many strong, valuable social connections and/or users (e.g., the entity, the another party, the user) to find love, friendship, business, professional, and/or monetary gain.

For example, Mike may show his love of animals and passion for volunteer work by wearing his favorite, taggable, World Wildlife Fund shirt during a weekend trip to San Francisco. Mike may pass another man, Joe, while walking down Haight-Ashbury. This man may be the director of the San Francisco branch of the World Wildlife Fund and may notice Mike's shirt. As the men pass one another, Joe may tag Mike's shirt and the men may quickly exchange pleasantries. Unfortunately, as both men may have prior engagements to get to, their time speaking may be brief before the men go their separate ways.

Later that day, Mike may check his profile and see that Jane, a pretty girl that lives in the apartment building next to his, sent him a message saying how much she loves the World Wildlife Fund and that she would love to volunteer with the organization. Mike may also see that Joe contacted him on his profile saying how good it was to meet him and that if Mike would ever like to work with the San Francisco branch of the World Wildlife Fund, Joe would get him a position. As a result, Mike may contact Joe and begin working with the organization. After getting a job, Mike may contact Jane who may volunteer. The two may discover that they have many other shared interests and may become very close. Because Mike may be presented with the social connection through the embodiments of described in FIGS. 1-12, Mike may have a chance to form at least one of a new friendship, a romantic relationship and/or a professional opportunity. Therefore, Mike may make substantial financial, social, and/or romantic gains through the social-networkable apparel server.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structures and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system. Accordingly, the specification and drawings are to be regarded in an illustrative rather than a restrictive sense.

What is claimed is:

1. a social-networkable apparel server comprising:
validating that a tagging of a taggable apparel through a mobile device is associated with at least one of a new user and an existing user of the social-networkable apparel server using a processor and a memory;
verifying that a set of geospatial coordinates associated with the tagging of the taggable apparel through the mobile device are trusted based on at least one of a contact information transmitted from the mobile device to the social-networkable apparel server and a claimed geospatial location of the at least one of the new user and the existing user of the social-networkable apparel server;
determining that a time stamp associated with a creation date and a creation time of the tagging of the taggable apparel generated through the mobile device is trusted based on the set of geospatial coordinates where the taggable apparel was tagged; and
automatically forming a social connection between the at least one of the new user and the existing user and an individual wearing the taggable apparel in the social-networkable apparel server using a radial algorithm.

2. The method of claim 1 further comprising:
selecting a design of the taggable apparel through an apparel creator module of the social-networkable apparel server based on a request of a merchant;
customizing an advertisement area on the taggable apparel through an advertisement creation module of the social-networkable apparel server based on the request of the merchant, wherein the advertisement area is associated with at least one of a commercial item, a service, and a promotional item offered by the merchant to any of those individuals that read a short range communication technology on the taggable apparel;
submitting a fulfillment request of an order by the merchant for a quantity of the taggable apparel having customized ones of the advertisement area and each individually associated with the short range communication technology through the social-networkable apparel server, such that the short range communication technology individually identifies each the taggable apparel and optionally a group of the taggable apparel and a wearer of the taggable apparel through a unique identifier associated with the short range communication technology and a unique uniform resource locator destination to which each read tag is transported in the social-networkable apparel server;
permitting the merchant to log-in to the social-networkable apparel server and set a criteria being at least one of a location sharing request, a social graph sharing request, a destination page design, a destination uniform resource locator location, and an updatable electronic promotion associated with each of the taggable apparel;
permitting the merchant to log-in to the social-networkable apparel server and view statistics related to a most social wearer of the taggable apparel, a top tagger, a top sharer, a top promoter, a top influencer, a top geospatial area of tagging, and a set of statistics associated with an effectiveness and return on investment of a purchase associated with the fulfillment request;
automatically publishing the tagging of the taggable apparel generated through the mobile device on a set of user profiles having associated verified addresses in a threshold radial distance from the set of geospatial coordinates associated with the tagging of the taggable apparel generated through the mobile device of the at least one of the new user and the existing user of the social-networkable apparel server using the radial algorithm;
processing at least one of a listing criteria associated with the tagging of the taggable apparel comprising a social connection, description, a photograph, a video, a salary, a fixed fee amount, an category, a functional status of a job offered through the tagging of the taggable apparel, wherein the job is at least one of a household job, a repair job, a maintenance job, a professional job and a career opportunity;
populating an availability chart when the job associated with the listing criteria is posted, wherein the availability chart includes at least one of a target candidate living area radius, a start timing, an hours per day, an hours per month, a professional qualification criteria and a timing criteria;
determining that a broadcast data is generated by the at least one of the new user and the existing user of a neighborhood broadcasting system when validating that the broadcast data is associated with the mobile device;
determining that an application on the mobile device is communicating the broadcast data to the neighborhood broadcasting system when the broadcast data is processed; and
associating the at least one of the new user and the existing user with the at least one of the new user and an existing user profile in the neighborhood broadcasting system through the application on the mobile device,
presenting the tagging of the taggable apparel generated through the mobile device as a tag pushpin in a geospatial map surrounding pre-populated residential and business listings in a surrounding vicinity, such that the tag pushpin is automatically presented on a geospatial map in addition to being presented on the set of user profiles having associated verified addresses in the threshold radial distance from the set of geospatial coordinates associated with the tagging of the taggable apparel generated through the mobile device of the at least one of the new user and the existing user of the social-networkable apparel server,
wherein the tagging of the taggable apparel generated through the mobile device is radially distributed through at least one of an on-page posting, an electronic communication, and a push notification delivered to desktop and mobile devices associated with users and their user profiles around an epicenter defined at the set of geospatial coordinates associated with the tagging of the taggable apparel generated through the mobile device to all subscribed user profiles in a circular geo-fenced area defined by a threshold distance from the set of geospatial coordinates associated with the tagging of the taggable apparel generated through the mobile device through the radial algorithm of the neighborhood broadcasting system that measures a distance away of each address associated with each user profile from a current geospatial location at the epicenter.

3. The method of claim 2 further comprising:
permitting the at least one of the new user and the existing user to drag and drop the tag pushpin on any location on the geospatial map, and automatically determining a latitude and a longitude associated a placed location;
automatically notifying at least one of a career center, a hardware store, a professional services provider, a landscaper, a gardener, a plumber, a handyman, and a homeless shelter in a surrounding geospatial area to the set of geospatial coordinates associated with the tagging of the taggable apparel generated through the mobile device.

4. The method of claim 3 further comprising:
extracting a geospatial coordinates from a metadata associated with the tagging of the taggable apparel generated through the mobile device when verifying that the set of geospatial coordinates associated with the tagging of the taggable apparel generated through the mobile device are trusted based on the claimed geospatial location of the at least one of the new user and the existing user of the social-networkable apparel server.

5. The method of claim 4 further comprising:
determining a relative match between a persistent clock associated with the social-networkable apparel server and a digital clock of the mobile device to determine that the time stamp associated with the creation date and time of the tagging of the taggable apparel generated through the mobile device is accurate and therefore trusted; and
automatically deleting the a publishing of the tagging of the taggable apparel generated through the mobile device on the set of user profiles having associated verified addresses in the threshold radial distance from the set of geospatial coordinates associated with the tagging of the taggable apparel generated through the mobile device of the at least one of the new user and the existing user of the social-networkable apparel server based on a social connection expiration time.

6. The method of claim 5 further comprising:
geocoding a set of residential addresses each associated with a resident name in a neighborhood surrounding the mobile device; and
prepopulating the set of residential addresses each associated with the resident name as the set of user profiles in the threshold radial distance from the claimed geospatial location of the at least one of the new user and the existing user of the social-networkable apparel server in a neighborhood curation system communicatively coupled with the social-networkable apparel server.

7. The method of claim 6 further comprising:
permitting the at least one of the new user and the existing user to modify content in each of the set of user profiles;
tracking a modified content through the neighborhood curation system;
generating a reversible history journal associated with each of the set of user profiles such that a modification of the at least one of the new user and the existing user can be undone on a modified user profile page;
determining an editing credibility of the at least one of the new user and the existing user based on an edit history of the at least one of the new user and the existing user and a community contribution validation of the at least one of the new user and the existing user by other users of the neighborhood curation system; and
automatically publishing the tagging of the taggable apparel generated through the mobile device to the set of user profiles having associated verified addresses in the threshold radial distance from the claimed geospatial location of the at least one of the new user and the existing user of the social-networkable apparel server using the radial algorithm.

8. The method of claim 7 further comprising:
processing a claim request of the at least one of the new user and the existing user generating the tagging of the taggable apparel generated through the mobile device to be associated with an address of the neighborhood curation system;
determining if a claimable neighborhood in the neighborhood curation system is associated with a private neighborhood community in the claimable neighborhood of the neighborhood curation system;
associating the at least one of the new user and the existing user with the private neighborhood community in the claimable neighborhood of the neighborhood curation system if the private neighborhood community has been activated by at least one of the at least one of the new user and the existing user and a different at least one of the new user and the existing user;
permitting the at least one of the new user and the existing user to draw a set of boundary lines in a form of a geospatial polygon such that the claimable neighborhood in a geospatial region surrounding the claim request creates the private neighborhood community in the neighborhood curation system if the private neighborhood community is inactive;
verifying the claim request of the at least one of the new user and the existing user generating the tagging of the taggable apparel generated through the mobile device to be associated with a neighborhood address of the neighborhood curation system when the address is determined to be associated with at least one of a work address and a residential address of the at least one of the new user and the existing user; and
simultaneously publishing the tagging of the taggable apparel generated through the mobile device on the private neighborhood community associated with the at least one of the new user and the existing user generating the tagging of the taggable apparel generated through the mobile device in the threshold radial distance from the address associated with the claim request of the at least one of the new user and the existing user of the neighborhood curation system when automatically publishing the tagging of the taggable apparel generated through the mobile device on the set of user profiles having associated verified addresses in the threshold radial distance from the claimed geospatial location of the at least one of the new user and the existing user of the social-networkable apparel server based on a set of preferences of the at least one of the new user and the existing user using the radial algorithm.

9. The method of claim 8 further comprising:
providing an interface to the merchant such that the merchant can use a haptic ‘flick’ gesture in at least one of a horizontal and a vertical fashion to switch a viewing pane associated with a monitoring of the effectiveness and return on investment of the purchase associated with the fulfillment request;
automatically initiating at least one of a video communication and an audio communication between the mobile device of the merchant and another mobile device of the at least one of the wearer of the taggable apparel and a tagger that reads the short range communication technology physically on the taggable apparel through the social-networkable apparel server based on a set of preset criteria through the social-networkable apparel server;
permitting each at least one of the wearer of the taggable apparel and the tagger that reads the short range communication technology physically on the taggable apparel for the job associated with the tagging of the taggable apparel to communicate with each other and form social connections with each other based on a participation criteria set by at least one of the merchant and the at least one of the wearer of the taggable apparel and the tagger that reads the short range communication technology physically on the taggable apparel, such that each of at least one of the wearer of the taggable apparel and the tagger that reads the short range communication technology physically on the taggable apparel is able to form social connections with each participating person associated with the tagging of the taggable apparel;
permitting participating merchants in the social-networkable apparel server to see at least one of previous ratings, interview comments, reviews, prescreen questions, and background checks of across a plurality of applicants applying for a plurality of jobs through the social-networkable apparel server such that different merchants benefit from previous diligence of at one of previous ratings, interview comments, reviews, prescreen questions, and background checks by participating merchants with each applicant to the job that has previously applied for different jobs through the social-networkable apparel server; and
providing a summary data to the merchant generating the tagging of the taggable apparel generated through the mobile device of how many user profile pages were updated with an alert of the tagging of the taggable apparel generated through the mobile device when publishing the tagging of the taggable apparel generated through the mobile device in at least one of the private neighborhood community and the set of user profiles having associated verified addresses in the threshold radial distance from the claimed geospatial location of the at least one of the new user and the existing user of the social-networkable apparel server based on the set of preferences of the at least one of the new user and the existing user.

10. The method of claim 9 further comprising:
live broadcasting the tagging of the taggable apparel generated through the mobile device to the different at least one of the new user and the existing user and at least one of the new user and an existing users in at least one of the private neighborhood community and currently within the threshold radial distance from the current geospatial location through the social-networkable apparel server such that a live broadcast multicasts to a plurality of data processing systems associated with each of a different user and the at least one of the new user and the existing users simultaneously when the mobile device of the at least one of the new user and the existing user generating a live-broadcast enables broadcasting of the tagging of the taggable apparel generated through the mobile device to any one of a geospatial vicinity around the mobile device of the at least one of the new user and the existing user generating a broadcast and in any private neighborhood community in which the at least one of the new user and the existing user has a non-transitory connection; and
permitting the different at least one of the new user and the existing user and at least one of the new user and the existing users in at least one of the private neighborhood community to bi-directionally communicate with the at least one of the new user and the existing user generating the broadcast through the social-networkable apparel server,
wherein any private neighborhood community in which the at least one of the new user and the existing user has the non-transitory connection is at least one of the residential address of the at least one of the new user and the existing user and the work address of the at least one of the new user and the existing user that has been confirmed by the social-networkable apparel server as being associated with the at least one of the new user and the existing user, and
wherein the threshold distance is between 0.2 and 0.4 miles from the set of geospatial coordinates associated with the tagging of the taggable apparel generated through the mobile device to optimize a relevancy of the live-broadcast.

11. A method of a social-networkable apparel server comprising:
determining that a time stamp associated with a creation date and a creation time of a tagging of a taggable apparel generated through a computing device is trusted based on a set of geospatial coordinates where the taggable apparel was tagged using a processor and a memory; and
automatically forming a social connection between a at least one of a new user and an existing user and an individual wearing the taggable apparel through the social-networkable apparel server using a radial algorithm; and
radially distributing the tagging of the taggable apparel as a notification data through at least one of an on-page posting, an electronic communication, and a push notification delivered to at least one of:
a set of recipients through an internet protocol (IP) based network associated with users and their user profiles around an epicenter defined at the set of geospatial coordinates associated with the tagging of the taggable apparel generated through the computing device,
a set of merchants through the internet protocol (IP) based network associated with the users and their user profiles around the epicenter defined at the set of geospatial coordinates associated with the tagging of the taggable apparel generated through the computing device,
a set of all subscribed user profiles in a circular geo-fenced area defined by a threshold distance from the set of geospatial coordinates associated with the tagging of the taggable apparel generated through the computing device through the radial algorithm of a neighborhood broadcasting system that measures a distance away of each address associated with each user profile from a current geospatial location at the epicenter.

12. The method of claim 11 further comprising:
validating that the tagging of the taggable apparel through the computing device is associated with at least one of the new user and the existing user of the social-networkable apparel server;
verifying that the set of geospatial coordinates associated with the tagging of the taggable apparel, through the computing device are trusted based on at least one of a contact information transmitted from the computing device to the social-networkable apparel server and a claimed geospatial location of the at least one of the new user and the existing user of the social-networkable apparel server;
selecting a design of the taggable apparel through an apparel creator module of the social-networkable apparel server based on a request of a merchant;
customizing an advertisement area on the taggable apparel through an advertisement creation module of the social-networkable apparel server based on the request of the merchant, wherein the advertisement area is associated with at least one of a commercial item, a service, and a promotional item offered by the merchant to any of those individuals that read a short range communication technology on the taggable apparel;
submitting a fulfillment request of an order by the merchant for a quantity of the taggable apparel having customized ones of the advertisement area and each individually associated with the short range communication technology through the social-networkable apparel server, such that the short range communication technology individually identifies each the taggable apparel and optionally a group of the taggable apparel and a wearer of the taggable apparel through a unique identifier associated with the short range communication technology and a unique uniform resource locator destination to which each read tag is transported in the social-networkable apparel server;
permitting the merchant to log-in to the social-networkable apparel server and set a criteria being at least one of a location sharing request, a social graph sharing request, a destination page design, a destination uniform resource locator location, and an updatable electronic promotion associated with each of the taggable apparel;
permitting the merchant to log-in to the social-networkable apparel server and view statistics related to a most social wearer of the taggable apparel, a top tagger, a top sharer, a top promoter, a top influencer, a top geospatial area of tagging, and a set of statistics associated with an effectiveness and return on investment of a purchase associated with the fulfillment request;
automatically publishing the tagging of the taggable apparel generated through the computing device on a set of user profiles having associated verified addresses in a threshold radial distance from the set of geospatial coordinates associated with the tagging of the taggable apparel generated through the computing device of the at least one of the new user and the existing user of the social-networkable apparel server using the radial algorithm;
processing at least one of a listing criteria associated with the tagging of the taggable apparel comprising a description, a photograph, a video, a salary, a fixed fee amount, a category, a functional status of a job offered through the tagging of the taggable apparel, wherein the job is at least one of a household job, a repair job, a maintenance job, a professional job and a career opportunity;
populating an availability chart when the job associated with the listing criteria is posted, wherein the availability chart includes at least one of a target candidate living area radius, a start timing, an hours per day, an hours per month, a professional qualification criteria and a timing criteria;
determining that a broadcast data is generated by the at least one of the new user and the existing user of the neighborhood broadcasting system when validating that the broadcast data is associated with the computing device;
determining that an application on the computing device is communicating the broadcast data to the neighborhood broadcasting system when the broadcast data is processed; and
associating the at least one of the new user and the existing user with the at least one of the new user and a existing user profile in the neighborhood broadcasting system through the application on the computing device,
presenting the tagging of the taggable apparel generated through the computing device as a tag pushpin in a geospatial map surrounding pre-populated residential and business listings in a surrounding vicinity, such that the tag pushpin is automatically presented on a geospatial map in addition to being presented on the set of user profiles having associated verified addresses in the threshold radial distance from the set of geospatial coordinates associated with the tagging of the taggable apparel generated through the computing device of the at least one of the new user and the existing user of the social-networkable apparel server.

13. The method of claim 12 further comprising:
permitting the at least one of the new user and the existing user to drag and drop the tag pushpin on any location on the geospatial map, and automatically determining a latitude and a longitude associated with a placed location;
automatically notifying at least one of a career center, a hardware store, a professional services provider, a landscaper, a gardener, a plumber, a handyman, and a homeless shelter in a surrounding geospatial area to the set of geospatial coordinates associated with the tagging of the taggable apparel generated through the computing device.

14. A system comprising:
a social-networkable apparel server to automatically form a social connection between the at least one of a new user and an existing user and an individual wearing a taggable apparel using a radial algorithm using a processor and a memory;
a network; and
a mobile device communicatively coupled with the social-networkable apparel server through the network to generate the social connection using at least one of a camera, a microphone, and a sensory capability of the mobile device to generate a captured data that is appended with a time stamp associated with a creation date and a creation time of captured data in generating the social connection;

15. The system of claim 14 in which the social-networkable apparel server comprises:
a validation module to validate that a tagging of the taggable apparel through the mobile device is associated with at least one of the new user and the existing user of the social-networkable apparel server, and to verify that a set of geospatial coordinates associated with the tagging of the taggable apparel through the mobile device are trusted based on at least one of a contact information transmitted from the mobile device to the social-networkable apparel server and a claimed geospatial location of the at least one of the new user and the existing user of the social-networkable apparel server,
a time stamp module to identify that the time stamp associated with the creation date and a creation time of the tagging of the taggable apparel generated through the mobile device is trusted based on the set of geospatial coordinates where the taggable apparel was tagged,
an apparel creator module to select a design of the taggable apparel based on a request of a merchant,
an advertisement creation module to customize an advertisement area on the taggable apparel based on the request of the merchant, wherein the advertisement area is associated with at least one of a commercial item, a service, and a promotional item offered by the merchant to any of those individuals that read a short range communication technology on the taggable apparel,
a submission module to submit a fulfillment request of an order by the merchant for a quantity of the taggable apparel having customized ones of the advertisement area and each individually associated with the short range communication technology through the social-networkable apparel server, such that the short range communication technology individually identifies each the taggable apparel and optionally a group of the taggable apparel and a wearer of the taggable apparel through a unique identifier associated with the short range communication technology and a unique uniform resource locator destination to which each read tag is transported in the social-networkable apparel server,
a merchant criteria module to permit the merchant to log-in to the social-networkable apparel server and set a criteria being at least one of a location sharing request, a social graph sharing request, a destination page design, a destination uniform resource locator location, and an updatable electronic promotion associated with each of the taggable apparel,
a statistic permission module to permit the merchant to log-in to the social-networkable apparel server and view statistics related to a most social wearer of the taggable apparel, a top tagger, a top sharer, a top promoter, a top influencer, a top geospatial area of tagging, and a set of statistics associated with an effectiveness and return on investment of a purchase associated with the fulfillment request,
a publishing module to automatically publish the tagging of the taggable apparel generated through the mobile device on a set of user profiles having associated verified addresses in a threshold radial distance from the set of geospatial coordinates associated with the tagging of the taggable apparel generated through the mobile device of the at least one of the new user and the existing user of the social-networkable apparel server using the radial algorithm,
a listing module to process at least one of a listing criteria associated with the tagging of the taggable apparel comprising a description, a photograph, a video, a salary, a fixed fee amount, an category, a functional status of a job offered through the tagging of the taggable apparel, wherein the job is at least one of a household job, a repair job, a maintenance job, a professional job and a career opportunity,
a charting module to populate an availability chart when the job associated with the listing criteria is posted, wherein the availability chart includes at least one of a target candidate living area radius, a start timing, an hours per day, an hours per month, a professional qualification criteria and a timing criteria,
a broadcast determination module to verify that a broadcast data is generated by the at least one of the new user and the existing user of a neighborhood broadcasting system when validating that the broadcast data is associated with the mobile device,
an application module to determine that an application on the mobile device is communicating the broadcast data to the neighborhood broadcasting system when the broadcast data is processed;
an association module to associate the at least one of the new user and the existing user with the at least one of the new user and a existing user profile in the neighborhood broadcasting system through the application on the mobile device,
a pushpin module to present the tagging of the taggable apparel generated through the mobile device as a tag pushpin in a geospatial map surrounding pre-populated residential and business listings in a surrounding vicinity, such that the tag pushpin is automatically presented on a geospatial map in addition to being presented on the set of user profiles having associated verified addresses in the threshold radial distance from the set of geospatial coordinates associated with the tagging of the taggable apparel generated through the mobile device of the at least one of the new user and the existing user of the social-networkable apparel server, and
a radial distribution module to allow the tagging of the taggable apparel generated through the mobile device to be radially distributed through at least one of an on-page posting, an electronic communication, and a push notification delivered to desktop and mobile devices associated with users and their user profiles around an epicenter defined at the set of geospatial coordinates associated with the tagging of the taggable apparel generated through the mobile device to all subscribed user profiles in a circular geo-fenced area defined by a threshold distance from the set of geospatial coordinates associated with the tagging of the taggable apparel generated through the mobile device through the radial algorithm of the neighborhood broadcasting system that measures a distance away of each address associated with each user profile from a current geospatial location at the epicenter.

16. The system of claim 15 further comprising:
a placement module to enable at least one of the new user and the existing user to drag and drop the tag pushpin on any location on the geospatial map, and automatically determining a latitude and a longitude associated a placed location;
a notification module to automatically notify at least one of a career center, a hardware store, a professional services provider, a landscaper, a gardener, a plumber, a handyman, and a homeless shelter in a surrounding geospatial area to the set of geospatial coordinates associated with the tagging of the taggable apparel generated through the mobile device.

17. The system of claim 16 further comprising:
an extraction module to extract a geospatial coordinates from a metadata associated with the tagging of the taggable apparel generated through the mobile device when verifying that the set of geospatial coordinates associated with the tagging of the taggable apparel generated through the mobile device are trusted based on the claimed geospatial location of the at least one of the new user and the existing user of the social-networkable apparel server.

18. The system of claim 17 further comprising:
a matching module to determine a relative match between a persistent clock associated with the social-networkable apparel server and a digital clock of the mobile device to determine that the time stamp associated with the creation date and time of the tagging of the taggable apparel generated through the mobile device is accurate and therefore trusted; and
a deletion module to automatically remove a publishing of the tagging of the taggable apparel generated through the mobile device on the set of user profiles having associated verified addresses in the threshold radial distance from the set of geospatial coordinates associated with the tagging of the taggable apparel generated through the mobile device of the at least one of the new user and the existing user of the social-networkable apparel server based on a social connection expiration time.

19. The system of claim 18 further comprising:
a plotting module to geocode a set of residential addresses each associated with a resident name in a neighborhood surrounding the mobile device; and
a data seeding module to prepopulate the set of residential addresses each associated with the resident name as the set of user profiles in the threshold radial distance from the claimed geospatial location of the at least one of the new user and the existing user of the social-networkable apparel server in a neighborhood curation system communicatively coupled with the social-networkable apparel server.

20. The system of claim 19 further comprising:
a curation permission module to permit the at least one of the new user and the existing user to modify content in each of the set of user profiles;
a discovery module to track a modified content through the neighborhood curation system;
an undo module to generate a reversible history journal associated with each of the set of user profiles such that a modification of the at least one of the new user and the existing user can be undone on a modified user profile page;
a reputation module to determine an editing credibility of the at least one of the new user and the existing user based on an edit history of the at least one of the new user and the existing user and a community contribution validation of the at least one of the new user and the existing user by other users of the neighborhood curation system; and
the publishing module to automatically publish the tagging of the taggable apparel generated through the mobile device to the set of user profiles having associated verified addresses in the threshold radial distance from the claimed geospatial location of the at least one of the new user and the existing user of the social-networkable apparel server using the radial algorithm.
a claiming module to process a claim request of the at least one of the new user and the existing user generating the tagging of the taggable apparel generated through the mobile device to be associated with an address of the neighborhood curation system;
an association determination module to verify if a claimable neighborhood in the neighborhood curation system is associated with a private neighborhood community in the claimable neighborhood of the neighborhood curation system;
a private neighborhood module to connect the at least one of the new user and the existing user with the private neighborhood community in the claimable neighborhood of the neighborhood curation system if the private neighborhood community has been activated by at least one of the at least one of the new user and the existing user and a different at least one of the new user and the existing user;
a boundary module to permit the at least one of the new user and the existing user to draw a set of boundary lines in a form of a geospatial polygon such that the claimable neighborhood in a geospatial region surrounding the claim request creates the private neighborhood community in the neighborhood curation system if the private neighborhood community is inactive;
a claim verification module to confirm the claim request of the at least one of the new user and the existing user generating the tagging of the taggable apparel generated through the mobile device to be associated with a neighborhood address of the neighborhood curation system when the address is determined to be associated with at least one of a work address and a residential address of the at least one of the new user and the existing user; and
a concurrency module to simultaneously publish the tagging of the taggable apparel generated through the mobile device on the private neighborhood community associated with the at least one of the new user and the existing user generating the tagging of the taggable apparel generated through the mobile device in the threshold radial distance from the address associated with the claim request of the at least one of the new user and the existing user of the neighborhood curation system when automatically publishing the tagging of the taggable apparel generated through the mobile device on the set of user profiles having associated verified addresses in the threshold radial distance from the claimed geospatial location of the at least one of the new user and the existing user of the social-networkable apparel server based on a set of preferences of the at least one of the new user and the existing user using the radial algorithm;
a gesture module to provide an interface to the merchant such that the merchant can use a haptic ‘flick’ gesture in at least one of a horizontal and a vertical fashion to switch a viewing pane associated with a monitoring of the effectiveness and return on investment of the purchase associated with the fulfillment request;
a merchant module to automatically initiate at least one of a video communication and an audio communication between the mobile device of the merchant and another mobile device of the at least one of the wearer of the taggable apparel and a tagger that reads the short range communication technology physically on the taggable apparel through the social-networkable apparel server based on a set of preset criteria through the social-networkable apparel server;
a communication module to permit each at least one of the wearer of the taggable apparel and the tagger that reads the short range communication technology physically on the taggable apparel for the job associated with the tagging of the taggable apparel to communicate with each other and form social connections with each other based on a participation criteria set by at least one of the merchant and the at least one of the wearer of the taggable apparel and the tagger that reads the short range communication technology physically on the taggable apparel, such that each of at least one of the wearer of the taggable apparel and the tagger that reads the short range communication technology physically on the taggable apparel is able to form social connections with each participating person associated with the tagging of the taggable apparel;
a historical applicant module to permit participating merchants in the social-networkable apparel server to see at least one of previous ratings, interview comments, reviews, prescreen questions, and background checks of across a plurality of applicants applying for a plurality of jobs through the social-networkable apparel server such that different merchants benefit from previous diligence of at one of previous ratings, interview comments, reviews, prescreen questions, and background checks by participating merchants with each applicant to the job that has previously applied for different jobs through the social-networkable apparel server; and
a summary module to provide a summary data to the merchant generating the tagging of the taggable apparel generated through the mobile device of how many user profile pages were updated with an alert of the tagging of the taggable apparel generated through the mobile device when publishing the tagging of the taggable apparel generated through the mobile device in at least one of the private neighborhood community and the set of user profiles having associated verified addresses in the threshold radial distance from the claimed geospatial location of the at least one of the new user and the existing user of the social-networkable apparel server based on the set of preferences of the at least one of the new user and the existing user;
a live broadcast module to live broadcast the tagging of the taggable apparel generated through the mobile device to the different at least one of the new user and the existing user and at least one of the new user and an existing users in at least one of the private neighborhood community and currently within the threshold radial distance from the current geospatial location through the social-networkable apparel server such that a live-broadcast multicasts to a plurality of data processing systems associated with each of a different user and the at least one of the new user and the existing users simultaneously when the mobile device of the at least one of the new user and the existing user generating a live-broadcast enables broadcasting of the tagging of the taggable apparel generated through the mobile device to any one of a geospatial vicinity around the mobile device of the at least one of the new user and the existing user generating the broadcast and in any private neighborhood community in which the at least one of the new user and the existing user has a non-transitory connection; and
a bi-directional communication module to permit the different at least one of the new user and the existing user and at least one of the new user and the existing users in at least one of the private neighborhood community to bi-directionally communicate with the at least one of the new user and the existing user generating the broadcast through the social-networkable apparel server,
a non-transitory module to constrain any private neighborhood community in which the at least one of the new user and the existing user has the non-transitory connection to at least one of the residential address of the at least one of the new user and the existing user and the work address of the at least one of the new user and the existing user that has been confirmed by the social-networkable apparel server as being associated with the at least one of the new user and the existing user, and
a threshold module to automatically set the threshold distance is between 0.2 and 0.4 miles from the set of geospatial coordinates associated with the tagging of the taggable apparel generated through the mobile device to optimize a relevancy of the live-broadcast.
